(19) United States
(12) Patent Application Publication
(10) Pub. No.: US 2013/0269543 A1
(43) Pub. Date: Oct. 17, 2013

(54) System for Managing the Nutritional Content for Nutritional Substances

(71) Applicant: Eugenio Minvielle, Rye, NY (US)

(72) Inventor: Eugenio Minvielle, Rye, NY (US)

(21) Appl. No.: 13/485,916

(22) Filed: May 31, 2012

Related U.S. Application Data
(60) Provisional application No. 61/624,993, filed on Apr. 16, 2012.
(60) Provisional application No. 61/624,999, filed on Apr. 16, 2012.
(60) Provisional application No. 61/625,009, filed on Apr. 16, 2012.
(60) Provisional application No. 61/624,948, filed on Apr. 16, 2012.
(60) Provisional application No. 61/624,972, filed on Apr. 16, 2012.
(60) Provisional application No. 61/624,985, filed on Apr. 16, 2012.
(60) Provisional application No. 61/624,992, filed on Apr. 16, 2012.
(60) Provisional application No. 61/625,002, filed on Apr. 16, 2012.
(60) Provisional application No. 61/625,010, filed on Apr. 16, 2012.
(60) Provisional application No. 61/624,745, filed on Apr. 16, 2012.
(60) Provisional application No. 61/624,765, filed on Apr. 16, 2012.
(60) Provisional application No. 61/624,788, filed on Apr. 16, 2012.
(60) Provisional application No. 61/624,800, filed on Apr. 16, 2012.
(60) Provisional application No. 61/624,980, filed on Apr. 16, 2012.
(60) Provisional application No. 61/624,989, filed on Apr. 16, 2012.
(60) Provisional application No. 61/624,939, filed on Apr. 16, 2012.

(51) Int. Cl. G06F 17/30; A23L 1/00

(52) U.S. Cl. 99/486; 707/736; 707/705; 707/E17.001; 707/E17.058

(57) ABSTRACT

A nutritional substance information system collects, stores, tracks, and transmits information regarding the creation, preservation, transformation, conditioning and consumption of nutritional substances, and importantly, in nutritional values, and correlates such information with various organizations, entities, industries, and governments outside the nutritional substance supply systems, so as to optimize the production of nutritional substances, as well as optimize the consumption of nutritional substances.

### CROSS REFERENCE TO RELATED APPLICATIONS OR PRIORITY CLAIM

This application claims benefit under 35 U.S.C. 119(e) of U.S. Provisional Patent Application Ser. No. 61/624,993, filed Apr. 16, 2012; U.S. Provisional Patent Application Ser. No. 61/624,999, filed Apr. 16, 2012; U.S. Provisional Patent Application, 61/625,009, filed Apr. 16, 2012; U.S. Provisional Patent Application Ser. No. 61/624,948, filed Apr. 16, 2012; U.S. Provisional Patent Application Ser. No. 61/624,972, filed Apr. 16, 2012; U.S. Provisional Patent Application, 61/624,985, filed Apr. 16, 2012; U.S. Provisional Patent Application Ser. No. 61/624,992, filed Apr. 16, 2012; U.S. Provisional Patent Application Ser. No. 61/625,002, filed Apr. 16, 2012; U.S. Provisional Patent Application, 61/625,010, filed Apr. 16, 2012; U.S. Provisional Patent Application Ser. No. 61/624,745, filed Apr. 16, 2012; U.S. Provisional Patent Application Ser. No. 61/624,765, filed Apr. 16, 2012; U.S. Provisional Patent Application, 61/624,788, filed Apr. 16, 2012; U.S. Provisional Patent Application Ser. No. 61/624,800, filed Apr. 16, 2012; U.S. Provisional Patent Application Ser. No. 61/624,980, filed Apr. 16, 2012; U.S. Provisional Patent Application, 61/624,989, filed Apr. 16, 2012; and U.S. Provisional Patent Application Ser. No. 61/624,939 filed Apr. 16, 2012, the contents of which are incorporated herein by reference in their entirety.

### FIELD OF THE INVENTION

The present inventions relate to an integrated system for collecting, transmitting and acting upon information regarding the nutritional content of nutritional substances.

### BACKGROUND OF THE INVENTION

Nutritional substances are traditionally grown (plants), raised (animals) or synthesized (synthetic compounds). Additionally, nutritional substances can be found in a wild, non-cultivated form, which can be caught or collected. While the collectors and creators of nutritional substances generally obtain and/or generate information about the source, history, caloric content and/or nutritional content of their products, they generally do not pass such information along to the users of their products. One reason is the nutritional substance industries have tended to act like “silo” industries. Each group in the food and beverage industry: growers, packagers, processors, distributors, retailers, and preparers work separately, and either shares no information, or very little information, between themselves. There is generally no consumer access to, and little traceability of, information regarding the creation and/or origin, preservation, processing, preparation, or consumption of nutritional substances. It would be desirable for such information be available to the consumers of nutritional substances, as well as all participants in the food and beverage industry—the nutritional substance supply system.

While the nutritional substance supply system has endeavored over the last 50 years to increase the caloric content of nutritional substances produced (which has help reduce starvation in developing countries, but has led to obesity problems in developed countries), maintaining, or increasing, the nutritional content of nutritional substances has been a lower priority. Caloric content refers to the energy in nutritional substances, commonly measured in calories. The caloric content could be represented as sugars and/or carbohydrates in the nutritional substances. The nutritional content of foods and beverages, as used herein, refers to the non-caloric content of these nutritional substances which are beneficial to the organisms which consume these nutritional substances. For example, the nutritional content of a nutritional substance could include vitamins, minerals, proteins, and other non-caloric components which are necessary, or at least beneficial, to the organism consuming the nutritional substances.

While there has recently been greater attention by consumer organizations, health organizations and the public to the nutritional content of foods and beverages, the food and beverage industry has been slow in responding to this attention. One reason for this may be that since the food and beverage industry operates as silos of those who create nutritional substances, those who preserve and transport nutritional substances, those who transform nutritional substances, and those who finally prepare the nutritional substances for consumption by the consumer, there has been no coordination of management of nutritional content. While each of these silo industries may be able to maintain or increase the nutritional content of the foods and beverages they handle, each silo industry has only limited information and control of the nutritional substances they receive, and the nutritional substances they pass along.

As consumers better understand their need for nutritional substances with higher nutritional content, they will start demanding that the food and beverage industry offer products which include higher nutritional content, and/or at least information regarding nutritional content of such products. In fact, consumers are already willing to pay higher prices for higher nutritional content. This can be seen at high-end grocery stores which offer organic, minimally processed, fresh, non-adulterated nutritional substances. Further, as societies and governments seek to improve their constituents' health and lower healthcare costs, incentives and/or mandates will be given to the food and beverage industry to track, maintain, and/or increase the nutritional content of nutritional substances they handle. There will be a need, not only within each food and beverage industry silo to maintain or improve the nutritional content of their products, but an industry-wide solution to allow the management of nutritional content across the entire cycle from creation to consumption. In order to manage the nutritional content of nutritional substances across the entire cycle from creation to consumption, the nutritional substance industry will need to identify, track, measure, estimate, preserve, transform, condition, and record nutritional content for nutritional substances. Of particular importance is the measurement, estimation, and tracking of changes to the nutritional content of a nutritional substance from creation to consumption. This information could be used, not only by the consumer in selecting particular nutritional substances to consume, but could be used by the other food and beverage industry silos, including creation, preservation, transformation, and conditioning, to make decisions on how to create, handle and process nutritional substances. Additionally, those who sell nutritional substances to consumers, such as restaurants and grocery stores, could market and price nutritional substances with higher nutritional content, or minimally degraded nutritional content.

For example, the grower of sweet corn generally only provides basic information as the variety and grade of its corn to the packager, who preserves and ships the corn to a producer for use in a ready-to-eat dinner. The packager may only tell the producer that the corn has been frozen as loose kernels of sweet corn. The producer may only provide the consumer with rudimentary instructions how to cook or reheat the ready-to-eat dinner in a microwave oven, toaster oven or conventional oven, and only tell the consumer that the dinner contains whole kernel corn among the various items in the dinner. Finally, the consumer of the dinner will likely keep her opinions on the quality of the dinner to herself, unless it was an especially bad experience, where she might contact the producer's customer support program to complain. Very minimal, or no, information on the nutritional content of the ready-to-eat dinner is passed along to the consumer. The consumer knows essentially nothing about changes (generally degradation) to the nutritional content of the sweet corn from creation, processing, packaging, cooking, preservation, preparation by consumer, and finally consumption by the consumer.

Consumers' needs are changing as consumers are demanding healthier foods, such as “organic foods.” Customers are also asking for more information about the nutritional substances they consume, such as specific characteristics' relating not only to nutritional content, but to allergens or digestive intolerances. For example, nutritional substances which contain lactose, gluten, nuts, dyes, etc. need to be avoided by certain consumers. However, the producer of the ready-to-eat dinner, in the prior example, has very little information to share other than possibly the source of the elements of the ready-to-eat dinner and its processing steps in preparing the dinner. Generally, the producer of the ready-to-eat dinner does not know the nutritional content and organoleptic state of the product after it has been reheated or cooked by the consumer. For example, the consumer may want to know what proportion of organoleptic properties and/or nutritional content the corn in the ready-to-eat dinner remain after cooking or reheating, and the change in nutritional content (usually a degradation). There is a need to preserve, measure, estimate, store and/or transmit such nutritional content information throughout the nutritional substance supply system.

The caloric and nutritional content information for a prepared food that is provided to the consumer is often minimal. For example, when sugar is listed in the ingredient list, the consumer generally does receive any information about the source of the sugar, which can come from a variety of plants, such as sugarcane, beets, or corn, which will affect its nutritional content. Conversely, some nutritional information that is provided to consumers is so detailed, the consumer can do little with it. For example, this this of ingredients is from a nutritional label on a consumer product: Vitamins—A 355 IU 7%, E 0.8 mg 4%, K 0.5 mcg, 1%, Thiamin 0.6 mg 43%, Riboflavin 0.3 mg 20%, Niacin 6.0 mg 30%, B6 1.0 mg 52%, Foliate 31.5 mcg 8%, Pantothenic 7%; Minerals Calcium 11.6 1%, Iron 4.5 mg 25%, 211 mg 53%, Phosphorus 349 mg 35%, Potassium 476 mg 14%, Sodium 58.1 mg 2%, Zinc 3.7 mg 24%, Copper 0.5 mg 26%, Manganese 0.8 mg 40%, Selenium 25.7 mcg 37%; Carbohydrate 123 g, Dietary fiber 12.1 g, Saturated fat 7.9 g, Monosaturated Fat 2.1 g, Polysaturated Fat 3.6 g, Omega 3 fatty acids 108 g, Omega 6 fatty acids 3481, Ash 2.0 g and Water 17.2 g. (%=Daily Value). There is a need to provide information about nutritional substances in a meaningful manner. Such information needs to be presented in a manner that meets the specific needs of a particular consumer. For example, consumers with a medical condition, such as diabetes, would want to track specific information regarding sugar and nutrients in the foods and beverages they consume.

If fact, each silo in the food and beverage industry already creates and tracks some information, including caloric and nutritional information, about their product internally. For example, the framer who grew the corn knows the variety of the seed, condition of the soil, the source of the water, the fertilizers and pesticides used, and can measure the caloric and nutritional content at creation. The packager of the corn knows when it was picked, how it was transported to the packaging plant, how the corn was preserved and packaged before being sent to the ready-to-eat dinner producer, when it was delivered to the producer, and what degradation to caloric and nutritional content has occurred. The producer knows the source of each element of the ready-to-eat dinner, how it was processed, including the recipe followed, and how it was preserved and packaged for the consumer. Not only does such a producer know what degradation to caloric and nutritional occurred, the producer can modify its processing and post-processing preservation to minimally affect nutritional content. The preparation of the nutritional substance for consumption can also degrade the nutritional content of nutritional substances. Finally, the consumer knows how she prepared the dinner, what condiments were added, and whether she did or did not enjoy it.

If there was a mechanism to share this information, the quality of the nutritional substances, including caloric and nutritional content, could be preserved and improved.

Consumers could be better informed about nutritional substances they select and consume, including the state of the nutritional substance throughout its lifecycle from creation to consumption. The efficiency and cost effectiveness of nutritional substances could also be improved. Feedback within the entire chain from creator to consumer could provide a closed-loop system that could improve quality (taste, appearance, and caloric and nutritional content), efficiency, value and profit. For example, in the milk supply chain, at least 10% of the milk produced is wasted due to safety margins included in product expiration dates. The use of more accurate tracking information, measured quality (including nutritional content) information, and historical environmental information could substantially reduce such waste. Collecting, preserving, measuring and/or tracking information about a nutritional substance in the nutritional substance supply system, would allow needed accountability. There would be nothing to hide.

As consumers are demanding more information about what they consume, they are asking for products that have higher nutritional content and more closely match good nutritional requirements, and would like nutritional products to actually meet their specific nutritional requirements. While grocery stores, restaurants, and all those who process and sell food and beverages may obtain some information from current nutritional substance tracking systems, such as labels, these current systems can provide only limited information.

Nutritional substances collectors and/or producers, such as growers (plants), ranchers (animals) or synthesizer (synthetic compounds), routinely create and collect information about their products, however, that information is generally not accessible by their customers. Even if such producers wished to provide such information to their customers, there is no current method of labeling, encoding or identifying each particular product to provide such information (even though all plants, animals and in general, nutritional substances have a natural fingerprint). While there are limited methods and systems available, they are excessively costly, time consuming, and do not trace, or provide access to, the nutritional substance organoleptic and/or nutritional state across the product's lifecycle. Current labels for such products include package labels, sticker labels and food color ink labels. These labels generally are applied to all similar products and cannot identify each particular product, only variety of products, such as apple banana, but not a particular banana.

Current packaging materials for nutritional substances include plastics, paper, cardboard, glass, and synthetic materials. Generally, the packaging material is chosen by the producer to best preserve the quality of the nutritional substance until used by the customer. In some cases, the packaging may include some information regarding type of nutritional substance, identity of the producer, and the country of origin. Such packaging generally does not transmit source information of the nutritional substance, such as creation information, current or historic information as to the external conditions of the packaged nutritional substance, or current or historic information as to the internal conditions of the packaged nutritional substance.

Traditional food processors take nutritional substances from producers and transform them into nutritional substances for consumption by consumers. While they have some knowledge of the nutritional substances they purchase, and make such selections to meet the needs of the consumers, they generally do not transmit that information along to consumers, nor change the way they transform the nutritional substances based on the history or current condition of the nutritional substances they receive for transformation.

Consumers of nutritional substances are sometimes given options on how to prepare nutritional substances they have obtained from the store, such as different cooking devices: microwave ovens, conventional ovens, etc., and/or limited taste preferences such as crunchy or soft. However, if the consumer desires to prepare a specific recipe, they must obtain all the proper ingredients themselves, as well as prepare the recipe themselves including which cooking appliances need to be used.

All through the nutritional substance supply and consumption chain the various suppliers benefit from feedback from consumers further up the supply chain. However, such feedback is disorganized and haphazard and can only be traced generally to the actual nutritional substances being commented on.

As consumers are demanding more information about what they consume, they are asking for products that have higher nutritional content and more closely match good nutritional requirements, and would like nutritional products to actually meet their specific nutritional requirements. While grocery stores, restaurants, and all those who process and sell food and beverages may obtain some information from current nutritional substance tracking systems, such as labels, these current systems can provide only limited information.

Traditional food processors take nutritional substances from producers and transform them into nutritional substances for consumption by consumers. While they have some knowledge of the nutritional substances they purchase, and make such selections to meet the needs of the consumers, they generally do not transmit that information along to consumers, nor change the way they transform the nutritional substances based on the history or current condition of the nutritional substances they receive for transformation.

An important issue in the creation, preservation, transformation, conditioning, and consumption of nutritional substances are the changes that occur in nutritional substances due to a variety of internal and external factors. Because nutritional substances are composed of biological, organic, and/or chemical compounds, they are generally subject to degradation. This degradation generally reduces the nutritional, organoleptic, and/or aesthetic values of nutritional substances. While not always true, nutritional substances are best consumed at their point of creation. However, being able to consume nutritional substances at the farm, at the slaughterhouse, at the fishery, or at the food processing plant is at least inconvenient, if not impossible. Currently, the food and beverage industry attempts to minimize the loss of nutritional value (often through the use of additives or preservatives), and/or attempts to hide this loss of nutritional value from consumers.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

It is an object of the present invention to obtain information as to the creation/origin of a nutritional substance, whether it is grown, caught, raised, or synthesized. Such information could be accessed by users or consumers of the nutritional substances by means of identification of specific nutritional substances. The means for identification can take the form tag of a label, wherein such a label can be attached to the nutritional substance. Such a label can be made up of a material attached to the nutritional substance or could be encoded directly on the nutritional substance.

It is an object of the present invention to obtain information as to the creation/origin of a nutritional substance, whether it is grown, raised, caught, recollected or synthesized. Such information could be accessed by users or consumers of the nutritional substances by means of identification of specific nutritional substances. The means for identification of a nutritional substance is done by a unique attribute of the nutritional substance is identified that can be used to reference the creation/origin information. Alternately, identification can be done by modifying the nutritional substance in a fashion which does not affect the nutritional quality or taste of the nutritional substance that allows the nutritional substance to be uniquely identified to reference the creation information.

It is an object of the present invention to obtain information as to the creation/origin of a nutritional substance, whether it is grown, raised, caught, collected, or synthesized. Such information could be accessed by users or consumers of the nutritional substances by means of identification of specific nutritional substances. The means for identification of a nutritional substance is done by a unique genetic attribute of the nutritional substance is identified that can be used to reference the creation information. Alternately, identification can be done by modifying the genetic attributes nutritional substance in a fashion which does not affect the nutritional quality or taste of the nutritional substance that allows the nutritional substance to be uniquely identified to reference the creation information.

It is an object of the present invention to minimize and/or track degradation of nutritional, organoleptic, and/or aesthetic value of nutritional substances, and/or collect, store, and/or transmit information regarding this degradation.

It is an object of the present invention to preserve the nutritional substance such that its source information and/or historical preservation information, including external influences on the nutritional substance, are available to users and/or consumers of the nutritional substance.

A further object of the present invention is to provide packaging which interacts with the nutritional substance to maintain and/or improve the nutritional substance being preserved.

It is an object of the present invention to preserve the nutritional substance such that its source information and/or historical preservation information, including external influences on the nutritional substance, are available to users and/or consumers of the nutritional substance.

An object of the present invention, the packaging or label of a nutritional substance tracks creation and historical information of nutritional substance as well as current information about the state of the nutritional substance.

A further object of the present invention is to provide packaging which interacts with the nutritional substance to maintain and/or improve the nutritional substance being preserved.

It is an object of the present invention to preserve the nutritional substance such that its source information and/or historical preservation information, including external influences on the nutritional substance, are available to users and/or consumers of the nutritional substance.

An object of the present invention, the packaging of a nutritional substance tracks creation and historical information of nutritional substance as well as current information about the state of the nutritional substance.

A further object of the present invention is to provide packaging which interacts with the nutritional substance to maintain and/or improve the nutritional substance being preserved.

It is an object of the present invention to minimize and/or track degradation of nutritional, organoleptic, and/or aesthetic value of nutritional substances, and/or collect, store, and/or transmit information regarding this degradation.

It is an object of present invention that a transformer of nutritional substance maintains creation and/or preservation information for components of a transformed nutritional substance.

It is an object of present invention that a transformer of nutritional substance maintains creation and/or preservation information for components of a transformed nutritional substance.

It is another object of the present invention that a transformer of nutritional substance maintains creation and/or preservation information for components of a transformed nutritional substance and additionally provides information regarding the transformation.

It is an object of present invention that a transformer of nutritional substance maintains creation and/or packaging information for components of a transformed nutritional substance.

It is another object of the present invention that a transformer of nutritional substance maintains creation and/or packaging information for components of a transformed nutritional substance and additionally provides information regarding the transformation.

It is a further object of the present invention to utilize the source and packaging information to modify the transformation of the nutritional substance to preserve nutritional value and/or improve the quality of the transformed nutritional substance. Additionally, such information can be used by an automated system to automatically preserve nutritional value and/or improve the quality of the transformed nutritional substance.

It is another object of the present invention to obtain information regarding the source, packaging and transformation of the nutritional substance, and the conditioning of the nutritional substance to provide to the consumer.

It is a further object of the present invention to modify the conditioning of the nutritional substance according to the source, packaging and/or transformation information.

It is a further object of the present invention to use source, packaging and transformation information to appropriately select the conditioning settings for a single conditioning apparatus and/or multiple conditioning apparatuses.

It is another object of the present invention to select the conditioning settings according to the preferences and/or needs of the consumer.

It is a further object of the present invention to use external recipe information to modify the conditioning of a nutritional substance according to the needs and/or tastes of the consumer.

It is an object of the present invention to minimize and/or track degradation of nutritional, organoleptic, and/or aesthetic value of nutritional substances, and/or collect, store, and/or transmit information regarding this degradation.

It is an object of the present invention to obtain consumer feedback on the consumption of the nutritional substance and provide such feedback to one or more of the nutritional substance creator, packager, transformer and/or conditioner.

An additional object of the present invention is to create a multi-dimensional database of such information for use and analysis by the nutritional substance creator, packager, transformer and/or conditioner.

It is an object of the present invention to provide a communication system which collects, tracks, organizes information from each stage of the production of nutritional substances from creation to consumption. It is a further object of the present invention to use such information to modify the creation, packaging, transformation, conditioning and consumption of nutritional substances. It is a further object of the present invention to do so in a manner that preserves and/or enhances the nutritional value and/or taste of the nutritional substances across their lifecycle.

It is a further object of the present invention to collect, store and provide information on the consumer of the nutrition substance.

It is an object of the present invention to provide an information system for nutritional substance which could be accessed by both nutritional substance industry participants and non-nutritional substance entities, including consumers.

It is an object of the present invention to provide a communication system which collects, tracks, organizes information from each stage of the production of nutritional substances from creation to consumption. It is a further object of the present invention to use such information to modify the creation, packaging, transformation, conditioning and consumption of nutritional substances. It is a further object of the present invention to do so in a manner that preserves and/or enhances the nutritional value and/or taste of the nutritional substances across their lifecycle.

It is a further object of the present invention to collect, store and provide information on the consumer of the nutrition substance.

It is an object of the present invention to minimize and/or track degradation of nutritional, organoleptic, and/or aesthetic value of nutritional substances, and/or collect, store, and/or transmit information regarding this degradation.

### SUMMARY OF THE INVENTION

In an embodiment of the present invention, information as to the creation/origin of a nutritional substance, whether it is grown, caught, raised, or synthesized is obtained and stored. The means for identification can take the form tag of a label, wherein such a label can be attached to the nutritional substance. Such a label can be made up of a material attached to the nutritional substance or could be encoded directly on the nutritional substance.

In another embodiment of the present invention, information as to the creation/origin of a nutritional substance, whether it is grown, raised, caught, recollected or synthesized is referenced by means of identification of specific nutritional substances. The means for identification of a nutritional substance is done by a unique attribute of the nutritional substance is identified that can be used to reference the creation/origin information. Alternately, identification can be done by modifying the nutritional substance in a fashion which does not affect the nutritional quality or taste of the nutritional substance that allows the nutritional substance to be uniquely identified to reference the creation information.

In another embodiment of the present invention, information as to the creation/origin of a nutritional substance, whether it is grown, raised, caught, collected, or synthesized is referenced by identification of a nutritional substance by a unique genetic attribute of the nutritional substance is identified that can be used to reference the creation information. Alternately, identification can be done by modifying the genetic attributes nutritional substance in a fashion which does not affect the nutritional quality or taste of the nutritional substance that allows the nutritional substance to be uniquely identified to reference the creation information.

In one embodiment of the present invention, the packaging for a nutritional substance allows for the tracking of source information, information as to the history of the nutritional substance from the point it was packaged and/or current information on outside influences on the packaged nutritional substance.

In another embodiment of the present invention the packaging for the nutritional substance can provide information to the consumer as to the current state of the nutritional substance.

In a further embodiment of the present invention, the packaging of the nutritional substance can interact with the nutritional substance to preserve and/or enhance the nutritional substance.

In one embodiment of the present invention, the packaging for a nutritional substance allows for the tracking of source information, information as to the history of the nutritional substance from the point it was packaged and/or current information on outside influences on the packaged nutritional substance.

In another embodiment of the present invention the packaging/label for the nutritional substance can provide information to the consumer as to the current state of the nutritional substance.

In a further embodiment of the present invention, the packaging of the nutritional substance can interact with the nutritional substance to preserve and/or enhance the nutritional substance.

In an embodiment of the present invention, the transformer of nutritional substances obtains and transmits source and/or preservation information to users and/or consumers of the transformed nutritional substance.

In an embodiment of the present invention, the transformer of nutritional substances obtains and transmits source and/or preservation information to users and/or consumers of the transformed nutritional substance.

In another embodiment of the present invention, the transformer of nutritional substances obtains and transmits source and/or preservation information and information regarding the transformation to users and/or consumers of the transformed nutritional substance.

In an embodiment of the present invention, the transformer of nutritional substances obtains and transmits source and/or packaging information to users and/or consumers of the transformed nutritional substance.

In another embodiment of the present invention, the transformer of nutritional substances obtains and transmits source and/or packaging information and information regarding the transformation to users and/or consumers of the transformed nutritional substance.

In a further embodiment of the present invention, the source and/or packaging information is used by the transformer to modify the transformation of the of nutritional substances obtains and transmits source and/or packaging information to users and/or consumers of the transformed nutritional substance so as to preserve nutritional value and/or improve the quality of the transformed nutritional substance.

In another embodiment of the present invention, the source packaging information of the component nutritional substance to automatically transform the nutritional substance so as to preserve nutritional value and/or improve the quality of the transformed nutritional substance.

In an embodiment of the present invention, information regarding the source, packaging and transformation of a nutritional substance is transmitted to the consumer following the conditioning of the product.

In another embodiment of the present invention, information regarding the source, packaging and transformation of a nutritional substance is used in the conditioning of the nutritional substance to preserve nutritional value and/or improve the quality of the conditioned nutritional substance.

In a further embodiment of the present invention, that one or more conditions apparatuses use source, packaging and/or transformation information to modify the conditioning of the nutritional substance.

In another embodiment of the present invention, the consumer's needs and/or preferences are used by the conditioning apparatus in the preparation of the nutritional substance.

In a further embodiment of the present invention, external recipe information is used by the conditioning apparatus to modify the conditioning of the nutritional substance.

In one embodiment of the present invention, consumer feedback information regarding consumed nutritional substances is collected and correlated to the source, packaging, transformation and/or conditioning information. Such information could be made available to the creator, packager, transformer and/or conditioner of the nutritional substance.

In another embodiment of the present invention, such correlated information would be stored and analyzed in a multi-dimensional database.

In one embodiment of the present invention, information relating to the creation/origin of a nutritional substance is traceable to any precedent or subsequent user or consumer of that nutritional substance. Similarly, information regarding the packaging of a nutritional substance is also passed to precedent and subsequent users and/or consumers of the nutritional substance. Additionally, information regarding the transformation of a nutritional substance is passed along providing access to experts, professionals and the consumer of the nutritional substance and can be used to make nutritional substance selection as well as to modify nutritional substance preparation, trace its origin and organoleptic state throughout their its cycle and related to any stored information of its database or in real time across the globe.

In another embodiment of the present invention, such information could be mapped out regarding the creation, packaging, transformation, and conditioning of the nutritional substance is used by a subsequent user or consumer of the nutritional substance to modify their use, preservation, transformation and/or conditioning of the nutritional substance.

In another embodiment of the present invention, such information could be mapped out regarding the creation, packaging, transformation, and conditioning of the nutritional substance is used by a subsequent user or consumer of the nutritional substance to modify their use, preservation, transformation and/or conditioning of the nutritional substance.

In another embodiment of the present invention, the information collected by the creator, packager, transformer, conditioner and consumer is stored in a multi-dimensional database for analysis. Additionally, such information is transmitted to the creators, packager, transformers, conditioners and consumers for nutritional substance and process improvement. The transmission of such information can be accomplished using any form of telecommunication, including wireless communication.

In another embodiment of the present invention, the information collected by the creator, packager, transformer, conditioner and consumer is stored in a multi-dimensional database for analysis. Additionally, such information is transmitted to the creators, packager, transformers, conditioners and consumers for nutritional substance and process improvement. The transmission of such information can be accomplished using any form of telecommunication, including wireless communication.

In the preferred embodiment of the present invention, information regarding the consumer is used dynamically within the system to modify the creation, preservation, transformation, conditioning and selection of nutrition substances to meet the consumer's needs.

In the preferred embodiment of the present invention, information regarding the consumer is used dynamically within the system to modify the creation, preservation, transformation, conditioning and selection of nutrition substances to meet the consumer's needs.

In an embodiment of the present invention, the transformer of nutritional substances obtains and transmits source and/or preservation information to users and/or consumers of the transformed nutritional substance.

In an embodiment of the present invention, the transformer of nutritional substances obtains and transmits source and/or preservation information to users and/or consumers of the transformed nutritional substance.

In another embodiment of the present invention, the transformer of nutritional substances obtains and transmits source and/or preservation information and information regarding the transformation to users and/or consumers of the transformed nutritional substance.

In an embodiment of the present invention, the transformer of nutritional substances obtains and transmits source and/or packaging information to users and/or consumers of the transformed nutritional substance.

In another embodiment of the present invention, the transformer of nutritional substances obtains and transmits source and/or packaging information and information regarding the transformation to users and/or consumers of the transformed nutritional substance.

In a further embodiment of the present invention, the source and/or packaging information is used by the transformer to modify the transformation of the of nutritional substances obtains and transmits source and/or packaging information to users and/or consumers of the transformed nutritional substance so as to preserve nutritional value and/or improve the quality of the transformed nutritional substance.

In another embodiment of the present invention, the source packaging information of the component nutritional substance to automatically transform the nutritional substance so as to preserve nutritional value and/or improve the quality of the transformed nutritional substance.

An embodiment of the present invention provides a system for the creation, collection, storage, transmission, and/or processing of information regarding nutritional substances so as to improve, maintain, or minimize degradation of nutritional, organoleptic, and/or aesthetic value of nutritional substances. Additionally, the present invention provides such information for use by the creators, preservers, transformers, conditioners, and consumers of nutritional substances. The nutritional information creation, preservation, and transmission system of the present invention should allow the nutritional substance supply system to improve its ability to minimize degradation of nutritional, organoleptic and/or aesthetic value of the nutritional substance, and/or inform the consumer about such degradation. While the ultimate goal of the nutritional substance supply system is to minimize degradation of nutritional, organoleptic and/or aesthetic value, an interim goal should be providing consumers with significant information regarding degradation of nutritional substances consumers select and consume. Entities within the nutritional substance supply system who provide such information regarding nutritional substance degradation will be able to differentiate their products from those who obscure and/or hide such information. Additionally, such entities should be able to charge a premium for products which either maintain their nutritional, organoleptic, and/or aesthetic value, or supply more complete information.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of a nutritional substance supply relating to the present invention;

FIG. 2 shows a graph representing a value of a nutritional substance which changes according to a change of condition for the nutritional substance;

FIG. 3 shows a schematic functional block diagram of the creation module 200 according to the present invention;

FIG. 4 shows a schematic functional block diagram of the creation module 200 according to an alternate embodiment of the present invention;

FIG. 5 shows a schematic functional block diagram of the creation module 200 according to an alternate embodiment of the present invention;

FIG. 6 shows a schematic functional block diagram of the creation module 200 according to an alternate embodiment of the present invention;

FIG. 7 shows a schematic functional block diagram of the creation module 200 according to an alternate embodiment of the present invention;

FIG. 8 shows a schematic functional block diagram of the preservation module 300 according to the present invention;

FIG. 9 shows a schematic functional block diagram of the preservation module 300 according to an alternate embodiment of the present invention;

FIG. 10 shows a schematic functional block diagram of the preservation module 300 according to an alternate embodiment of the present invention;

FIG. 11 shows a schematic functional block diagram of the preservation module 300 according to an alternate embodiment of the present invention;

FIG. 12 shows a schematic functional block diagram of the preservation module 300 according to an alternate embodiment of the present invention;

FIG. 13 shows a schematic functional block diagram of the preservation module 300 according to an alternate embodiment of the present invention;

FIG. 14 shows a schematic functional block diagram of the preservation module 300 according to an alternate embodiment of the present invention;

FIG. 15 shows a schematic functional block diagram of the preservation module 300 according to an alternate embodiment of the present invention;

FIG. 16 shows a schematic functional block diagram of the preservation module 300 according to an alternate embodiment of the present invention;

FIG. 17 shows a schematic functional block diagram of the preservation module 300 according to an alternate embodiment of the present invention;

FIG. 18 shows a schematic functional block diagram of the preservation module 300 according to an alternate embodiment of the present invention;

FIG. 19 shows a schematic functional block diagram of the transformation module 400 according to the present invention;

FIG. 20 shows a schematic functional block diagram of the transformation module 400 according to the present invention;

FIG. 21 shows a schematic functional block diagram of the transformation module 400 according to the present invention;

FIG. 22 shows a schematic functional block diagram of the conditioning module 500 according to the present invention;

FIG. 23 shows a schematic functional block diagram of the conditioning module 500 according to an alternate embodiment of the present invention;

FIG. 24 shows a schematic functional block diagram of the conditioning module 500 according to an alternate embodiment of the present invention;

FIG. 25 shows a schematic functional block diagram of the conditioning module 500 according to an alternate embodiment of the present invention;

FIG. 26 shows a schematic functional block diagram of the consumer information module 600 according to the present invention;

FIG. 27 shows a schematic functional block diagram of the consumer information module 600 according to an alternate embodiment of the present invention;

FIG. 28 shows a schematic functional block diagram of the consumer information module 600 according to the present invention;

FIG. 29 shows a schematic functional block diagram of the consumer information module 600 according to an alternate embodiment of the present invention;

FIG. 30 shows a schematic functional block diagram of the consumer information module 600 according to the present invention;

FIG. 31 shows a schematic functional block diagram of the consumer information module 600 according to an alternate embodiment of the present invention;

FIG. 32 shows a schematic functional block diagram of a nutritional substance supply relating to an alternate embodiment of the present invention;

FIG. 33 shows a schematic functional block diagram of a nutritional substance supply relating to an alternate embodiment of the present invention; and

FIG. 34 shows a schematic functional block diagram of the nutritional substance information system of the present invention, and its interconnection to various systems.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, WiFi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The modules in the systems can be understood to be integrated in some instances and in particular embodiments, only particular modules may be interconnected.

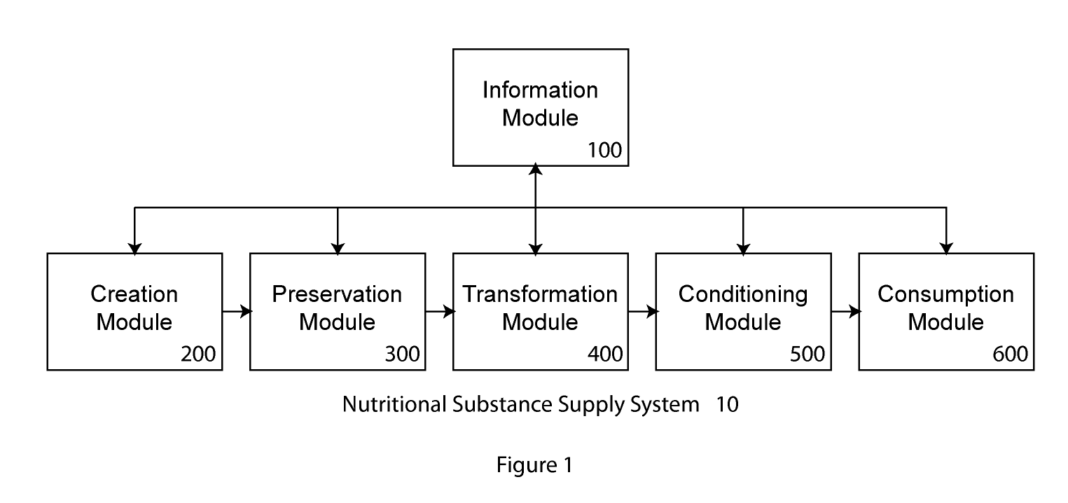

FIG. 1 shows the components of a nutritional substance industry 10. It should be understood that this could be the food and beverage and beverage ecosystem for human consumption, but could also be the feed industry for animal consumption, such as the pet food industry, or even the agricultural ecosystem for the cultivation of plants. A goal of the present invention for nutritional substance industry 10 is to create, preserve, transform and trace the qualitative, organoleptic and nutritional properties of nutritional substances through their creation, preservation, transformation, conditioning and consumption. While the nutritional substance industry 10 can be composed of many companies or businesses, it can also be integrated into combinations of business serving many roles, or can be one business or even individual.

Module 200 is the creation module. This can be system, organization, or individual which creates and/or originates nutritional substances. Examples of this module include a farm which grows produce. It can be a ranch which raises beef. It can be an aquaculture far for growing shrimp. It could be a factory with synthesizes nutritional compounds. It could be collector of wild truffles. If could be a deep sea crab trawler.

Preservation module 300 is a preservation system for preserving and protecting the nutritional substances created by creation module 200. Once the nutritional substance has been created, generally, it will need to be packaged in some manner for its transition to other modules in the nutritional substances industry 10. While preservation module 300 is shown in a particular position in the nutritional substance industry 10, following the creation module 200, it should be understood that the preservation module 300 actual can be placed anywhere nutritional substances need to be preserved during their transition from creation to consumption.

Transformation module 400 is a nutritional substance processing system, such as a manufacturer who processes raw materials such as grains into breakfast cereals. Transformation module 400 could also be a ready-to-eat dinner manufacturer who receives the components for a ready-to-eat dinner from preservation module 300 and prepares them into a frozen dinner. While transformation module 400 is depicted as one module, it will be understood that nutritional substances may be transformed by a number of transformation modules 400 on their path to consumption.

Conditioning module 500 is a consumer preparation system for preparing the nutritional substance immediately before consumption by the consumer. Conditioning module 500 can be a microwave oven, a blender, a toaster, a convection oven, a cook, etc. It can also be systems used by commercial establishments to prepare nutritional substance for consumers such as a restaurant, an espresso maker, pizza oven, and other devices located at businesses which provide nutritional substances to consumers. Such nutritional substances could be for consumption at the business or for the consumer to take out from the business. Conditioning module 500 can also be a combination of any of these devices used to prepare nutritional substances for consumption by consumers.

Consumer module 600 collects information from the living entity which consumes the nutritional substance which has passed through the various modules from creation to consumption. The consumer can be a human being, but could also be an animal, such as pets, zoo animals and livestock, which are they themselves nutritional substances for other consumption chains. Consumers could also be plant life which consumes nutritional substances to grow.

Information module 100 receives and transmits information regarding a nutritional substance between each of the modules in the nutritional substance industry 10 including, the creation module 200, the preservation module 300, the transformation module 400, the conditioning module 500, and the consumer module 600. The nutritional substance information module 100 can be an interconnecting information transmission system which allows the transmission of information between various modules. Information module 100 contains a database where the information regarding the nutritional substance resides. Information module 100 can be connected to the other modules by a variety of communication systems, such as paper, computer networks, the internet and telecommunication systems, such as wireless telecommunication systems.

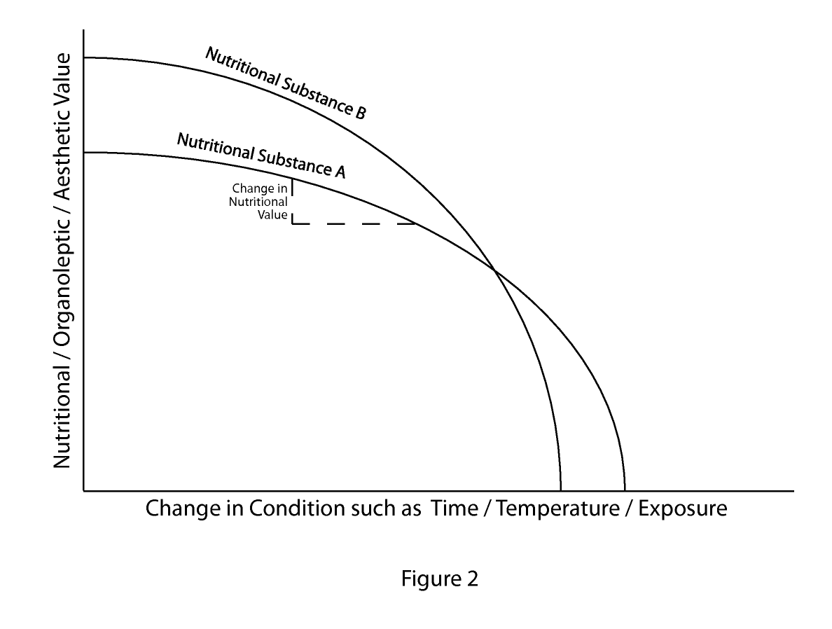

FIG. 2 is a graph showing the function of how a value of a nutritional substance varies over the change in a condition of the nutritional substance. Plotted on the vertical axis of this graph can be either the nutritional value, organoleptic value, or even the aesthetic value of a nutritional substance. Plotted on the horizontal axis can be the change in condition of nutritional substance over a variable such as time, temperature, location, and/or exposure to environmental conditions. This exposure to environmental conditions can include exposure to air, including oxygen, exposure to moisture, exposure to radiation such as heat or sunlight, or exposure to materials such as packaging. The function plotted as nutritional substance A could show the degradation of in the nutritional value of milk over time. Any point on this curve can be compared to another point to measure and/or describe the change in nutritional value. The plot of the degradation in nutritional value of nutritional substance B describes a nutritional substance which starts out with a higher nutritional value than nutritional substance A, but degrades over time more quickly than nutritional substance A.

If, in this example, where nutritional substance A and nutritional substance B are milk, this information regarding the nutritional substance degradation profile of each milk could be used by the consumer in the selection and/or consumption of the milk. If the consumer has this information at time zero when selecting a milk product for purchase, the consumer could consider when the consumer plans to consume the milk, whether that is on one occasion or multiple occasions. For example, if the consumer planned to consume the milk prior to the point when the curve represented by nutritional substance B crosses the curve represented by nutritional substance A, then the consumer should choose the milk represented by nutritional substance B because it has a higher nutritional value until it crosses the curve represented by nutritional substance A. However, if the consumer expects to consume at least some of the milk at a point in time after the time when the curve represented by nutritional substance B crosses the curve represented by nutritional substance A, then the consumer might choose to select the milk represented by the nutritional substance A, even though milk represented by nutritional substance A has a lower nutritional value than the milk represented by nutritional substance B at an earlier time. This change to a desired value in a nutritional substance over a change in the nutritional substance described in FIG. 2 can be measured and/or controlled throughout nutritional substance supply system 10 in FIG. 1.

In FIG. 1, Creation module 200 can dynamically encode nutritional substances to enable the tracking of nutritional, organoleptic, and/or aesthetic value of the nutritional substance. This dynamic encoding can replace and/or complement existing nutritional substance marking systems such as barcodes, labels, and/or ink markings. This dynamic encoding can be used to make nutritional substance information from creation module 200 available to information module 100 for use by preservation module 300, transformation module 400, conditioning module 500, and/or consumption module 600, which includes the ultimate consumer of the nutritional substance. One method of marking the nutritional substance by creation module 200 (or actually any other module in nutritional supply system 10) could include an electronic tagging system, such as the tagging system manufactured by Kovio of San Jose, Calif., USA. Such thin film chips can be used not only for tracking nutritional substances, by can include components to measure attributes of nutritional substances, and record and transmit such information. Such information may be readable by a reader including a satellite-based system. Such a satellite-based nutritional substance information tracking system could comprise a network of satellites with coverage of some or all the surface of the earth, so as to allow information module 100 real time, near real time updates about a particular nutritional substance.

Preservation module 300 includes packers and shippers of nutritional substances. The tracking of nutritional, organoleptic, and/or aesthetic values during the preservation period within preservation module 300 allows for dynamic expiration dates for nutritional substances. For example, expiration dates for dairy products are currently based generally only on time using assumptions regarding minimal conditions at which dairy products are maintained. This extrapolated expiration date is based on a worst-case scenario for when the product becomes unsafe to consume during the preservation period. In reality, the degradation of dairy products may be significantly less than this worst-case. If preservation module 300 could measure or derive the actual degradation information, the actual expiration date could be significantly later in time. This would allow the nutritional substance supply system to dispose of fewer products due to expiration dates. This ability to dynamically generate expiration dates for nutritional substances is of particular significance when nutritional substances contain few or no preservatives. Such products are highly valued throughout nutritional substance supply system 10, including consumers who are willing to pay a premium for nutritional substances with few or no preservatives.

By law, in many localities, food processors such as those in transformation module 400 are required to provide nutritional substance information regarding their products. Often, this information takes the form of a nutritional table applied to the packaging of the nutritional substance. Currently, the information in this nutritional table is based on averages or minimums for their typical product. Using the nutritional substance information from information module 100 provided by creation module 200, preservation module 300, and/or information from the transformation of the nutritional substance by transformation module 400, the food processor could include a nutritional table for the actual nutritional substance being supplied. The information in such a dynamically generated nutritional table could be used by conditioning module 500 in the preparation of the nutritional substance, and/or used by consumption module 600, so as to allow the ultimate consumer the ability to select the most desirable nutritional substance which meets their needs, and/or to track information regarding nutritional substances consumed.

The change in nutritional, organoleptic, and/or aesthetic value by conditioning module 500 is currently not tracked or provided to the consumer. However, using information provided by information module 100 from creation module 200, preservation module 300, transformation module 400, and/or information measured or generated by conditioning module 500, conditioning module 500 could provide consumer with the actual, and/or estimated change in nutritional, organoleptic, and/or aesthetic values of the nutritional substance. Such information regarding the change to nutritional, organoleptic and/or aesthetic value of the nutritional substance could be provided not only to the consumer, but could also be provided to information module 100 for use by creation module 200, preservation module 300, transformation module 400, so as to track, and possibly improve nutritional substances throughout the entire nutritional substance supply system 10.

The information regarding nutritional substances provided by information module 100 to consumption module 600 can replace or complement existing information sources such as recipe books, food databases like www.epicurious.com, and Epicurious apps. Through the use of specific information regarding a nutritional substance from information module 100, consumers can use consumption module 600 to select nutritional substances according to nutritional, organoleptic, and/or aesthetic values. This will allow consumers to make informed decisions regarding nutritional substance additives, preservatives, genetic modifications, origins, traceability, and other nutritional substance attributes. This information can be provided by consumption module 600 through personal computers, laptop computers, tablet computers, and/or smartphones. Software running on these devices can include dedicated computer programs, modules within general programs, and/or smartphone apps. An example of such a smartphone app regarding nutritional substances is the iOS ShopNoGMO from the Institute for Responsible Technology. This iPhone app allows consumers access to information regarding non-genetically modified organisms they may select. Additionally, consumption module 600 may provide information for the consumer to operate conditioning module 500 in such a manner as to preserve nutritional, organoleptic, and/or aesthetic value.

Through the use of nutritional substance information available from information module 100 nutritional substance supply system 10 can track nutritional, organoleptic, and/or aesthetic value. Using this information, nutritional substances travelling through nutritional substance supply system 10 can be dynamically valued and priced according to nutritional, organoleptic, and/or aesthetic values. For example, nutritional substances with longer expiration dates (longer shelf life) may be more highly valued than nutritional substances with shorter expiration dates. Additionally, nutritional substances with higher nutritional, organoleptic, and/or aesthetic values may be more highly valued, not just by the consumer, but also by each entity within nutritional substance supply system 10. This is because each entity will want to start with a nutritional substance with higher nutritional, organoleptic, and/or aesthetic value before it performs its function and passes the nutritional substance along to the next entity.

During the period of implementation of the present inventions, there will be nutritional substances being marketed which including the information, information-enabled nutritional substances, and nutritional substances which are not information enabled, dumb nutritional substances. Information-enabled nutritional substances would be available in virtual internet marketplaces, as well as traditional marketplaces. Because of information provided by information-enabled nutritional substances, entities within the nutritional substance suppOly system 10, including consumers, would be able to review and select information-enabled nutritional substances for purchase. It should be expected that, initially, the information-enabled nutritional substances would enjoy a higher market value and price than dumb nutritional substances. However, as information-enabled nutritional substances become more the norm, the cost savings from less waste due to degradation of information-enabled nutritional substances could lead to their price actually becoming less than dumb nutritional substances.

For example, the producer of a ready-to-eat dinner would prefer to use corn of a high nutritional, organoleptic, and/or aesthetic value in the production of its product, the ready-to-eat dinner, so as to produce a premium product of high nutritional, organoleptic, and/or aesthetic value. Depending upon the levels of the nutritional, organoleptic, and/or aesthetic values, the ready-to-eat dinner producer may be able to charge a premium price and/or differentiate its product from that of other producers. When selecting the corn to be used in the ready-to-eat dinner, the producer will seek corn of high nutritional, organoleptic, and/or aesthetic value from preservation module 300 that meets its requirements for nutritional, organoleptic, and/or aesthetic value. The packager/shipper of preservation module 300 would also be able to charge a premium for corn which has high nutritional, organoleptic, and/or aesthetic values. And finally, the packager/shipper of preservation module 300 will select corn of high nutritional, organoleptic, and/or aesthetic value from the grower of creation module 200, who will also be able to charge a premium for corn of high nutritional, organoleptic, and/or aesthetic values.

The nutritional, organoleptic, and/or aesthetic value for a nutritional substance tracked through nutritional substance supply system 10 through nutritional substance information from information module 100 can be preferably measured information. However, some or all such nutritional substance information may be derived through measurements of environmental conditions of the nutritional substance as it travelled through nutritional substance supply system 10. Additionally, some or all of nutritional substance information can be derived from data of other nutritional substances which have travelled through nutritional substance supply system 10. Finally, nutritional substance information can also be derived from laboratory experiments performed on other nutritional substances, which may approximate conditions and/or processes to which the actual nutritional substance has been exposed.

For example, laboratory experiments can be performed on bananas to determine effect on nutritional, organoleptic, and/or aesthetic value for a variety of environmental conditions bananas may be exposed to during packaging and shipment in preservation module 300. Using this experimental data, tables and/or algorithms could be developed which would predict the level of nutritional, organoleptic, and/or aesthetic values for a particular banana based upon information collected regarding the environmental conditions to which the banana was exposed during its time in preservation module 300. While the ultimate goal for nutritional substance supply system 10 would be the actual measurement of nutritional, organoleptic, and/or aesthetic values, use of derived nutritional, organoleptic, and/or aesthetic value from experimental information would allow more accurate tracking of nutritional, organoleptic, and/or aesthetic values while technology and systems are put in place to allow actual measurement.

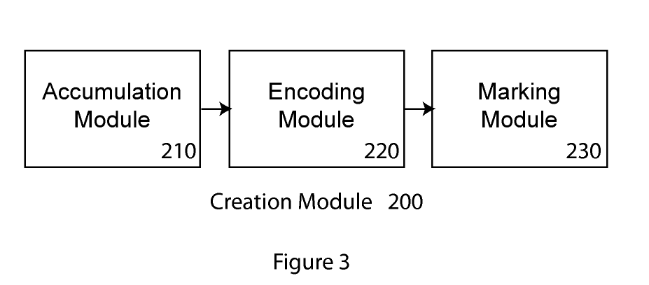

FIG. 3 shows an embodiment of the creation/origin module of the present invention. During the creation/origin of the nutritional substance, creation information regarding the origin and creation of the nutritional substance can be accumulated by accumulation module 210. This creation information is generally known by the creator of the nutritional substance. For example, the grower of sweet corn, knows the land and contacts the seed and traits producer to decide on the seeds that need to be planted in consequence knows the seeds that were planted, knows where the corn seed is planted, when the corn seed was planted, the soil conditions, the source of the water used to irrigate the corn, when the corn is to be harvested or the truffles gathered. Additionally, the grower knows what fertilizers, pesticides, and other substances were used to nourish and protect during growing of the corn.

Accumulation module 210 receives and stores all such creation information that is available from the grower. Accumulation module 210 can take the form of a computer running a data storage program, such as a database.

In another example from the meat industry, the rancher raising a cow for beef knows the cows parental lineage, knows how the cow was raised, whether in a controlled environment or on the open range, and knows when the cow was slaughtered. Additionally, the rancher knows the medical history of the cow, including its general health, any diseases or injuries it suffered, and any medical treatment it received. Additionally, the rancher knows of the cow's immunization history and any medications, supplements and vaccines the cow was given, such as hormones, antibiotics and nutritional supplements. Also the rancher has all the information of the cow's milk production cycle and of the rate of growth, if it has been free range grass fed or in a confined environment and the state and method used to have it slaughtered. This creation information can be accumulated by accumulator module 210 and in the same way we explained the process for the corn a database that could be monitored on real time though a local or global access network.

In another example, the creator of a synthetic nutritional substance knows the source of the molecules used to create the nutritional substance, such as a vitamin complex. A multi-vitamin manufacturer knows the source of the ascorbic acid modules (vitamin C), the source of magnesium and the source of iron, and knows how they were processed into the multi-vitamin. Such creation information would also be accumulated by accumulator module 210 and a database that could be monitored on real time though a local or global access network.

Encoding module 220 takes the nutritional substance creation information from the accumulation module 210 and transforms that information into a form that can be marked on the nutritional substance. The encoded information from encoding module 220 is transmitted to the marking module 230. The encoding module 220 can convert the creation information to the form needed for the marking module, such as a compact, formatted human-readable form. Alternately, encoding module 220 can convert the creation information into a compact machine readable form for imprinting by the marking module 230.

Encoding module 230 can create a label and/or code to be attached, incorporated, or detected, to the nutritional substance that contains the information which specifically pertains to that nutritional substance. The marking module 230 can create a standalone label which is attached to the nutritional substance, which will later be removed before use of the nutritional substance. Such labels can be made of paper, plastic, foil, cardboard, glass or other synthetic material or be integrated with and/or within the nutritional substance through irrigation, fertilization, nourishing, genetics, etc. . . . .

Alternately, the marking module can create the label directly on or detect the nutritional substance in a fashion that does not degrade the nutritional substance. Examples include ink made for edible food dye, laser etching of nutritional substance surface, and branding by heat or chemicals or identification of the particular molecules or particular organoleptic characteristics contained or incrusted onto the nutritional substance itself.

Additionally, marking module 230 can generate a label to apply to the nutritional substance which is consumable along with the nutritional substance. Examples include rice paper, edible substances and materials from other nutritional substances.

The label created by marking module 230 may contain the information from accumulation module 210 encoded by encoding module 220 in consumer readable form. Such a label could list the various creation information so that a consumer could read it, for example variety of the banana, where it was grown, when it was planted and harvested, and any non-natural substances that were added to the banana during its cultivation. Such information may be compacted using industry standards that consumers have learned to read and through the combination or mix of ingredients and or sequence on which the ingredients are grown/raised, processed/treated and-or prepared for consumption.

In another example, a package of hamburger meat could include a label containing creation information, such as the lineage of the cow, where and when it was raised and slaughtered, what it was fed, and any nutritional supplements it was given.

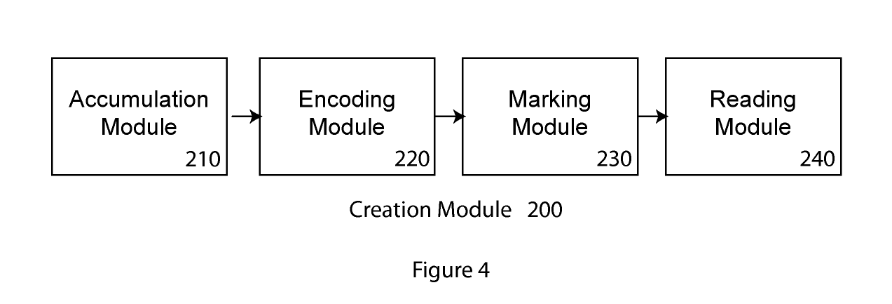

In FIG. 4, the information from accumulation module 210 is encoded by encoding module 220 in a compact, machine readable form which is used by the marking module 230 to create the label. Such a label could be in the form of a barcode or QR Code. In this case, the information is still stored directly on the nutritional substance, but will require reader module 240 to retrieve the information.

In the case of the package of hamburger meat, the user of the hamburger meat would use label reader 240 to retrieve the creation information from the label. If the user is a hamburger patty manufacturer, it will utilize the creation information obtained from label reader 240 to track the hamburger patty products it produces and ships to its customers. It could use such creation information in the preparation of the hamburger patty. For example, such creation information could affect how the hamburger meat is cooked. The user could also pass such creation information along to its customers along with its manufacturing information including in the way it was raised “grass fed” or slaughtered “kosher”.

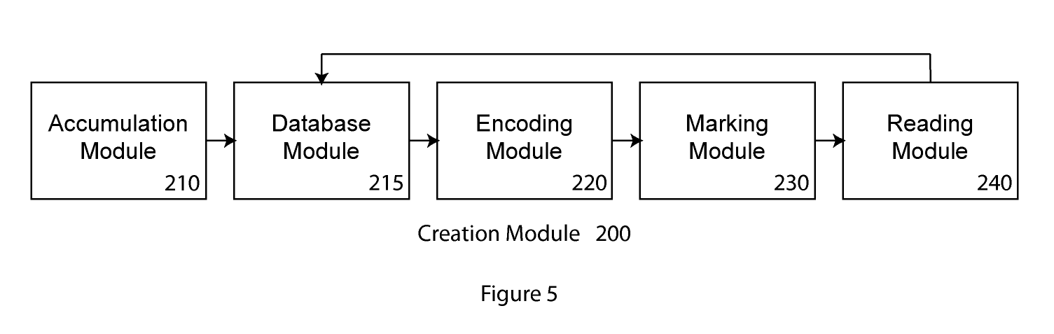

FIG. 5 is an embodiment of the present invention where the creation information is stored in a database for eventual reference by the user of the nutritional substance. Accumulation module 210 accumulates the creation information from the nutritional substance's creation, this information is stored in database module 215 and could be monitored in real time though a local or global access network.

Database module 215 stores the information in a persistent format for later use by the users of the nutritional substance. In its preferred embodiment, encoding module 220 generates a reference code for the creation information stored in database module 215, which it provides to marking module 230 creates a label for the nutritional substance which includes the reference code. The reference code on the label created by the marking module 230 can be in human readable form, such as an alphanumeric code. In such a case, the user of the nutritional substance could use the reference code to obtain the creation information from database 215. Access to database module 215 by a user of the nutritional substance, such as a consumer, might be accomplished by means of a telecommunication system, such as a wireless telecommunication system accessed by means of a personal computing device, such as a tablet computer running a nutritional substance app.

Alternatively, marking module 230 could create a label which includes a machine readable version of the reference code. This could take the form of a barcode or QR Code which could be used to retrieve the creation information from database module 215. In this embodiment, the label reader 240 would read the barcode or QR Code on the label to obtain the reference code which would then be used to retrieve the creation information from database 215.

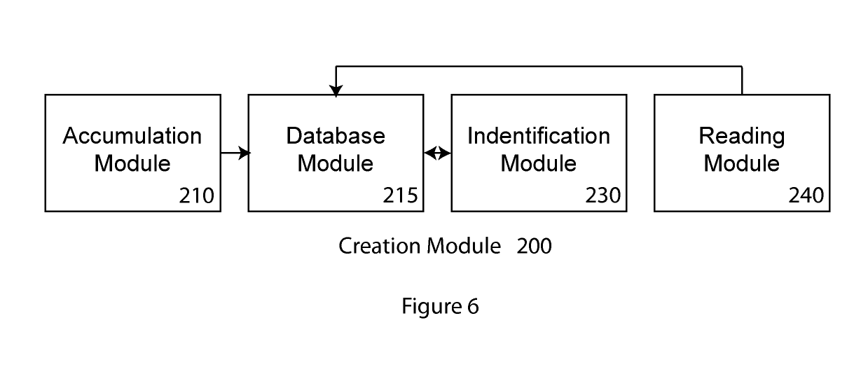

FIG. 6 shows an embodiment of the creation/origin module of the present invention. During the creation/origin of the nutritional substance, creation information regarding the origin and creation of the nutritional substance can be accumulated by accumulation module 210. This creation information is generally known by the creator of the nutritional substance. For example, the grower of sweet corn, knows the land and contacts the seed and traits producer to decide on the seeds that need to be planted in consequence knows the seeds that were planted, knows where the corn seed is planted, when the corn seed was planted, the soil conditions, the source of the water used to irrigate the corn, when the corn is to be harvested or the truffles gathered. Additionally, the grower knows what fertilizers, pesticides, and other substances were used to nourish and protect during growing of the corn.

Accumulation module 210 receives and stores all such creation information that is available from the grower. Accumulation module 210 can take the form of a computer running a data storage program, such as a database.

The creation information is stored in a database module 215 for eventual reference by the user of the nutritional substance. Accumulation module 210 accumulates the creation information from the nutritional substance's creation, which is stored in database module 215.

Database module 220 stores the information in a persistent format for later use by the users of the nutritional substance. In its preferred embodiment, encoding module 220 generates a reference code for the creation information stored in database module 215, which it provides to identification module 230. The identification module 230 identifies a unique identifier of the nutritional substance, which it provides back to the database module 215 for storage with the related creation information from accumulator module 210.

Identification module 230 creates unique identification information for a nutritional substance. In one embodiment, the identification module 230 analyzes the nutritional substance to obtain a unique identifier for the nutritional substance that can be used to reference creation information accumulated by accumulation module 210 and stored in database 215. For example, a particular variety of corn may have certain molecules in it that are unique to where and/or how it was grown. The identification module 230 would provide a link back to the creation information database module 215.

Reader module 240 would be used by the user of the nutritional substance to obtain the unique identifier necessary to retrieve the creation information from database 215. For example, the user of sweet corn received from a grower would use reader module 240 to obtain the unique identifier of corn it has received to retrieve the creation information from database module 215 for that corn. That information could be used in the processing of the corn, such as into canned sweet corn. Additionally, such creation information could be passed along to the consumer of the sweet corn with possibly the manufacturing information of the canned sweet COM.

In another embodiment of the present invention, a unique identifier could be added or formed within the nutritional substance. Such a unique identifier would not harm or degrade or affect the aesthetic value of the nutritional substance. It also would not be dangerous to the consumer of the product. In short, it should be transparent to the user of the nutritional substance. Such unique identifiers can take the form of specific molecules or chemicals not naturally found in the nutritional substance. It also could take the form of nanoparticles specifically designed to form a unique identifier.

Further, a unique identifier could be created in a product by adding a substance which interacts with some known feature of a specific nutritional substance to form a unique identifier. A chemical compound which interacts with a compound naturally occurring within a nutritional substance could create a unique identifier for that product. For example, if cattle are raised on different ranges which include food that has different amounts of a certain chemical which is incorporated into their tissue, a substance could be added during processing of the resulting meat which would interact differently with the substances obtained in the cow to produce differing unique identifiers. This would allow a particular unique identifier in a particular piece of beef to be traced back to its creation information.

Access to database module 215 by a user of the nutritional substance, such as a consumer, might be accomplished by means of a telecommunication system, such as a wireless telecommunication system accessed by means of a personal computing device, such as a tablet computer running a nutritional substance app.

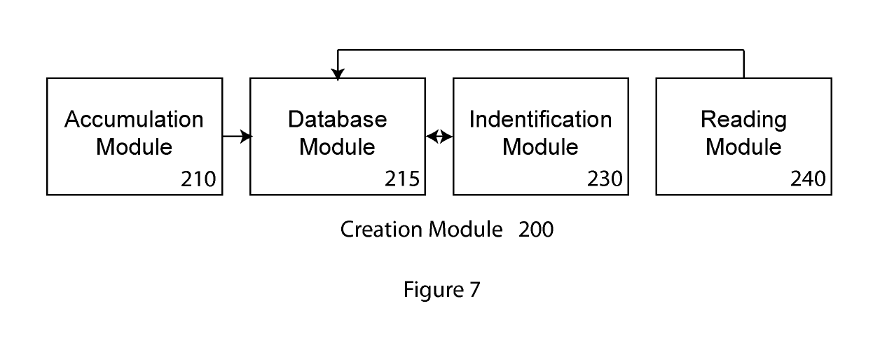

FIG. 7 shows an embodiment of the creation/origin module of the present invention. During the creation/origin of the nutritional substance, creation information regarding the origin and creation of the nutritional substance can be accumulated by accumulation module 210. This creation information is generally known by the creator of the nutritional substance. For example, the grower of sweet corn, knows the land and contacts the seed and traits producer to decide on the seeds that need to be planted in consequence knows the seeds that were planted, knows where the corn seed is planted, when the corn seed was planted, the soil conditions, the source of the water used to irrigate the corn, when the corn is to be harvested or the truffles gathered. Additionally, the grower knows what fertilizers, pesticides, and other substances were used to nourish and protect during growing of the corn.

Accumulation module 210 receives and stores all such creation information that is available from the grower. Accumulation module 210 can take the form of a computer running a data storage program, such as a database.

The creation information is stored in a database module 215 for eventual reference by the user of the nutritional substance. Accumulation module 210 accumulates the creation information from the nutritional substance's creation, which is stored in database module 215.

Database module 220 stores the information in a persistent format for later use by the users of the nutritional substance. In its preferred embodiment, encoding module 220 generates a reference code for the creation information stored in database module 215, which it provides to identification module 230. The identification module 230 identifies a unique identifier of the nutritional substance, which it provides back to the database module 215 for storage with the related creation information from accumulator module 210.

Identification module 230 creates unique identification information for a nutritional substance. In one embodiment, the identification module 230 analyzes the nutritional substance to obtain a unique genetic identifier for the nutritional substance that can be used to reference creation information accumulated by accumulation module 210 and stored in database 215. For example, a particular variety of corn may have certain genes in it that are unique to where and/or how it was grown. The identification module 230 would provide a link back to the creation information database module 215. For example, such a unique genetic identify could be expressed in the corn by a unique color of the husk or silk.

Reader module 240 would be used by the user of the nutritional substance to obtain the unique genetic identifier necessary to retrieve the creation information from database 215. For example, the user of sweet corn received from a grower would use reader module 240 to obtain the unique genetic identifier of corn it has received to retrieve the creation information from database module 215 for that corn. That information could be used in the processing of the corn, such as into canned sweet corn. Additionally, such creation information could be passed along to the consumer of the sweet corn with possibly the manufacturing information of the canned sweet corn.

In another embodiment of the present invention, a unique genetic identifier could be added or formed within the genetic code of the nutritional substance. Such a unique genetic identifier would not harm or degrade or affect the aesthetic value of the nutritional substance. It also would not be dangerous to the consumer of the product. In short, it should be transparent to the user of the nutritional substance. Such unique identifiers can take the form of specific gene sequence not naturally found in the nutritional substance. It also could take the form of gene sequence which expresses a specifically designed to form a unique identifier. Alternately, such an added or modified gene sequence could be completely dormant, but readable by reader module 240, by decoding part or all of the gene sequence of the nutritional substance.

Access to database module 215 by a user of the nutritional substance, such as a consumer, might be accomplished by means of a telecommunication system, such as a wireless telecommunication system accessed by means of a personal computing device, such as a tablet computer running a nutritional substance app.

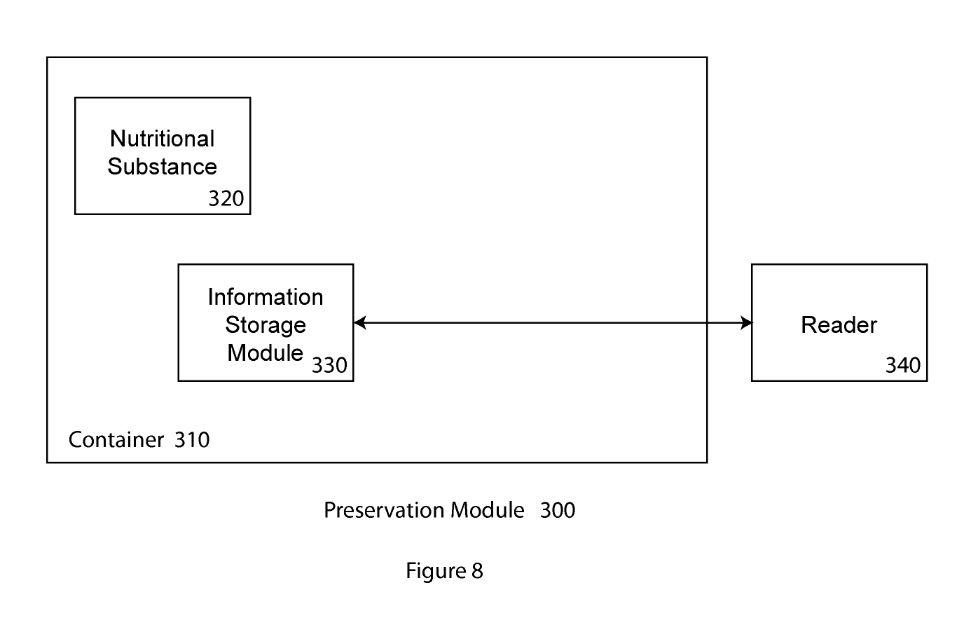

FIG. 8 shows an embodiment of the preservation module of the present invention. Preservation system 300 includes a container 310 which contains nutritional substance 320. Also included in container 310 is information storage module 330 which can be connected to an external reader 340. In this embodiment, information storage module 330 contains information regarding the nutritional substance 320. This information can include creation information from the creation of the nutritional substance 320. However, information in the information storage module 320 might include identification information, information regarding prior transformation of the nutritional substance 320, and other historic information. A shipper, or user, of container 310 can operatively connect to information storage module 330 using reader 340 to retrieve information stored therein.

In an alternate embodiment reader 340 can also write to information storage module 330. In this embodiment, information regarding the container and/or nutritional substance 320 can be modified or added to information storage module 330 by the user or shipper.

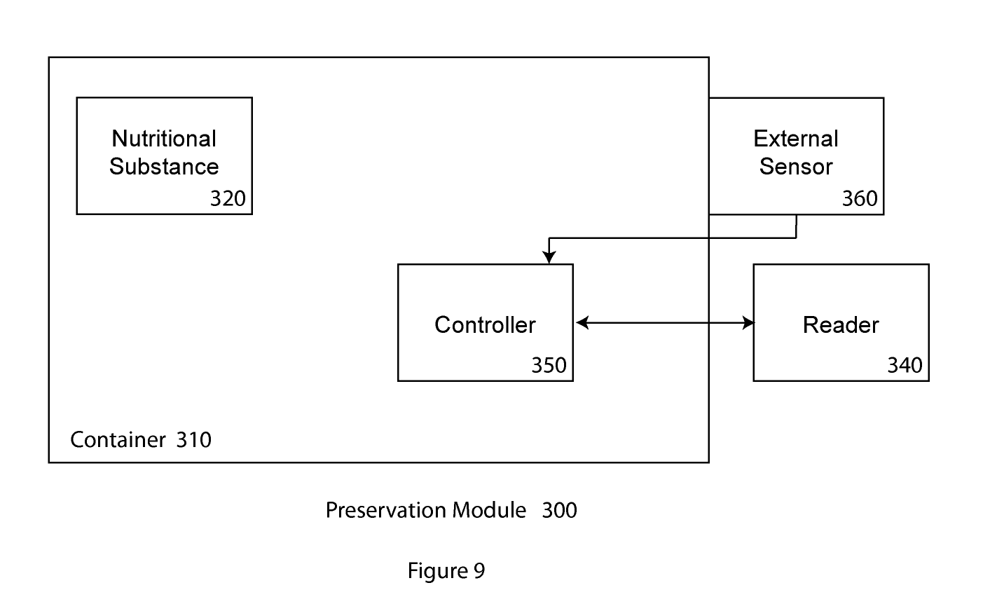

FIG. 9 shows another embodiment of preservation system 300 wherein container 310 contains nutritional substance 320 as well as controller 350. Controller 350 is connected to external sensor 360 located either inside, on the surface of, or external to container 310 such that external sensor 360 can obtain information regarding the environment external to container 310. Controller 350 and exterior sensor 360 can take the form of electronic components such as a micro-controller and an electronic sensor. However, the controller-sensor combination may also be chemical or organic materials which perform the same function, such as a liquid crystal sensor/display.

When the shipper or user of container 310 desires information from external sensor 360 the shipper or user can use reader 340 to query the controller 350 as to the state of external sensor 360. In the electronic component embodiment, reader 340 could be a user interface device such as a computer which can be electronically connected to controller 350. In the liquid crystal sensor/display, the ready could be a human looking at the display.

In one embodiment, reader 340 can be directly connected to external sensor 360 to obtain the information from external sensor 360 without need of a controller 350. In another embodiment, external sensor 360 provides information to controller 350 which is presented as a visual display to the shipper or user. Finally, external sensor 360 could provide information directly to the user or shipper by visual means such as a temperature sensitive liquid crystal thermometer.

In an additional embodiment, controller 350 can modify the operation of container 310 so as modify the preservation capabilities of container 310. For example, if the exterior environment of container 310 would adversely affect the nutritional substance 320, container 310 could adjust the internal environment of container 310 to better preserve the nutritional substance. If nutritional substance needs to be kept within a certain temperature range to preserve it's organoleptic and/or nutritional properties, and the external sensor 360 provide exterior temperature information to controller 350, controller 350 could modify container 310 so as to maintain nutritional substance 320 within the required temperature range.

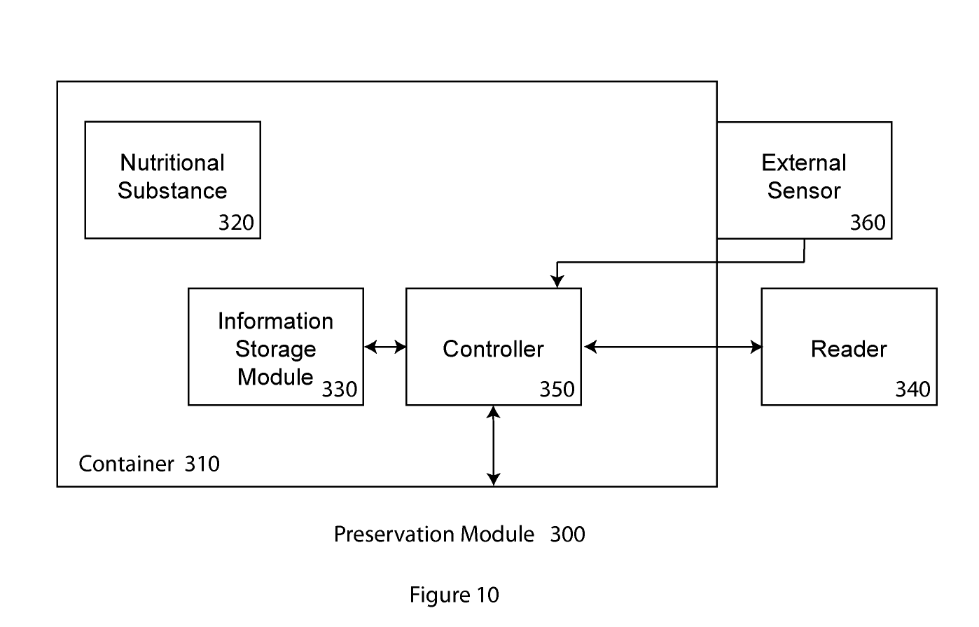

In FIG. 10 preservation system 300 includes container 310 which contains nutritional substance 320, controller 350, and information storage module 330. External sensor 360 is positioned such that it can provide information on the exterior environment to container 310. Information from the external sensor and information storage module can be retrieved by connecting reader 340 to container 310.

In this embodiment, information regarding the external environment sensed by external sensor 360 and provided to controller 350 can be stored in information storage module 330. This storage of external environment can be used to record a history the external environment container 310 has been subjected to. This would allow the shipper or user of container 310 to understand the external environment the container has been subjected to during the time it has preserved the nutritional substance. Such information can be used to determine if the nutritional substance is no longer safe for consumption or has been degraded such that the nutritional substance is no longer in an optimal state. Additionally, the user of the nutritional substance could modify its transformation, conditioning, or consumption according to any changes that may have occurred because of the external conditions of the container.

Additionally, in this embodiment, information storage module 340 could contain other information regarding the nutritional substance, including creation information, identification information, and/or prior transformation information.

In an additional embodiment, controller 350 can modify the operation of container 310 so as modify the preservation capabilities of container 310. For example, if the exterior environment of container 310 would adversely affect the nutritional substance 320, container 310 could adjust the internal environment of container 310 to better preserve the nutritional substance. Controller 350 can analyze the historic information from external sensor 360, stored in information storage module 330 to determine any long-term exterior conditions environmental If nutritional substance needs to be kept within a certain temperature range to preserve its organoleptic and/or nutritional properties, and the external sensor 360 provide exterior temperature information to controller 350, controller 350 could modify container 310 so as to maintain nutritional substance 320 within the required temperature range.

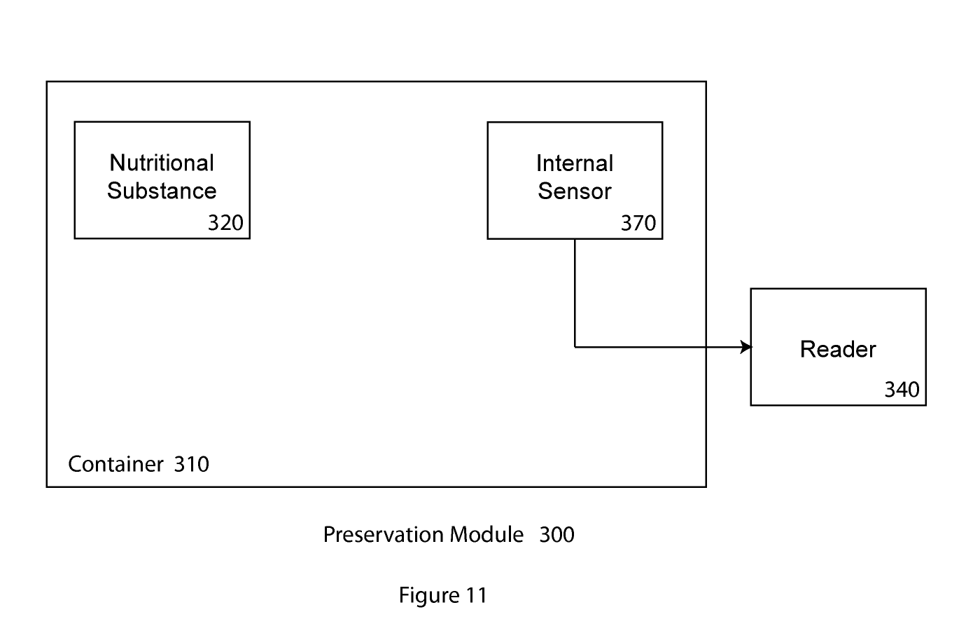

FIG. 11 shows embodiment of preservation system 300 wherein container 310 contains nutritional substance 320 as well as internal sensor 370 located either inside, or on the surface of, container 310, such that internal sensor 370 can obtain information regarding the environment internal to container 310. Internal sensor 370 can be connected to reader 340 to obtain the interior conditions of container 310. Internal sensor 360 and reader 340 can take the form of electronic components such as an electronic sensor and electronic display. However, the controller-sensor combination may also be chemical or organic materials which perform the same function, such as a liquid crystal sensor/display.

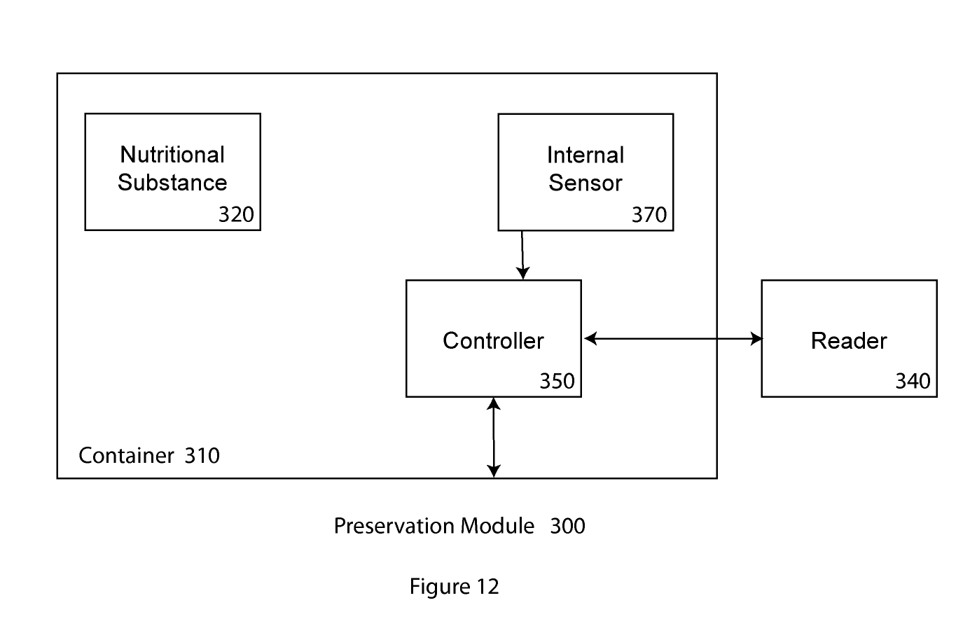

FIG. 12 shows embodiment of preservation system 300 wherein container 310 contains nutritional substance 320 as well as controller 350. Controller 350 is connected to internal sensor 370 located either inside, or on the surface of, container 310, such that internal sensor 370 can obtain information regarding the environment internal to container 310. Controller 350 and internal sensor 360 can take the form of electronic components such as a micro-controller and an electronic sensor. However, the controller-sensor combination may also be chemical or organic materials which perform the same function, such as a liquid crystal sensor/display.

When the shipper or user of container 310 desires information from internal sensor 370 the shipper or user can use reader 340 to query internal sensor 370. In the electronic component embodiment, reader 340 could be a user interface device such as a computer which can be electronically connected to internal sensor 370.

In an additional embodiment, controller 350 can modify the operation of container 310 so as modify the preservation capabilities of container 310. For example, if the interior environment of container 310 would adversely affect the nutritional substance 320, container 310 could adjust the internal environment of container 310 to better preserve the nutritional substance. If nutritional substance needs to be kept within a certain temperature range to preserve it's organoleptic and/or nutritional properties, and the internal sensor 370 provide internal temperature information to controller 350, controller 350 could modify container 310 so as to maintain nutritional substance 320 within the required temperature range.

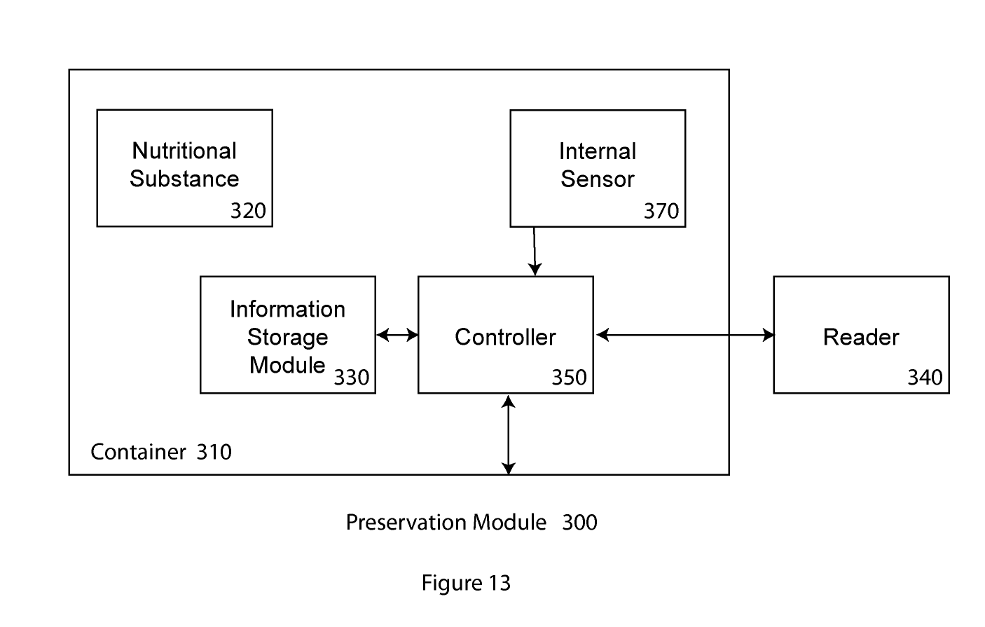

In FIG. 13, preservation system 300 includes container 310 which contains nutritional substance 320, controller 350, and information storage module 330. Internal sensor 370 is positioned such that it can provide information on the internal environment to container 310. Information from the internal sensor and information storage module can be retrieved by connecting reader 340 to container 310.

In this embodiment, information regarding the internal environment sensed by internal sensor 370 and provided to controller 350 can be stored in information storage module 330. This storage of internal environment can be used to record a history the internal environment container 310 has been subjected to. This would allow the shipper or user of container 310 to understand the internal environment the container has been subjected to during the time it has preserved the nutritional substance. Such information can be used to determine if the nutritional substance is no longer safe for consumption or has been degraded such that the nutritional substance is no longer in an optimal state. Additionally, the user of the nutritional substance could modify its transformation, conditioning, or consumption according to any changes that may have occurred because of the internal conditions of the container.

Additionally, in this embodiment, information storage module 340 could contain other information regarding the nutritional substance, including creation information, identification information, and/or prior transformation information.

In an additional embodiment, controller 350 can modify the operation of container 310 so as modify the preservation capabilities of container 310. For example, if the internal environment of container 310 would adversely affect the nutritional substance 320, container 310 could adjust the internal environment of container 310 to better preserve the nutritional substance. Controller 350 can analyze the historic information from internal sensor 370, stored in information storage module 330 to determine any long-term internal conditions environmental If nutritional substance needs to be kept within a certain temperature range to preserve its organoleptic and/or nutritional properties, and the internal sensor 370 provide internal temperature information to controller 350, controller 350 could modify container 310 so as to maintain nutritional substance 320 within the required temperature range.

Information in the information storage module 320 might include identification information, information regarding prior transformation of the nutritional substance 320, and other historic information. A shipper, or user, of container 310 can operatively connect to information storage module 330 using reader 340 to retrieve information stored therein. In an alternate embodiment reader 340 can also write to information storage module 330. In this embodiment, information regarding the container and/or nutritional substance 320 can be modified or added to information storage module 330 by the user or shipper.

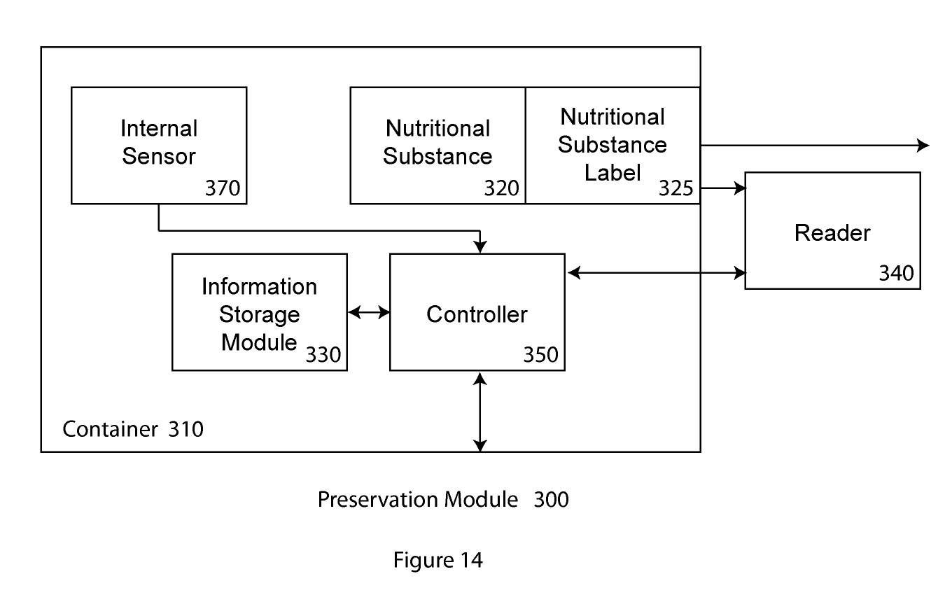

FIG. 14 shows an alternate embodiment of the present invention. Preservation system 300 includes container 310 which contains nutritional substance 320, nutritional substance label 325, controller 350, and information storage module 330. Internal sensor 370 is positioned such that it can provide information on the internal environment to container 310. Information from the internal sensor and information storage module can be retrieved by connecting reader 340 to container 310. Nutritional substance label 325 is attached to nutritional substance 320 so as to sense, measure, and/or indicate the current state of nutritional substance 320. Nutritional substance label 325 can be read by reader 340. Nutritional substance label 325 could be a material/chemical tag that, through a physical reaction with the surface of nutritional substance 320, provides information regarding the organoleptic state of the nutritional substance, including where nutritional substance 320 is in its life cycle. As an example, this label/tag could change color as a fruit, cheese or wine matures across time. It could also indicate if it detects traces of pesticides, hormones, allergens, harmful or dangerous bacteria, or any other substances.

In this embodiment, information regarding the internal environment sensed by internal sensor 370 and provided to controller 350 can be stored in information storage module 330. This storage of internal environment can be used to record a history the internal environment container 310 has been subjected to. This would allow the shipper or user of container 310 to understand the internal environment the container has been subjected to during the time it has preserved the nutritional substance. Such information can be used to determine if the nutritional substance is no longer safe for consumption or has been degraded such that the nutritional substance is no longer in an optimal state. Additionally, the user of the nutritional substance could modify its transformation, conditioning, or consumption according to any changes that may have occurred because of the internal conditions of the container.

Additionally, in this embodiment, information storage module 340 could contain other information regarding the nutritional substance, including creation information, identification information, and/or prior transformation information.

In an additional embodiment, controller 350 can modify the operation of container 310 so as modify the preservation capabilities of container 310. For example, if the internal environment of container 310 would adversely affect the nutritional substance 320, container 310 could adjust the internal environment of container 310 to better preserve the nutritional substance. Controller 350 can analyze the historic information from internal sensor 370, stored in information storage module 330 to determine any long-term internal conditions environmental If nutritional substance needs to be kept within a certain temperature range to preserve its organoleptic and/or nutritional properties, and the internal sensor 370 provide internal temperature information to controller 350, controller 350 could modify container 310 so as to maintain nutritional substance 320 within the required temperature range.

Information in the information storage module 320 might include identification information, information regarding prior transformation of the nutritional substance 320, and other historic information. A shipper, or user, of container 310 can operatively connect to information storage module 330 using reader 340 to retrieve information stored therein. Additionally, such a shipper, or user, of container 310 can obtain information from nutritional substance label 325, either through direct observation or through reader 340. In an alternate embodiment reader 340 can also write to information storage module 330. In this embodiment, information regarding the container and/or nutritional substance 320 can be modified or added to information storage module 330 by the user or shipper.

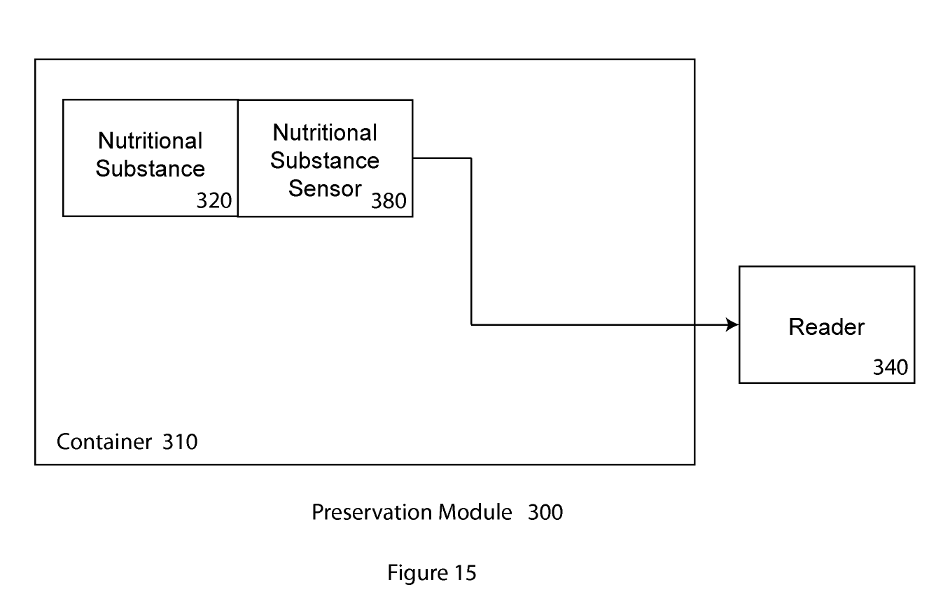

FIG. 15 shows embodiment of preservation system 300 wherein container 310 contains nutritional substance 320 as well as nutritional substance sensor 380 in contact with nutritional substance 320, such that nutritional substance sensor 380 can obtain information regarding the nutritional substance 320 in container 310. Nutritional substance sensor 380 can be connected to reader 340 to obtain the nutritional substance 320 condition. Nutritional substance sensor 380 and reader 340 can take the form of electronic components such as an electronic sensor and electronic display. However, the controller-sensor combination may also be chemical or organic materials which perform the same function, such as a liquid crystal sensor/display.

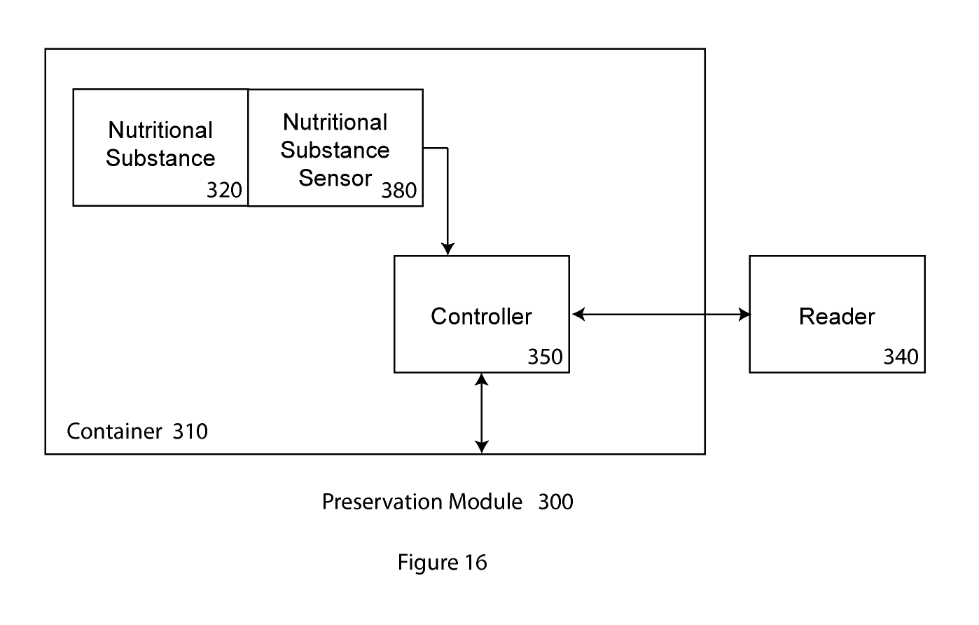

FIG. 16 shows embodiment of preservation system 300 wherein container 310 contains nutritional substance 320 as well as controller 350. Controller 350 is connected to nutritional substance sensor 380. Controller 350 and nutritional substance sensor 380 can take the form of electronic components such as a micro-controller and an electronic sensor. However, the controller-sensor combination may also be chemical or organic materials which perform the same function, such as a liquid crystal sensor/display.

When the shipper or user of container 310 desires information from nutritional substance sensor-380 the shipper or user can use reader 340 to query nutritional substance sensor 380. In the electronic component embodiment, reader 340 could be a user interface device such as a computer which can be electronically connected to nutritional substance sensor 380.

In an additional embodiment, controller 350 can modify the operation of container 310 so as modify the preservation capabilities of container 310. For example, if the interior environment of container 310 is adversely affecting the nutritional substance 320, container 310 could adjust the nutritional substance environment of container 310 to better preserve the nutritional substance. If nutritional substance needs to be kept within a certain temperature range to preserve its organoleptic and/or nutritional properties, and the nutritional substance sensor 380 provide nutritional substance temperature information to controller 350, controller 350 could modify container 310 so as to maintain nutritional substance 320 within the required temperature range.

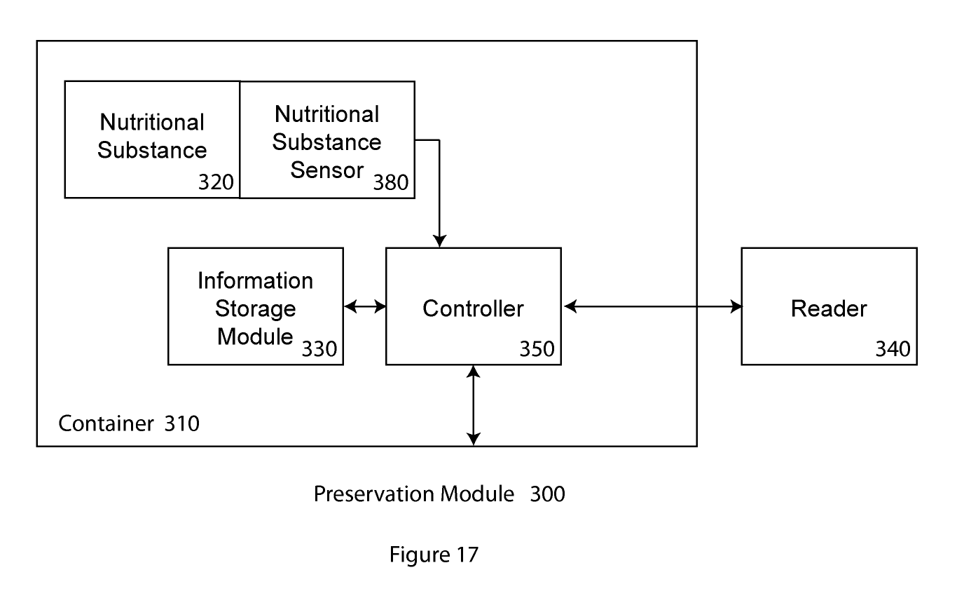

In FIG. 17, preservation system 300 includes container 310 which contains nutritional substance 320, controller 350, and information storage module 330. Nutritional substance sensor 380 is positioned such that it can provide information on the nutritional substance in container 310. Information from the nutritional substance sensor 380 and information storage module can be retrieved by connecting reader 340 to controller 350.

In this embodiment, information regarding the nutritional substance sensed by nutritional substance sensor 380, and provided to controller 350, can be stored in information storage module 330. This storage of nutritional substance environment can be used to record a history the nutritional substance. This would allow the shipper or user of container 310 to understand the nutritional substance during the time it has preserved the nutritional substance. Such information can be used to determine if the nutritional substance is no longer safe for consumption or has been degraded such that the nutritional substance is no longer in an optimal state. Additionally, the user of the nutritional substance could modify its transformation, conditioning, or consumption according to any changes that may have occurred because of the conditions of the container.

Additionally, in this embodiment, information storage module 330 could contain other information regarding the nutritional substance, including creation information, identification information, and/or prior transformation information.

In an additional embodiment, controller 350 can modify the operation of container 310 so as modify the preservation capabilities of container 310. For example, if the nutritional substance 320 is being adversely affected, controller 350 could adjust the container 310 to better preserve the nutritional substance. Controller 350 can analyze the historic information from nutritional substance sensor 380 stored in information storage module 330 to determine any long-term nutritional substance conditions that need to be changed, If nutritional substance needs to be kept within a certain temperature range to preserve its organoleptic and/or nutritional properties, and the nutritional substance sensor 380 provide nutritional substance temperature information to controller 350, controller 350 could modify container 310 so as to maintain nutritional substance 320 within the required temperature range.

Information in the information storage module 320 might include identification information, information regarding prior transformation of the nutritional substance 320, and other historic information. A shipper, or user, of container 310 can operatively connect to information storage module 330 using reader 340 to retrieve information stored therein. In an alternate embodiment reader 340 can also write to information storage module 330. In this embodiment, information regarding the container and/or nutritional substance 320 can be modified or added to information storage module 330 by the user or shipper.

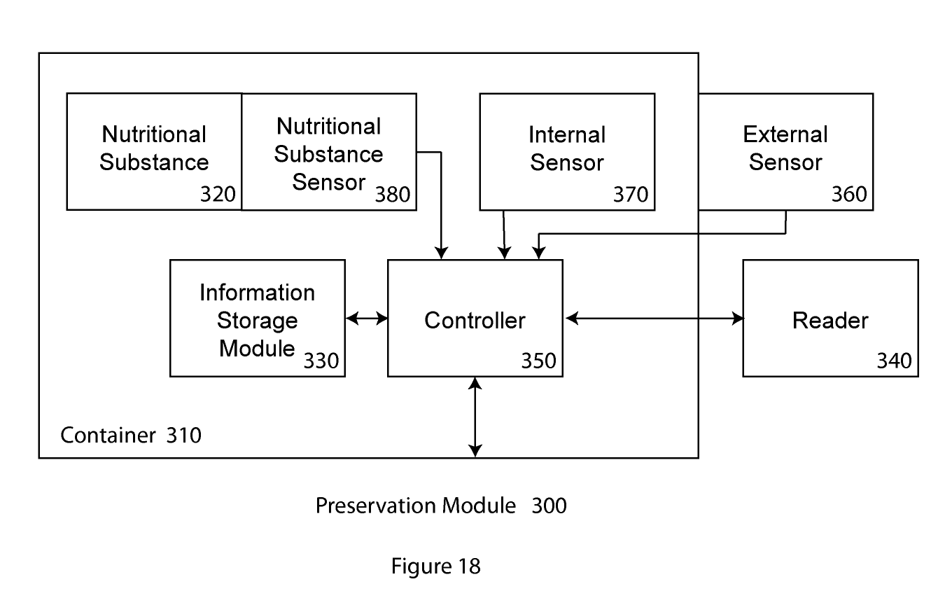

FIG. 18 shows the preferred embodiment of preservation module 300. Within container 310 is nutritional substance 320, nutritional substance sensor 380, internal sensor 370, information storage module 340, and controller 350. External sensor 360 is located outside or on the surface of container 310. In operation, controller 350 receives information from nutritional substance sensor 380, internal sensor 370, and external sensor 360. Additionally, controller 350 can store the information received from the three sensors in in information storage module 330. Controller 350 can retrieve such stored information and transmit it to reader 340. Reader 340 can also transmit instructions to controller 350.

Controller 350 is operably connected to container 310 so as to use the information obtained from the sensors and/or information stored in the information storage module to modify the operation of container 310 to affect the state of nutritional substance 320. Additionally, storage module 330 could contain information regarding nutritional substance 320 as to its identity, creation information and/or prior transformation information. This historic information could also be used in modifying the operation of container 310 in its preservation of nutritional substance 320.

As an example, nutritional substance 320 could be bananas being shipped to a distribution warehouse. Bananas are in container 310 which is capable of controlling its internal temperature, humidity, and the level of certain gasses within the container. Creation information as to the bananas is placed in information storage module 330 prior to shipment. During shipment, external sensor 360 measures the temperature and humidity outside container 310. This information is stored by controller 350 in information storage module 330. Controller 350 also receives information on the internal environment within container 310 from internal sensor 370 and stores this information in information storage module 330. This information includes the internal temperature, humidity, and certain gas levels within container 310. Finally, nutritional substance sensor 380, which is attached to the surface of the bananas, provides information as to the state of the bananas to controller 350. This information could include surface temperature, surface humidity, gasses being emitted, and surface chemicals. At any time during its shipment and delivery to the distribution warehouse, reader 340 can be used to retrieve both current information and historic information stored within information storage module 330.

During shipment, container 310 modifies its internal conditions according to instructions provided by controller 350. Controller 350 contains instructions as to how to preserve, and possibly ripen, the bananas using information stored in information storage module 330 about the creation of the bananas, as well as historical information received from the three sensors, as well as current information being received from the three sensors. In this manner, preservation module 300 can preserve and optimize organoleptic and nutritional attributes of the bananas while they are being shipped and stored.

It will be understood that subsets of the embodiment described herein can operate to achieve the goals stated herein. In one embodiment, nutritional substance sensor 380, internal sensor 370, external sensor 360, information storage module 330, controller 350, reader 340, and parts of container 310 are each electrical or electromechanical devices which perform each of the indicated functions. However, it is possible for some or all of these functions to be done using chemical and/or organic compounds. For example, a specifically designed plastic wrap for bananas can sense the exterior conditions of the package, the interior conditions of the package, and control gas flow through its surface so as to preserve and ripen the bananas.

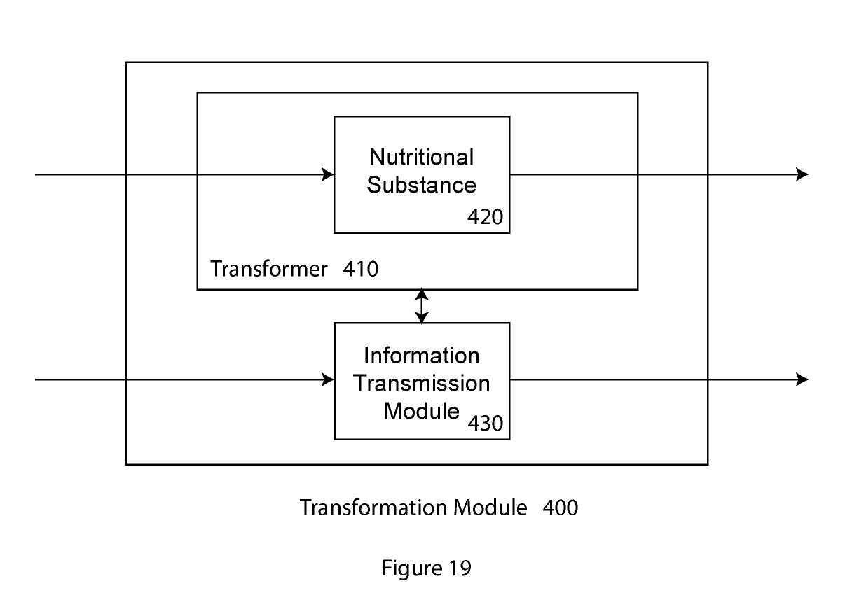

FIG. 19 shows an embodiment of transformation module 400 of the present invention. Transformation module 400 includes transformer 410, which acts upon nutritional substance 420, and information transmission module 430. When transformer 410 receives a nutritional substance 420, information transmission module 430 also receives, or retrieves information about the particular nutritional substance 420 that is to be transformed. This information can include creation information, packaging information, shipping information, and possibly previous transformation information. After nutritional substance 420 has been transformed by transformer 410, such information is passed along with the transformed nutritional substance 420 by the information transmission module 430.

For example, sweet corn that arrives for processing by transformer 410 has information associated with it, including the corn variety, where it was planted, when it was planted, when it was picked, the soil it was grown in, the water used for irrigation, and the fertilizers and pesticides that were used during its growth. There may also be information on organoleptic and nutritional attributes of the corn when it was preserved for shipment. This information may be stored in the labeling of the corn. However, it may be stored in a database maintained by the grower, shipper, or the nutritional substances industry. Such information could be accessed by means of telecommunications systems, such as wireless telecommunication systems.

Additionally, the corn may have information associated with it regarding how it was preserved for shipment from the farm to transformation system 400. Such information may include historical information on the environment exterior the container it was shipped in, internal conditions of the container and actual information about the corn during the shipment. Additionally, if the preservation system acted upon such information in preserving the corn, information about the preservation measures may also be available. Such information may be stored in the preservation system. However, it may be stored in a database maintained by the grower, shipper, or the nutritional substances industry. Such information could be accessed by means of telecommunications systems, such as wireless telecommunication systems.

In the example where the nutritional substance 420 is corn, transformer 410 removes the husk and the silk from the corn. It then separates the kernels from the cob. Washes the kernels, washes them, and cooks them. Finally, transformer 410 packages the cooked corn in a can and labels the can. The label on the can, can contain all the information provided to information transmission module 430. Preferably, this information is referenced by a code or tag which identifies the information regarding the corn in the can that is being transmitted by information transmission module 430.

In practice, information transmission module 430 would receive the information regarding the nutritional substance 420 from a database that is being used to track the corn during its journey from the farm to the consumer. When transformer 410 transforms nutritional substance 420, information transmission module 430 retrieves the appropriate information from the database and transmits it to another database. Alternatively, such information would be transmitted back to the original database, noting that the transformation had occurred. Preferably, the information regarding the corm would simply be appended with the information that the transformation had occurred.

If the nutritional substance 420 can no longer be tracked by the reference information that accompanied the nutritional substance from the creator, then new reference information may be created. For example, if the corn is combined with lima beans in the transformer 410, to make succotash, then the information for each may be combined and assigned a new reference number. Preferably, a new entry is created in the database, with references to the information related to the corn and the information related to the lima beans.

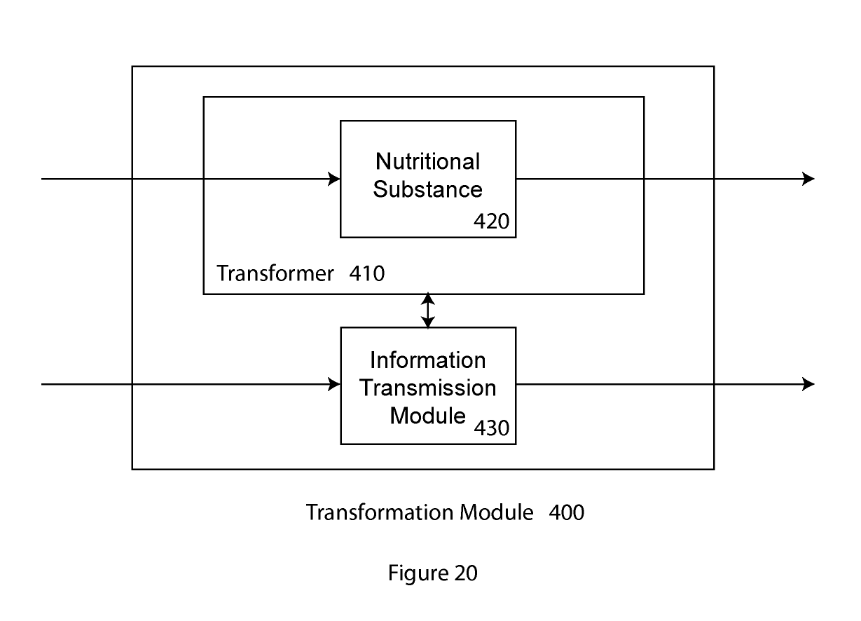

FIG. 20 shows an embodiment of transformation module 400 of the present invention. Transformation module 400 includes transformer 410, which acts upon nutritional substance 420, and information transmission module 430. When transformer 410 receives a nutritional substance 420, information transmission module 430 also receives, or retrieves information about the particular nutritional substance 420 that is to be transformed. This information can include creation information, packaging information, shipping information, and possibly previous transformation information. After nutritional substance 420 has been transformed by transformer 410, such information is passed along with the transformed nutritional substance 420 by the information transmission module 430, along with specific information relating to the transformation done by transformer 410.

For example, sweet corn that arrives for processing by transformer 410 has information associated with it, including the corn variety, where it was planted, when it was planted, when it was picked, the soil it was grown in, the water used for irrigation, and the fertilizers and pesticides that were used during its growth. There may also be information on organoleptic and nutritional attributes of the corn when it was preserved for shipment. This information may be stored in the labeling of the corn. However, it may be stored in a database maintained by the grower, shipper, or the nutritional substances industry. Such information could be accessed by means of telecommunications systems, such as wireless telecommunication systems.

Additionally, the corn may have information associated with it regarding how it was preserved for shipment from the farm to transformation system 400. Such information may include historical information on the environment exterior the container it was shipped in, internal conditions of the container and actual information about the corn during the shipment. Additionally, if the preservation system acted upon such information in preserving the corn, information about the preservation measures may also be available. Such information may be stored in the preservation system. However, it may be stored in a database maintained by the grower, shipper, or the nutritional substances industry. Such information could be accessed by means of telecommunications systems, such as wireless telecommunication systems.

In the example where the nutritional substance 420 is corn, transformer 410 removes the husk and the silk from the corn. It then separates the kernels from the cob. Washes the kernels, washes them, and cooks them. Finally, transformer 410 packages the cooked corn in a can and labels the can.

During this transformation of the nutritional substance 420 by transformer 410, information about the transformation can be captured by transformer 410 and sent to information transmission module 430. This information can include how the transformation was accomplished; including information on the transformer used, the recipe implemented by transformer 410, and the settings for transformer 410 when the transformation occurred. Additionally, any information created during the transformation by transformer 410 can be sent to the information transmission module 430. This could include measured information, such as the actual cooking temperature, length of time of each of the steps. Additionally, this information could include measured organoleptic and nutritional information.

The label on the can, can contain all the information provided to information transmission module 430. Preferably, this information is referenced by a code or tag which identifies the information regarding the corn in the can that is being transmitted by information transmission module 430.

In practice, information transmission module 430 would receive the information regarding the nutritional substance 420 from a database that is being used to track the corn during its journey from the farm to the consumer. When transformer 410 transforms nutritional substance 420, information transmission module 430 retrieves the appropriate information from the database, appends it with the information from transformer 410 regarding the transformation, and transmits it to another database. Alternatively, such information would be transmitted back to the original database, including the transformation information. Preferably, the information regarding the corm would simply be appended with the information from transformer 410 about the transformation.

If the nutritional substance 420 can no longer be tracked by the reference information that accompanied the nutritional substance from the creator, then new reference information may be created. For example, if the corn is combined with lima beans in the transformer 410, to make succotash, then the information for each may be combined and assigned a new reference number. Preferably, a new entry is created in the database, with references to the information related to the corn and the information related to the lima beans.

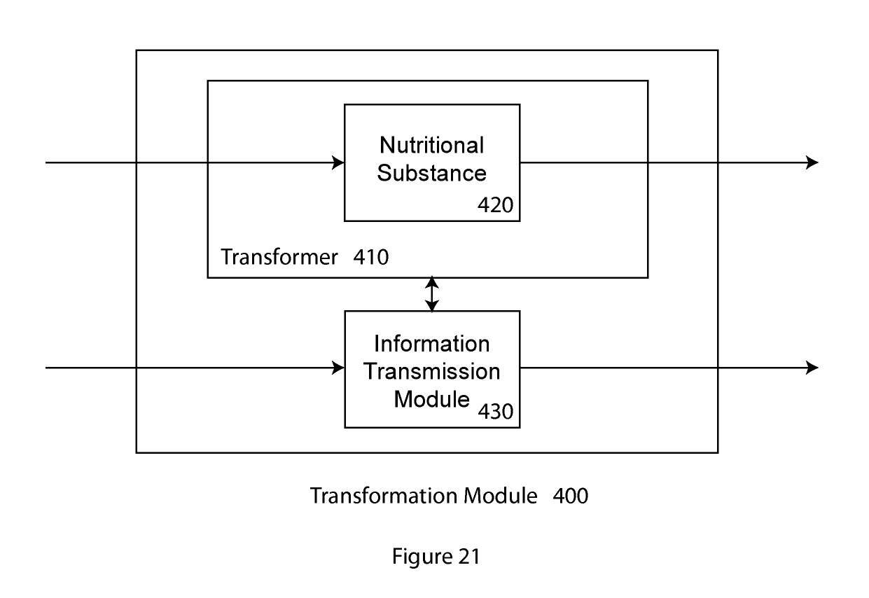

FIG. 21 shows an embodiment of transformation module 400 of the present invention. Transformation module 400 includes transformer 410, which acts upon nutritional substance 420, and information transmission module 430. When transformer 410 receives a nutritional substance 420, information transmission module 430 also receives, or retrieves information about the particular nutritional substance 420 that is to be transformed. This information can include creation information, packaging information, shipping information, and possibly previous transformation information. This information is used by transformer 410 to dynamically modify the transformation. After nutritional substance 420 has been transformed by transformer 410, such information is passed along with the transformed nutritional substance 420 by the information transmission module 430, along with specific information relating to the transformation done by transformer 410.

For example, sweet corn that arrives for processing by transformer 410 has information associated with it, including the corn variety, where it was planted, when it was planted, when it was picked, the soil it was grown in, the water used for irrigation, and the fertilizers and pesticides that were used during its growth. There may also be information on organoleptic and nutritional attributes of the corn when it was preserved for shipment. This information may be stored in the labeling of the corn. However, it may be stored in a database maintained by the grower, shipper, or the nutritional substances industry. Such information could be accessed by means of telecommunications systems, such as wireless telecommunication systems.

Additionally, the corn may have information associated with it regarding how it was preserved for shipment from the farm to transformation system 400. Such information may include historical information on the environment exterior the container it was shipped in, internal conditions of the container and actual information about the corn during the shipment. Additionally, if the preservation system acted upon such information in preserving the corn, information about the preservation measures may also be available. Such information may be stored in the preservation system. However, it may be stored in a database maintained by the grower, shipper, or the nutritional substances industry. Such information could be accessed by means of telecommunications systems, such as wireless telecommunication systems.

Any, or all, of this information can be provided to transformer 410. Transformer 410 can dynamically modify its transformation of nutritional substance 420 in response to such information to preserver or improve the organoleptic and/or nutritional properties of nutritional substance 420.

In the example where the nutritional substance 420 is corn, transformer 410 removes the husk and the silk from the corn. It then separates the kernels from the cob. Washes the kernels, washes them, and cooks them. In response to the information provided by information transmission module 430, transformer can adjust the cooking temperature and time. For example, if transformer 410 receives information that indicates that the corn is low in certain desirable nutrients, if might lower the cooking temperature and time to preserve those nutrients. However, if transformer 410 receives information that indicates that the corn is high tough starches, if might raise the cooking temperature and time to soften the corn. Finally, transformer 410 packages the cooked corn in a can and labels the can.

Additionally, transformer 410 can modify its transformation of the nutritional substance in response to measured attributes of the particular nutritional substance 420 being transformed. For example, transformer 410 can measure the color of the corn to be processed, and in response make adjustment to the transformation to preserver or enhance the color the transformed corn.

During this transformation of the nutritional substance 420 by transformer 410, information about the transformation can be captured by transformer 410 and sent to information transmission module 430. This information can include how the transformation was accomplished; including information on any dynamic transformation modifications, the recipe implemented by transformer 410, and the settings for transformer 410 when the transformation occurred. Additionally, any information created during the transformation by transformer 410 can be sent to the information transmission module 430. This could include measured information, such as the actual cooking temperature, length of time of each of the steps. Additionally, this information could include measured organoleptic and nutritional information.

The label on the packaging can contain all the information provided to information transmission module 430. Preferably, this information is referenced by a code or tag which identifies the information regarding the corn in the can that is being transmitted by information transmission module 430.

In practice, information transmission module 430 would receive the information regarding the nutritional substance 420 from a database that is being used to track the corn during its journey from the farm to the consumer. When transformer 410 transforms nutritional substance 420, information transmission module 430 retrieves the appropriate information from the database, appends it with the information from transformer 410 regarding the transformation, and transmits it to another database. Alternatively, such information would be transmitted back to the original database, including the transformation information. Preferably, the information regarding the corm would simply be appended with the information from transformer 410 about the transformation.

If the nutritional substance 420 can no longer be tracked by the reference information that accompanied the nutritional substance from the creator, then new reference information may be created. For example, if the corn is combined with lima beans in the transformer 410, to make succotash, then the information for each may be combined and assigned a new reference number. Preferably, a new entry is created in the database, with references to the information related to the corn and the information related to the lima beans.

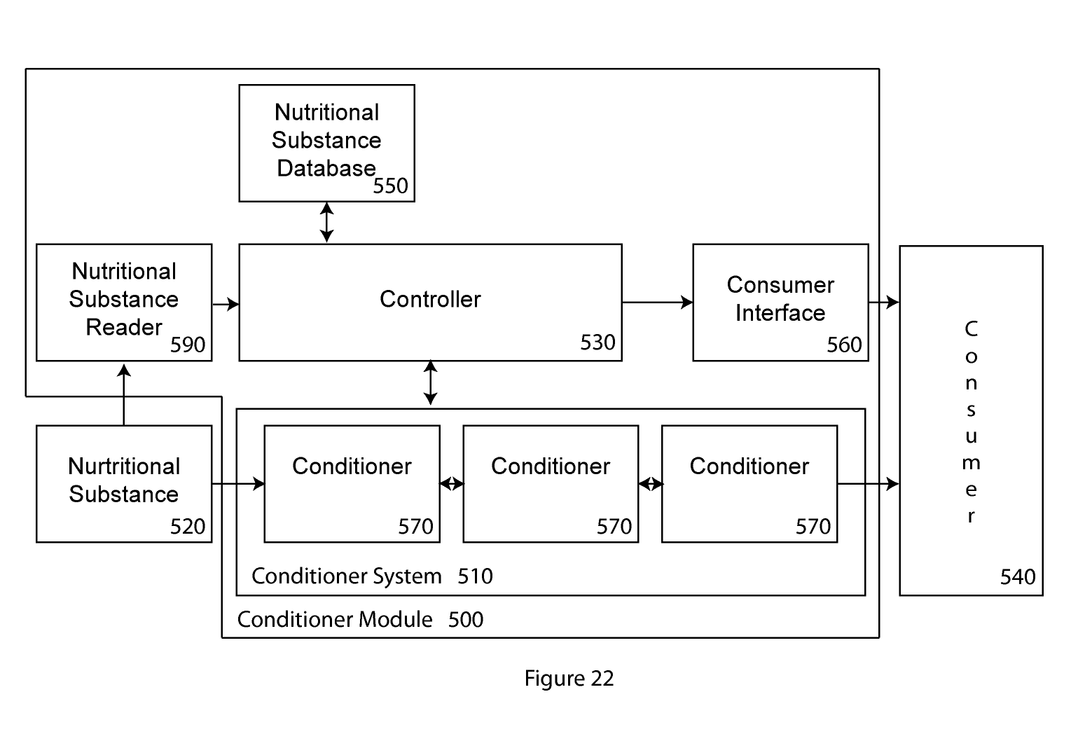

FIG. 22 shows an embodiment of conditioning module 500 of the present invention. Conditioner system 510 receives nutritional substance 520 for conditioning before it is delivered to consumer 540. Controller 530 is operably connected to conditioner system 510. In fact, controller 530 may be integrated within conditioner system 510, although in FIG. 2, it is shown as a separate device. When conditioner system 510 receives nutritional substance 520 for conditioning, nutritional substance reader 590 either receives or references information regarding nutritional substance 520, and provides it to controller 530. In the case where nutritional substance 520 contains a label which includes information about nutritional substance 520, nutritional substance reader 590 reads this information, provides it to controller 530 and makes it available to consumer 540 by means of consumer interface 560.

For example, if nutritional substance 520 is a ready-to-eat frozen dinner which needs to be heated by conditioner system 510, nutritional substance reader 590 would read a label on nutritional substance 520, provide it to controller 530. This information could include creation information as to the creation of the various components which constitute the ready-to-eat dinner. This information could include information about where and how the corn in the ready-to-eat dinner was grown, including the corn seed used, where it was planted, how it was planted, how it was irrigated, when it was picked, and information on fertilizers and pesticides used during its growth. Additionally, this information could include the cattle lineage, health, immunization, dietary supplements that were fed to the cattle that was slaughtered to obtain the beef in the ready-to-eat dinner.

The information on nutritional substance 520 could also include information on how the components were preserved for shipment from the farm or slaughterhouse on their path to the nutritional substance transformer who prepared the ready-to-eat dinner. Additional information could include how the nutritional substance transformer transformed the components into the ready-to-eat dinner, such as recipe used, additives to the dinner, and actual measured conditions during the transformation into the ready-to-eat dinner.

While such information could be stored on a label located on the packaging for nutritional substance 520 so as to be read by nutritional substance reader 590, provided to controller 530, and provided to consumer interface 560 for display to consumer 540, preferably, the label on the nutritional substance package includes reference information which is read by nutritional substance reader 590 and provided to controller 530 that allows controller 530 to retrieve the information about nutritional substance 520 from nutritional substance database 550.

Nutritional substance database 550 could be a database maintained by the transformer of nutritional substance 520 for access by consumers of such nutritional substance 520. However, preferably, nutritional substance database 550 is a database maintained by the nutritional substance industry for all such information regarding nutritional substances grown, raised, preserved, transformed, conditioned and consumed by consumer 540.

In an alternate embodiment of the present invention, controller 530, in addition to providing information regarding nutritional substance 520 to consumer 540, controller 530 also receives information from conditioner system 510 on how nutritional substance 520 was conditioned. Additionally, conditioner system 510 may also measure or sense information about nutritional substance 520 during its conditioning by conditioner system 510, and provide such information to controller 530, so that such information could also be provided to consumer 540, via consumer interface 560.

In a preferred embodiment of the present invention, controller 530 organizes and correlates the information it receives regarding nutritional substance 520 from the various sources of such information, including nutritional substance database 550 and conditioner system 510, and presents such information through consumer interface 560 to consumer 540 in a manner useful to consumer 540. For example, such information may be provided in a manner that assists consumer 540 in understanding how nutritional substance 520 meets consumer's 540 nutritional needs. It could organize information regarding nutritional substance 520 to track consumer's 540 weight loss program. Controller 530 could have access to, or maintain, information regarding consumer 540, so as to track and assist consumer 540 in meeting their specific nutritional needs.

In another embodiment of the present invention conditioner system 510 could be a plurality of conditioner devices which can be selectively operated by controller 530 to prepare nutritional substance 520. Conditioner system 510 can be either a single conditioning device, such as a microwave oven, conventional oven, toaster, blender, steamer, stovetop, or human cook. Conditioner system 510 may be a plurality of conditioners 570. In the case where a plurality of conditioners 570 comprise conditioner system 510, nutritional system 520 may be manually or automatically transferred between conditioners 570 for eventual transfer to consumer 540.

Nutritional substance reader 590 may be an automatic reader such as a barcode reader or RFID sensor which receives information from nutritional substance 520 or a reference code from nutritional substance 520 and provides this information to controller 530. Nutritional substance reader 590 might also be a manual entry system where the reference code for nutritional substance 520 is manually entered into nutritional substance reader 590 for controller 530.

Nutritional substance database 550 could be a flat database, relational database or, preferably, a multi-dimensional database. Nutritional substance database 550 could be local but, preferably, it would be located remotely, such as on the internet, and accessed via a telecommunication system, such as a wireless telecommunication system. Controller 530 can be implemented using a computing device, such as a micro-controller, micro-processor, personal computer, or tablet computer. Controller 530 could be integrated to include nutritional substance reader 590, consumer interface 560, and/or nutritional substance database 550. Additionally, controller 530 may be integrated in conditioner system 510, including integration into conditioner 570.

Consumer interface 560 can be implemented as a display device mounted on controller 530, conditioner system 510, or conditioner 570. However, consumer interface 560 is preferably a tablet computer, personal computer, personal assistant, or smart phone, running appropriate software, such as an app.

While conditioner module 500 can be located in the consumer's home, conditioner module 500 may be located at a restaurant or other food service establishment for use in preparing nutritional substances 520 for consumers who patronize such an establishment. Additionally, conditioner module 500 could be located at a nutritional substance seller such as a grocery store or health food store for preparation of nutritional substances 520 purchased by consumers at such an establishment. It could be foreseen that conditioner modules 500 could become standalone businesses where consumers select nutritional substances for preparation at the establishment or removal from the establishment for consumption elsewhere.

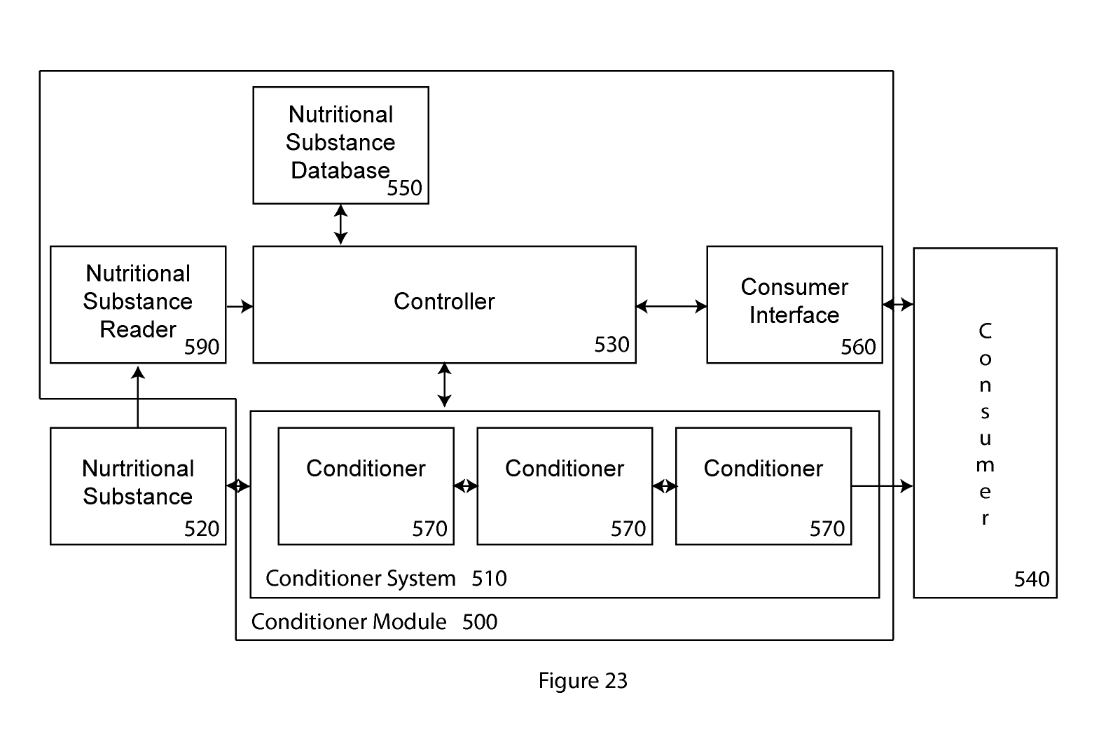

FIG. 23 shows an embodiment of conditioning module 500 of the present invention. Conditioner system 510 receives nutritional substance 520 for conditioning before it is delivered to consumer 540. Controller 530 is operably connected to conditioner system 510. In fact, controller 530 may be integrated within conditioner system 510, although in FIG. 2, it is shown as a separate device. When conditioner system 510 receives nutritional substance 520 for conditioning, nutritional substance reader 590 either receives or references information regarding nutritional substance 520, and provides it to controller 530. In the case where nutritional substance 520 contains a label which includes information about nutritional substance 520, nutritional substance reader 590 reads this information, provides it to controller 530 and makes it available to consumer 540 by means of consumer interface 560.

In an embodiment of the present invention, conditioner system 510 comprises conditioner 570. Conditioner 570 is a conditioning apparatus which can perform a number of operations on nutritional substance 520, separately and/or at the same time. For example, conditioner 570 could be a combination microwave oven, convection oven, grill, and conventional oven. Controller 530 could operate conditioner 570 to execute a sequence of conditioning cycles on nutritional substance 520 to complete its conditioning.

For example, if nutritional substance 520 is a whole frozen turkey to be prepared for dinner, consumer 540 would place the turkey in conditioner 570, the combination cooking unit suggested above. Controller 530 would receive and/or create a protocol of conditioning cycles. Such a protocol could be read by nutritional substance reader 590 from a label on nutritional substance 520. Alternately, a protocol of conditioning cycles could be obtained from nutritional substance database 550 through reference information obtained by nutritional substance reader 590 by nutritional substance 520. For example, a label on the turkey, could be read by nutritional substance reader 590, providing reference information for the turkey which controller 530 uses to obtain a conditioning protocol for the turkey from nutritional substance database 550.

An example of such a conditioning protocol for a frozen turkey could be to operate conditioner 570, the combination cooking unit in the following fashion. First, controller 530 instructs conditioner 570 to use the microwave function of the combination cooking unit to defrost the turkey according to the protocol and possibly according to conditioner information provided by conditioner 570, such as the weight of the turkey and information regarding the defrosting process as measured by conditioner 570. Following defrosting of the turkey, controller 530 next instructs the combination cooking unit to operate as a convection oven to cook the turkey for a sufficient length of time so as to ensure that the turkey reaches the proper internal temperature to meet safety requirements, and to maximize organoleptic and/or nutritional properties. Following the convection oven cooking of the turkey, controller 530 could instruct the combination cooking unit to grill the turkey for a sufficient period of time to create a desirable golden and crispy skin. Finally, controller 530 could instruct the combination cooking unit to use all three cooking functions at the same time to prepare the turkey for optimal consumption.

Alternately, conditioner system 510 could be composed of a plurality of conditioners 570. While an automated system for moving a nutritional substance between such conditioners would be optimal, conditioner system 510 could be operated manually by consumer 540 from instructions provided to consumer interface 560. In this embodiment, controller 530 could provide consumer 540 with instructions as to where to move the turkey after each step in the conditioning protocol. In this example, controller 530 instructs consumer 540 through consumer interface 560 to first place the frozen turkey in conditioner 570, a microwave oven. Controller 530 instructs the microwave oven to defrost the turkey based on information possibly provided by nutritional substance reader 590, nutritional substance database 550 and/or conditioner 570. Upon completion of defrosting by the microwave oven, controller 530 could instruct consumer 540 through interface 560 to move the defrosted turkey from the microwave oven to another conditioner 570, a convection oven. Controller 530 would operate the convection oven to cook the turkey for a sufficient length of time so as to ensure that the turkey reaches the proper internal temperature to meet safety requirements, and to maximize organoleptic and/or nutritional properties. Finally, following the cooking cycle in the convection oven, controller 530 could instruct consumer 540 through consumer interface 560 to move the turkey from the convection oven to another conditioner 570, a grill. Controller 530 would operate the grill so as to grill the turkey for a sufficient period of time to create a desirable golden and crispy skin.

In the case where conditioner system 510 is a plurality of conditioners 570, it would also be possible for controller 530 to manage conditioners 570 within conditioner system 510 so as to produce a complete meal. For example, controller 530 could select conditioning protocols which would maximize the use of each conditioner 570. For example, in a meal comprising a turkey, home baked bread, and acorn squash, controller 530 could stage and operate the microwave oven, convection oven, and grill to minimize preparation time for the meal by determining which item should be cooked in which conditioner 570, in which order, to maximize usage of each conditioner 570 in conditioning system 510. In this example, while the turkey is being defrosted in the microwave oven, controller 530 could instruct consumer 540 through interface 560 to place the bread dough in the convection oven and the acorn squash on the grill. Following the defrosting of the turkey, when the turkey is moved to the convection oven, which finished baking the bread, the bread could be moved to the grill for browning, and the acorn squash could be moved to microwave oven to keep warm., until the entire meal is ready.

For example, if nutritional substance 520 is a ready-to-eat frozen dinner which needs to be heated by conditioner system 510, nutritional substance reader 590 would read a label on nutritional substance 520, provide it to controller 530. This information could include creation information as to the creation of the various components which constitute the ready-to-eat dinner. This information could include information about where and how the corn in the ready-to-eat dinner was grown, including the corn seed used, where it was planted, how it was planted, how it was irrigated, when it was picked, and information on fertilizers and pesticides used during its growth. Additionally, this information could include the cattle lineage, health, immunization, dietary supplements that were fed to the cattle that was slaughtered to obtain the beef in the ready-to-eat dinner.

The information on nutritional substance 520 could also include information on how the components were preserved for shipment from the farm or slaughterhouse on their path to the nutritional substance transformer who prepared the ready-to-eat dinner. Additional information could include how the nutritional substance transformer transformed the components into the ready-to-eat dinner, such as recipe used, additives to the dinner, and actual measured conditions during the transformation into the ready-to-eat dinner.

While such information could be stored on a label located on the packaging for nutritional substance 520 so as to be read by nutritional substance reader 590, provided to controller 530, and provided to consumer interface 560 for display to consumer 540, preferably, the label on the nutritional substance package includes reference information which is read by nutritional substance reader 590 and provided to controller 530 that allows controller 530 to retrieve the information about nutritional substance 520 from nutritional substance database 550.

Nutritional substance database 550 could be a database maintained by the transformer of nutritional substance 520 for access by consumers of such nutritional substance 520. However, preferably, nutritional substance database 550 is a database maintained by the nutritional substance industry for all such information regarding nutritional substances grown, raised, preserved, transformed, conditioned and consumed by consumer 540.

In an alternate embodiment of the present invention, controller 530, in addition to providing information regarding nutritional substance 520 to consumer 540, controller 530 also receives information from conditioner system 510 on how nutritional substance 520 was conditioned. Additionally, conditioner system 510 may also measure or sense information about nutritional substance 520 during its conditioning by conditioner system 510, and provide such information to controller 530, so that such information could also be provided to consumer 540, via consumer interface 560.

In a preferred embodiment of the present invention, controller 530 organizes and correlates the information it receives regarding nutritional substance 520 from the various sources of such information, including nutritional substance database 550 and conditioner system 510, and presents such information through consumer interface 560 to consumer 540 in a manner useful to consumer 540. For example, such information may be provided in a manner that assists consumer 540 in understanding how nutritional substance 520 meets consumer's 540 nutritional needs. It could organize information regarding nutritional substance 520 to track consumer's 540 weight loss program. Controller 530 could have access to, or maintain, information regarding consumer 540, so as to track and assist consumer 540 in meeting their specific nutritional needs.

In another embodiment of the present invention conditioner system 510 could be a plurality of conditioner devices which can be selectively operated by controller 530 to prepare nutritional substance 520. Conditioner system 510 can be either a single conditioning device, such as a microwave oven, conventional oven, toaster, blender, steamer, stovetop, or human cook. Conditioner system 510 may be a plurality of conditioners 570. In the case where a plurality of conditioners 570 comprise conditioner system 510, nutritional system 520 may be manually or automatically transferred between conditioners 570 for eventual transfer to consumer 540.

Nutritional substance reader 590 may be an automatic reader such as a barcode reader or RFID sensor which receives information from nutritional substance 520 or a reference code from nutritional substance 520 and provides this information to controller 530. Nutritional substance reader 590 might also be a manual entry system where the reference code for nutritional substance 520 is manually entered into nutritional substance reader 590 for controller 530.

Nutritional substance database 550 could be a flat database, relational database or, preferably, a multi-dimensional database. Nutritional substance database 550 could be local but, preferably, it would be located remotely, such as on the internet, and accessed via a telecommunication system, such as a wireless telecommunication system. Controller 530 can be implemented using a computing device, such as a micro-controller, micro-processor, personal computer, or tablet computer. Controller 530 could be integrated to include nutritional substance reader 590, consumer interface 560, and/or nutritional substance database 550. Additionally, controller 530 may be integrated in conditioner system 510, including integration into conditioner 570.

Consumer interface 560 can be implemented as a display device mounted on controller 530, conditioner system 510, or conditioner 570. However, consumer interface 560 is preferably a tablet computer, personal computer, personal assistant, or smart phone, running appropriate software, such as an app.

While conditioner module 500 can be located in the consumer's home, conditioner module 500 may be located at a restaurant or other food service establishment for use in preparing nutritional substances 520 for consumers who patronize such an establishment. Additionally, conditioner module 500 could be located at a nutritional substance seller such as a grocery store or health food store for preparation of nutritional substances 520 purchased by consumers at such an establishment. It could be foreseen that conditioner modules 500 could become standalone businesses where consumers select nutritional substances for preparation at the establishment or removal from the establishment for consumption elsewhere.

Additionally, controller 530 uses nutritional substance information provided by nutritional substance database 550 from reference information from nutritional substance reader 590 to dynamically modify the operation of conditioner system 510 to maintain organoleptic and nutritional properties of nutritional substance 520. For example, if the nutritional substance 520 is a ready-to-eat dinner, controller 530 could modify the instructions to conditioner system 530 in response to information regarding the corn used in the ready-to-eat dinner such that a temperature and cooking duration can be modified to affect the organoleptic, nutritional, taste, and/or appearance of the corn.

In an embodiment of the present invention, the label on nutritional substance 520 could contain the conditioning instructions for nutritional substance 520, or a reference to such conditioning instructions in nutritional substance database 550. In operation, this would allow nutritional substance ready 590 to obtain information nutritional substance 520 on how controller 530 dynamically operations conditioner system 510 to condition nutritional substance 520, without consumer intervention. Additionally, conditioning instructions for nutritional substance 520 could be provided for a variety of different conditions systems 510, or conditioners 570, and controller could select the proper conditioning instructions.

In a further embodiment of the present invention, nutritional substance reader 590 and/or conditioner system 510 measures or senses information about the current state of nutritional substance 520 and provides such information to controller 530 to allow controller 530 to dynamically modify operation of conditioner system 510.

In an additional embodiment of the present invention, consumer 540 provides information regarding their needs and/or desires with regard to the nutritional substance 520 to consumer interface 560. Consumer interface 560 provides this information to controller 530 so as to allow controller 530 to dynamically modify conditioner system 510 in the conditioning of nutritional substance 520. Consumer's 540 needs and/or desires could include nutritional parameters, taste parameters, aesthetic parameters. For example, consumer 540 may have needs for certain nutrients which are present in nutritional substance 520 prior to conditioning. Controller 530 could modify operation of conditioner system 510 so as to preserve such nutrients. For example, conditioner system 500 can cook the nutritional substance at a lower temperature and/or for a shorter duration so as to minimize nutrient loss.

Consumer 540 aesthetic desires could include how rare or well done they prefer a particular nutritional substance to be prepared. For example, consumer 540 may prefer his vegetables to be crisp or pasta to be prepared al dente. With such information provided by consumer 540 to consumer interface 560, controller 530 can dynamically modify operation of conditioner system 510.

In the preferred embodiment of the present invention, controller 530 receives information regarding the history of nutritional substance 520, current information on nutritional substance 520, and consumer 540 needs and/or desires, and dynamically modifies operation of conditioner system 510. For example, if nutritional substance 520 is a steak, controller 530 would receive reference information regarding the steak, nutritional substance 520, from nutritional substance reader 590. Controller 530 would use this reference information to obtain information about the steak from nutritional substance database 550. Controller 530 could also receive current information about the steak from nutritional substance reader 590 and/or conditioner 510. Additionally, controller 530 could receive consumer 540 preferences from consumer interface 560. Finally, controller 530 could receive information from conditioner system 510 during the conditioning of the steak, nutritional substance 520. Using some or all of such information, controller 530 would dynamically modify the cooking of the steak to preserve organoleptic, nutritional, and aesthetic properties to meet consumer 540 needs. For example, the steak could be cooked slowly to preserve iron levels within the meat, and also cooked to well-done to meet consumer's 540 taste.

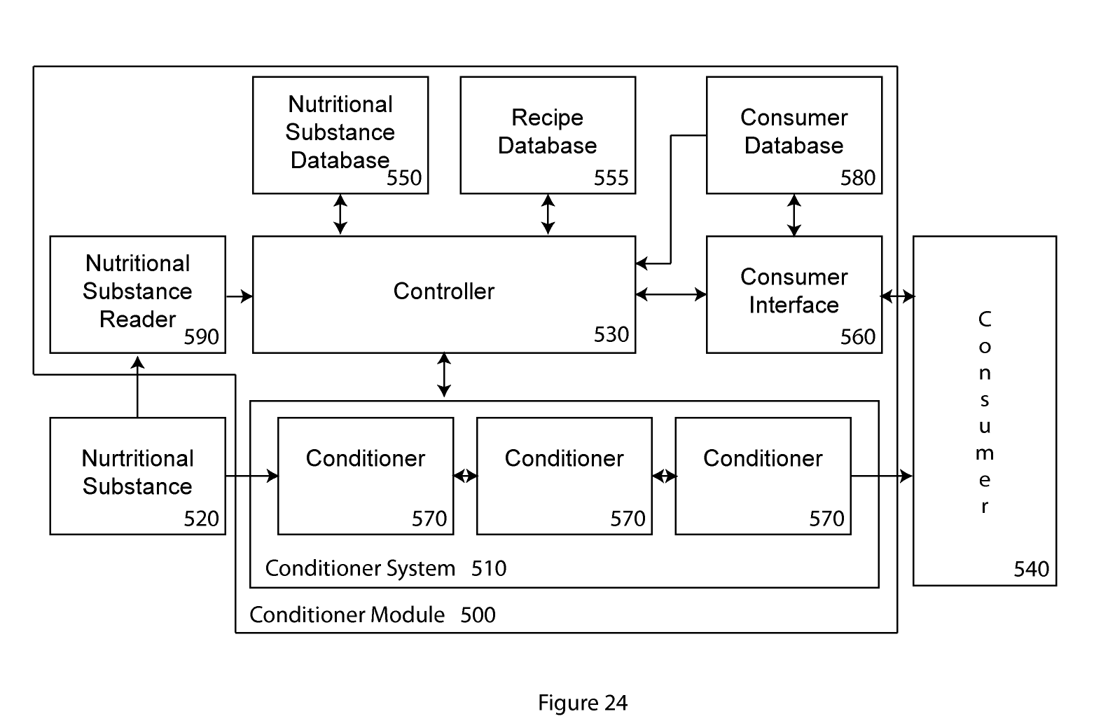

FIG. 24 shows an embodiment of conditioning module 500 of the present invention. Conditioner system 510 receives nutritional substance 520 for conditioning before it is delivered to consumer 540. Controller 530 is operably connected to conditioner system 510. In fact, controller 530 may be integrated within conditioner system 510, although in FIG. 2, it is shown as a separate device. When conditioner system 510 receives nutritional substance 520 for conditioning, nutritional substance reader 590 either receives or references information regarding nutritional substance 520, and provides it to controller 530. In the case where nutritional substance 520 contains a label which includes information about nutritional substance 520, nutritional substance reader 590 reads this information, provides it to controller 530 and makes it available to consumer 540 by means of consumer interface 560.

In an embodiment of the present invention, conditioner system 510 comprises conditioner 570. Conditioner 570 is a conditioning apparatus which can perform a number of operations on nutritional substance 520, separately and/or at the same time. For example, conditioner 570 could be a combination microwave oven, convection oven, grill, and conventional oven. Controller 530 could operate conditioner 570 to execute a sequence of conditioning cycles on nutritional substance 520 to complete its conditioning.

For example, if nutritional substance 520 is a whole frozen turkey to be prepared for dinner, consumer 540 would place the turkey in conditioner 570, the combination cooking unit suggested above. Controller 530 would receive and/or create a protocol of conditioning cycles. Such a protocol could be read by nutritional substance reader 590 from a label on nutritional substance 520. Alternately, a protocol of conditioning cycles could be obtained from nutritional substance database 550 through reference information obtained by nutritional substance reader 590 by nutritional substance 520. For example, a label on the turkey, could be read by nutritional substance reader 590, providing reference information for the turkey which controller 530 uses to obtain a conditioning protocol for the turkey from nutritional substance database 550.

An example of such a conditioning protocol for a frozen turkey could be to operate conditioner 570, the combination cooking unit in the following fashion. First, controller 530 instructs conditioner 570 to use the microwave function of the combination cooking unit to defrost the turkey according to the protocol and possibly according to conditioner information provided by conditioner 570, such as the weight of the turkey and information regarding the defrosting process as measured by conditioner 570. Following defrosting of the turkey, controller 530 next instructs the combination cooking unit to operate as a convection oven to cook the turkey for a sufficient length of time so as to ensure that the turkey reaches the proper internal temperature to meet safety requirements, and to maximize organoleptic and/or nutritional properties. Following the convection oven cooking of the turkey, controller 530 could instruct the combination cooking unit to grill the turkey for a sufficient period of time to create a desirable golden and crispy skin. Finally, controller 530 could instruct the combination cooking unit to use all three cooking functions at the same time to prepare the turkey for optimal consumption.

Alternately, conditioner system 510 could be composed of a plurality of conditioners 570. While an automated system for moving a nutritional substance between such conditioners would be optimal, conditioner system 510 could be operated manually by consumer 540 from instructions provided to consumer interface 560. In this embodiment, controller 530 could provide consumer 540 with instructions as to where to move the turkey after each step in the conditioning protocol. In this example, controller 530 instructs consumer 540 through consumer interface 560 to first place the frozen turkey in conditioner 570, a microwave oven. Controller 530 instructs the microwave oven to defrost the turkey based on information possibly provided by nutritional substance reader 590, nutritional substance database 550 and/or conditioner 570. Upon completion of defrosting by the microwave oven, controller 530 could instruct consumer 540 through interface 560 to move the defrosted turkey from the microwave oven to another conditioner 570, a convection oven. Controller 530 would operate the convection oven to cook the turkey for a sufficient length of time so as to ensure that the turkey reaches the proper internal temperature to meet safety requirements, and to maximize organoleptic and/or nutritional properties. Finally, following the cooking cycle in the convection oven, controller 530 could instruct consumer 540 through consumer interface 560 to move the turkey from the convection oven to another conditioner 570, a grill. Controller 530 would operate the grill so as to grill the turkey for a sufficient period of time to create a desirable golden and crispy skin.

In the case where conditioner system 510 is a plurality of conditioners 570, it would also be possible for controller 530 to manage conditioners 570 within conditioner system 510 so as to produce a complete meal. For example, controller 530 could select conditioning protocols which would maximize the use of each conditioner 570. For example, in a meal comprising a turkey, home baked bread, and acorn squash, controller 530 could stage and operate the microwave oven, convection oven, and grill to minimize preparation time for the meal by determining which item should be cooked in which conditioner 570, in which order, to maximize usage of each conditioner 570 in conditioning system 510. In this example, while the turkey is being defrosted in the microwave oven, controller 530 could instruct consumer 540 through interface 560 to place the bread dough in the convection oven and the acorn squash on the grill. Following the defrosting of the turkey, when the turkey is moved to the convection oven, which finished baking the bread, the bread could be moved to the grill for browning, and the acorn squash could be moved to microwave oven to keep warm., until the entire meal is ready.

For example, if nutritional substance 520 is a ready-to-eat frozen dinner which needs to be heated by conditioner system 510, nutritional substance reader 590 would read a label on nutritional substance 520, provide it to controller 530. This information could include creation information as to the creation of the various components which constitute the ready-to-eat dinner. This information could include information about where and how the corn in the ready-to-eat dinner was grown, including the corn seed used, where it was planted, how it was planted, how it was irrigated, when it was picked, and information on fertilizers and pesticides used during its growth. Additionally, this information could include the cattle lineage, health, immunization, dietary supplements that were fed to the cattle that was slaughtered to obtain the beef in the ready-to-eat dinner.

The information on nutritional substance 520 could also include information on how the components were preserved for shipment from the farm or slaughterhouse on their path to the nutritional substance transformer who prepared the ready-to-eat dinner. Additional information could include how the nutritional substance transformer transformed the components into the ready-to-eat dinner, such as recipe used, additives to the dinner, and actual measured conditions during the transformation into the ready-to-eat dinner.

While such information could be stored on a label located on the packaging for nutritional substance 520 so as to be read by nutritional substance reader 590, provided to controller 530, and provided to consumer interface 560 for display to consumer 540, preferably, the label on the nutritional substance package includes reference information which is read by nutritional substance reader 590 and provided to controller 530 that allows controller 530 to retrieve the information about nutritional substance 520 from nutritional substance database 550.

Nutritional substance database 550 could be a database maintained by the transformer of nutritional substance 520 for access by consumers of such nutritional substance 520. However, preferably, nutritional substance database 550 is a database maintained by the nutritional substance industry for all such information regarding nutritional substances grown, raised, preserved, transformed, conditioned and consumed by consumer 540.

In an alternate embodiment of the present invention, controller 530, in addition to providing information regarding nutritional substance 520 to consumer 540, controller 530 also receives information from conditioner system 510 on how nutritional substance 520 was conditioned. Additionally, conditioner system 510 may also measure or sense information about nutritional substance 520 during its conditioning by conditioner system 510, and provide such information to controller 530, so that such information could also be provided to consumer 540, via consumer interface 560.

In a preferred embodiment of the present invention, controller 530 organizes and correlates the information it receives regarding nutritional substance 520 from the various sources of such information, including nutritional substance database 550 and conditioner system 510, and presents such information through consumer interface 560 to consumer 540 in a manner useful to consumer 540. For example, such information may be provided in a manner that assists consumer 540 in understanding how nutritional substance 520 meets consumer's 540 nutritional needs. It could organize information regarding nutritional substance 520 to track consumer's 540 weight loss program. Controller 530 could have access to, or maintain, information regarding consumer 540, so as to track and assist consumer 540 in meeting their specific nutritional needs.

In another embodiment of the present invention conditioner system 510 could be a plurality of conditioner devices which can be selectively operated by controller 530 to prepare nutritional substance 520. Conditioner system 510 can be either a single conditioning device, such as a microwave oven, conventional oven, toaster, blender, steamer, stovetop, or human cook. Conditioner system 510 may be a plurality of conditioners 570. In the case where a plurality of conditioners 570 comprise conditioner system 510, nutritional system 520 may be manually or automatically transferred between conditioners 570 for eventual transfer to consumer 540.

Nutritional substance reader 590 may be an automatic reader such as a barcode reader or RFID sensor which receives information from nutritional substance 520 or a reference code from nutritional substance 520 and provides this information to controller 530. Nutritional substance reader 590 might also be a manual entry system where the reference code for nutritional substance 520 is manually entered into nutritional substance reader 590 for controller 530.

Nutritional substance database 550 could be a flat database, relational database or, preferably, a multi-dimensional database. Nutritional substance database 550 could be local but, preferably, it would be located remotely, such as on the internet, and accessed via a telecommunication system, such as a wireless telecommunication system. Controller 530 can be implemented using a computing device, such as a micro-controller, micro-processor, personal computer, or tablet computer. Controller 530 could be integrated to include nutritional substance reader 590, consumer interface 560, and/or nutritional substance database 550. Additionally, controller 530 may be integrated in conditioner system 510, including integration into conditioner 570.

Consumer interface 560 can be implemented as a display device mounted on controller 530, conditioner system 510, or conditioner 570. However, consumer interface 560 is preferably a tablet computer, personal computer, personal assistant, or smart phone, running appropriate software, such as an app.

While conditioner module 500 can be located in the consumer's home, conditioner module 500 may be located at a restaurant or other food service establishment for use in preparing nutritional substances 520 for consumers who patronize such an establishment. Additionally, conditioner module 500 could be located at a nutritional substance seller such as a grocery store or health food store for preparation of nutritional substances 520 purchased by consumers at such an establishment. It could be foreseen that conditioner modules 500 could become standalone businesses where consumers select nutritional substances for preparation at the establishment or removal from the establishment for consumption elsewhere.

Additionally, controller 530 uses nutritional substance information provided by nutritional substance database 550 from reference information from nutritional substance reader 590 to dynamically modify the operation of conditioner system 510 to maintain organoleptic and nutritional properties of nutritional substance 520. For example, if the nutritional substance 520 is a ready-to-eat dinner, controller 530 could modify the instructions to conditioner system 530 in response to information regarding the corn used in the ready-to-eat dinner such that a temperature and cooking duration can be modified to affect the organoleptic, nutritional, taste, and/or appearance of the corn.

In an embodiment of the present invention, the label on nutritional substance 520 could contain the conditioning instructions for nutritional substance 520, or a reference to such conditioning instructions in nutritional substance database 550. In operation, this would allow nutritional substance ready 590 to obtain information nutritional substance 520 on how controller 530 dynamically operations conditioner system 510 to condition nutritional substance 520, without consumer intervention. Additionally, conditioning instructions for nutritional substance 520 could be provided for a variety of different conditions systems 510, or conditioners 570, and controller could select the proper conditioning instructions.

In a further embodiment of the present invention, nutritional substance reader 590 and/or conditioner system 510 measures or senses information about the current state of nutritional substance 520 and provides such information to controller 530 to allow controller 530 to dynamically modify operation of conditioner system 510.

In an additional embodiment of the present invention, consumer 540 provides information regarding their needs and/or desires with regard to the nutritional substance 520 to consumer interface 560. Consumer interface 560 provides this information to controller 530 so as to allow controller 530 to dynamically modify conditioner system 510 in the conditioning of nutritional substance 520. Consumer's 540 needs and/or desires could include nutritional parameters, taste parameters, aesthetic parameters. For example, consumer 540 may have needs for certain nutrients which are present in nutritional substance 520 prior to conditioning. Controller 530 could modify operation of conditioner system 510 so as to preserve such nutrients. For example, conditioner system 500 can cook the nutritional substance at a lower temperature and/or for a shorter duration so as to minimize nutrient loss.

Consumer 540 aesthetic desires could include how rare or well done they prefer a particular nutritional substance to be prepared. For example, consumer 540 may prefer his vegetables to be crisp or pasta to be prepared al dente. With such information provided by consumer 540 to consumer interface 560, controller 530 can dynamically modify operation of conditioner system 510.

In the preferred embodiment of the present invention, controller 530 receives information regarding the history of nutritional substance 520, current information on nutritional substance 520, and consumer 540 needs and/or desires, and dynamically modifies operation of conditioner system 510. For example, if nutritional substance 520 is a steak, controller 530 would receive reference information regarding the steak, nutritional substance 520, from nutritional substance reader 590. Controller 530 would use this reference information to obtain information about the steak from nutritional substance database 550. Controller 530 could also receive current information about the steak from nutritional substance reader 590 and/or conditioner 510. Additionally, controller 530 could receive consumer 540 preferences from consumer interface 560. Finally, controller 530 could receive information from conditioner system 510 during the conditioning of the steak, nutritional substance 520. Using some or all of such information, controller 530 would dynamically modify the cooking of the steak to preserve organoleptic, nutritional, and aesthetic properties to meet consumer 540 needs. For example, the steak could be cooked slowly to preserve iron levels within the meat, and also cooked to well-done to meet consumer's 540 taste.

Conditioner system 510 can prepare a nutritional substance for consumer 540 which contains a plurality of nutritional substances 520. Conditioner module 500 includes recipe database 555 which is operably connected to controller 530. Recipe database 555 can be part of nutritional substance database 550, or it can be a stand-alone database. While recipe database 555 can be located locally, it is preferably accessible to many conditioner modules 500 through a telecommunications system such as the internet, including wireless telecommunications systems.

Controller 530 is also preferably connected to consumer database 580. Consumer database 580 may be additionally connected to consumer interface 560. Consumer database 580 could include consumer's 540 organoleptic and nutritional needs, and consumer 540 preferences. Consumer database 580 may receive input regarding consumer 540 from consumer 540, but could also include information supplied by consumer's 540 medical records, exercise records for the consumer's gym, and other information sources. Additionally, consumer database 580 could include information regarding consumer's 540 preferences provided by controller 530 for previous nutritional substance 520 conditionings. Finally, consumer database 580 could include consumer preferences from external sources such as restaurants and grocery stores where consumer 540 purchases nutritional substances 520. Finally, consumer database 580 could include information from consumer module 600, in FIG. 1.

Consumer database 580 could be a local database maintained by controller 530 and/or consumer interface 560. Preferably, consumer database 580 is part of a nutritional substance industry database containing such information regarding a plurality of consumers 540.

For example, controller 530 can operate conditioner system 510 to select the necessary ingredients, nutritional substance 520, to prepare a meal. In this case, nutritional substance 520 could be a plurality of nutritional substances 520. In operation, consumer 540 could select a dinner menu using consumer interface 560. Additionally, consumer 540 could select a specific recipe from recipe database 555 or could select a recipe source within database 555, such as low salt meals and/or recipes by a certain well-known chef. Controller 530 could prepare a shopping list for consumer 540 through consumer interface 560. Alternatively, controller 530 could transmit a shopping list to a nutritional substance 520 such as a grocery store, so consumer 540 could pick up such items already selected or could have such items delivered.

Alternatively, if instructed by consumer 540 to utilize nutritional substances on hand, which have been logged into controller 530 through nutritional substance reader 590, controller 530 could modify or suggest a recipe that used only nutritional substances 520 available to conditioner module 500. For example, if consumer 540 instructs conditioner module 500 through conditioner interface 560 that consumer 540 would like Italian food in the style of a well-known Italian chef, controller 530 would utilize information in its various databases to prepare such a meal. In this case, controller 530 would match its inventory of available nutritional substances with recipes from the well-known Italian chef in recipe database 555 and find available recipes. Controller 530 could select a recipe that optimized consumer's 540 needs and preferences and prepare a meal using conditioner system 510. Alternatively, controller 530 could present various options to consumer 540 using consumer interface 560, highlighting features of each available meal from the standpoint of consumer's 540 nutritional needs and/or preferences.

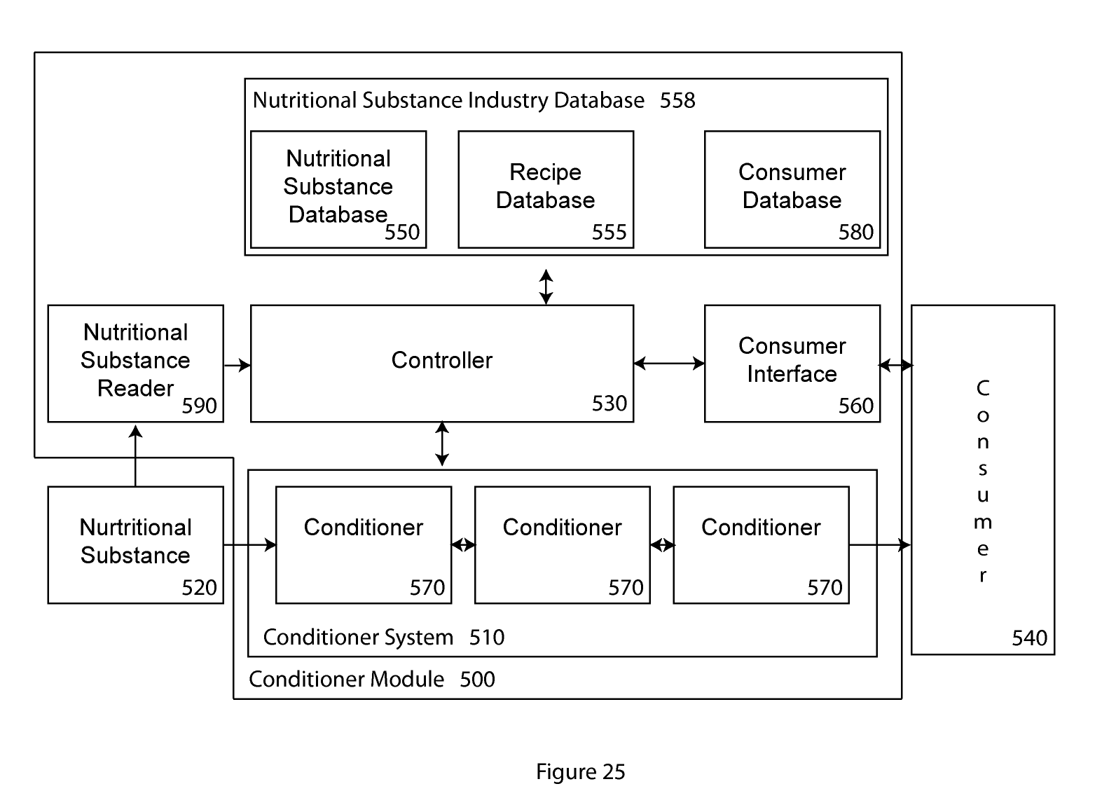

In FIG. 25, nutritional substance database 550, recipe database 555, and consumer database 580 are part of nutritional substance industry database 558. Controller 530 would communicate with nutritional substance industry database 558 through a communication system such as the internet, and preferably a telecommunications system such as wireless telecommunications.

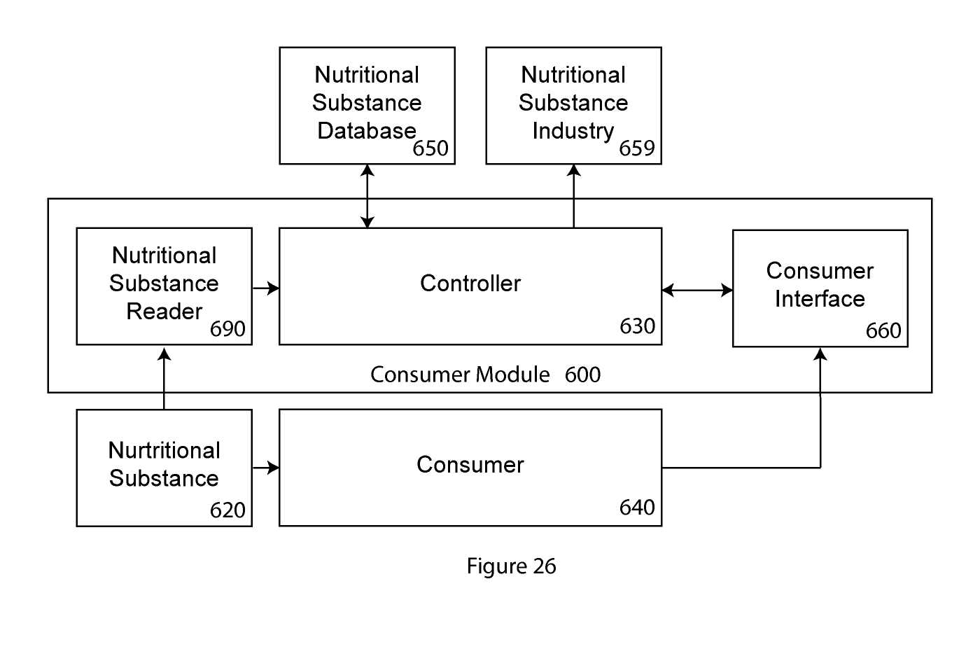

FIG. 26 shows an embodiment of consumer module 600 of the present invention. In the first embodiment of the present invention, consumer module 600 comprises nutritional substance reader 690, controller 630, and consumer interface 660. A nutritional substance 620 is read by nutritional substance reader 690 to obtain reference information regarding nutritional substance 620. Nutritional substance reader 690 provides such reference information to controller 630. Nutritional substance 620 is consumed by consumer 640. During, and/or following, consumption of nutritional substance 620 consumer 640 provides information to consumer interface 660. Such information is provided by consumer interface 660 to controller 630. Controller 630 correlates the nutritional substance information and the consumer information and provides the correlated information to nutritional substance industry 659. Such information may be used for improving nutritional substance 620, creating new nutritional substances, discontinue nutritional substances, and for marketing nutritional substance 620. Other uses of such correlated consumer information will be apparent to those in the nutritional substance industry 659. In a further embodiment described herein, consumer information may also be provided to the nutritional substance industry 659.

In an alternate embodiment, controller 630 references nutritional substance information 620 to nutritional substance database 650 to determine those in nutritional substance industry 659 who were involved in the creation, preserving, transforming, and/or conditioning of the nutritional substance 620. Controller 630 may provide the consumer information regarding nutritional substance 620 to those involved in the supply chain of nutritional substance 620.

Consumer module 600 can be implemented with discreet devices. For example, nutritional substance reader 690 could be an optical reader such as a barcode scanner or camera capable of discerning reference information. Nutritional substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630.

Preferably, consumer module 600 is an integrated device such as a tablet computer or smartphone. In this case, nutritional substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known nutritional substance 620

In operation, consumer 640 would use the camera on the tablet computer or smartphone to read a barcode on nutritional substance 620 providing the reference information for nutritional substance 620. The tablet computer or smartphone would display an appropriate user interface so as to allow consumer 640 to provide information about her consumption of nutritional substance 620. Controller 630 could query nutritional substance database 650 using reference information regarding nutritional substance 620 to determine those in the nutritional substance industry who were involved in the supply chain for nutritional substance 620. Additionally, nutritional substance database 650 could contain information on what information to collect from consumer 640 of the particular nutritional substance 620 being referenced.

Such information could be provided through a connection to the internet accessed through the telecommunication system in the tablet computer or smartphone. Preferably, such a telecommunications connection to nutritional substance database 630 would be a wireless telecommunication system. The tablet computer or smartphone would then, in the same manner, provide the consumer information regarding her consumption of nutritional substance 620 to those in nutritional substance industry 659 involved in the supply chain of nutritional substance 620.

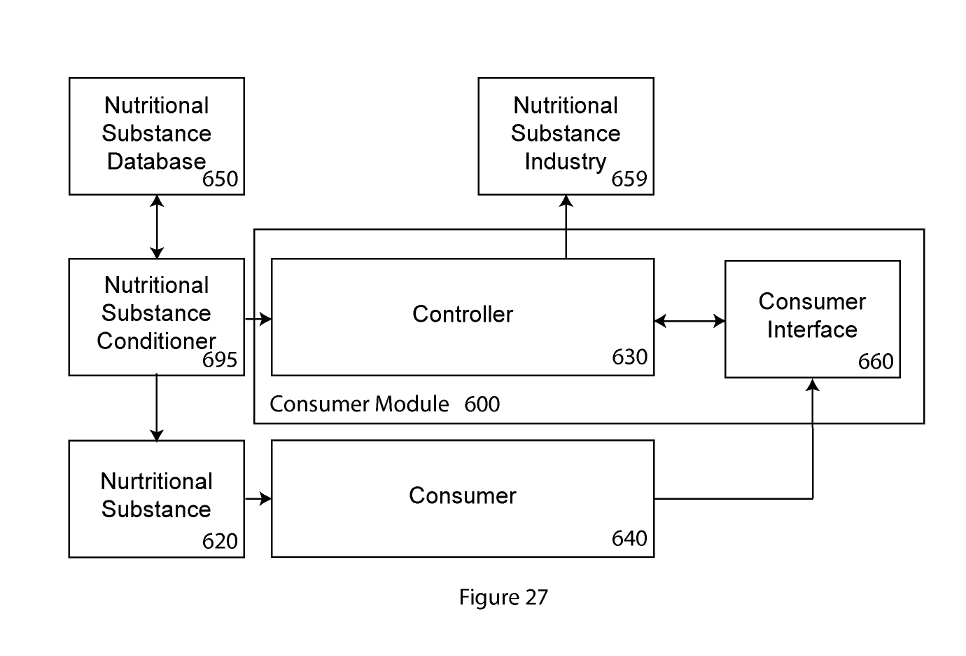

FIG. 27 shows an alternate embodiment of the present invention where nutritional substance 620 was conditioned by nutritional substance conditioner 695. In this case, nutritional substance conditioner 695 would already have information pertaining to nutritional substance 620, including information on how nutritional substance 620 was conditioned by nutritional substance conditioner 695.

In this embodiment, controller 630 receives such information regarding nutritional substance 620 and correlates it with consumer information from consumer interface 660 and provides it to nutritional substance industry 659.

For example, nutritional substance conditioner 695 conditions a ready-to-eat dinner. In the process of conditioning the ready-to-eat dinner, nutritional substance conditioner 695 receives various information, reads the reference tag on nutritional substance 620, the ready-to-eat dinner. Using this reference information, nutritional substance conditioner 695 receives, from nutritional substance database 650, information regarding nutritional substance 620, the ready-to-eat dinner. In this case, if the nutritional substance conditioner 695 is a nutritional substance information ready microwave oven, it would obtain from nutritional substance database 650 preparation information, organoleptic information, and/or nutritional information about the ready-to-eat dinner. Upon presentation of the ready-to-eat dinner to consumer 640, nutritional substance conditioner 695 also provides the information regarding the ready-to-eat dinner it received from nutritional substance database 650 along with information it collected regarding the conditioning of the ready-to-eat dinner by nutritional substance conditioner 695, to controller 630. If consumer module 600 is a standalone device such as a tablet computer or smartphone, the information from nutritional substance conditioner 695 could be transferred by means of a wireless local area network or Bluetooth connection. Consumer module 600, the smartphone for example, would obtain consumer information regarding the consumption of the nutritional substance 620. Since the smartphone knows what was consumed, it can obtain from consumer 640 information appropriate for the ready-to-dinner.

In the case of the ready-to-eat dinner, the consumer 640 could be asked specifically about the taste of the corn and the taste of the beef in the dinner, as well as their combination. Using such information and the information from the nutritional substance database 650, consumer module 600 can provide appropriate information to those in the nutritional substance industry 659 who were involved in the supply chain for nutritional substance 620.

In this embodiment, consumer module 600 could be part of nutritional substance conditioner 695. In this example, the nutritional substance information ready microwave oven would provide user interface 660 to receive consumer information regarding the nutritional substance 620 conditioned by nutritional substance conditioner 695. In such a case, controller 630 likely would be the same controller which operates nutritional substance conditioner 695.

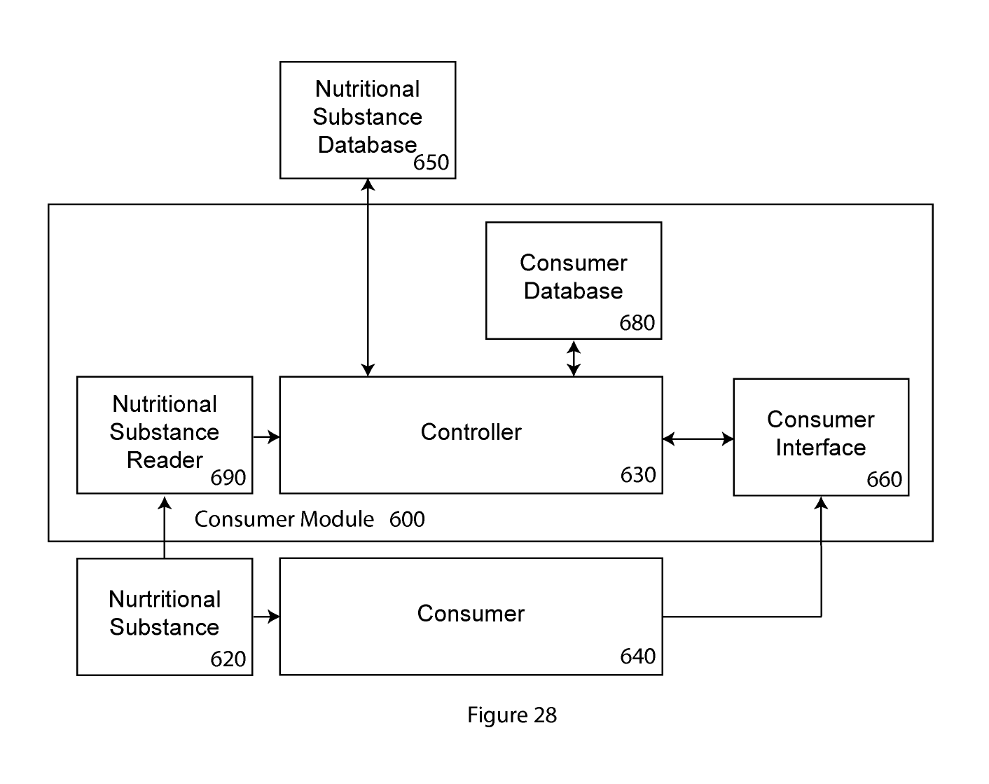

FIG. 28 shows an embodiment of consumer module 600 of the present invention. In the first embodiment of the present invention, consumer module 600 comprises nutritional substance reader 690, controller 630, and consumer interface 660. A nutritional substance 620 is read by nutritional substance reader 690 to obtain reference information regarding nutritional substance 620. Nutritional substance reader 690 provides such reference information to controller 630. Nutritional substance 620 is consumed by consumer 640. During, and/or following, consumption of nutritional substance 620 consumer 640 provides information to consumer interface 660. Such information is provided by consumer interface 660 to controller 630. Controller 630 correlates the nutritional substance information and the consumer information and provides the correlated information to nutritional substance industry 659. Such information may be used for improving nutritional substance 620, creating new nutritional substances, discontinue nutritional substances, and for marketing nutritional substance 620. Other uses of such correlated consumer information will be apparent to those in the nutritional substance industry 659. In a further embodiment described herein, consumer information may also be provided to the nutritional substance industry 659.

In an alternate embodiment, controller 630 references nutritional substance information 620 to nutritional substance database 650 to determine those in nutritional substance industry 659 who were involved in the creation, preserving, transforming, and/or conditioning of the nutritional substance 620. Controller 630 may provide the consumer information regarding nutritional substance 620 to those involved in the supply chain of nutritional substance 620.

Also included in consumer module 600 is consumer database 680. Consumer database 680 contains specific information regarding consumer 640. Correlated information regarding the consumption of nutritional substance 620 could be stored for future reference in consumer database 680. Such information could be used in collecting future consumer information. For example, if consumer 640 is very particular about a certain aspect of a nutritional substance 620, controller 630 could ask for additional and/or more specific information from consumer 640 about the nutritional substance 620 through consumer interface 660. As an example, consumer 640 is very particular about the texture of pasta. When nutritional substance 620 being consumed by consumer 640 contains pasta, controller 630, in response to historical consumer 640 information in consumer database 680, could ask for additional information regarding the texture of the pasta in nutritional substance 620, using consumer interface 660.

Consumer module 600 can be implemented with discreet devices. For example, nutritional substance reader 690 could be an optical reader such as a barcode scanner or camera capable of discerning reference information. Nutritional substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630.

Preferably, consumer module 600 is an integrated device such as a tablet computer or smartphone. In this case, nutritional substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known nutritional substance 620

In operation, consumer 640 would use the camera on the tablet computer or smartphone to read a barcode on nutritional substance 620 providing the reference information for nutritional substance 620. The tablet computer or smartphone would display an appropriate user interface so as to allow consumer 640 to provide information about her consumption of nutritional substance 620. Controller 630 could query nutritional substance database 650 using reference information regarding nutritional substance 620 to determine those in the nutritional substance industry who were involved in the supply chain for nutritional substance 620. Additionally, nutritional substance database 650 could contain information on what information to collect from consumer 640 of the particular nutritional substance 620 being referenced.

Such information could be provided through a connection to the internet accessed through the telecommunication system in the tablet computer or smartphone. Preferably, such a telecommunications connection to nutritional substance database 630 would be a wireless telecommunication system. The tablet computer or smartphone would then, in the same manner, provide the consumer information regarding her consumption of nutritional substance 620 to those in nutritional substance industry 659 involved in the supply chain of nutritional substance 620.

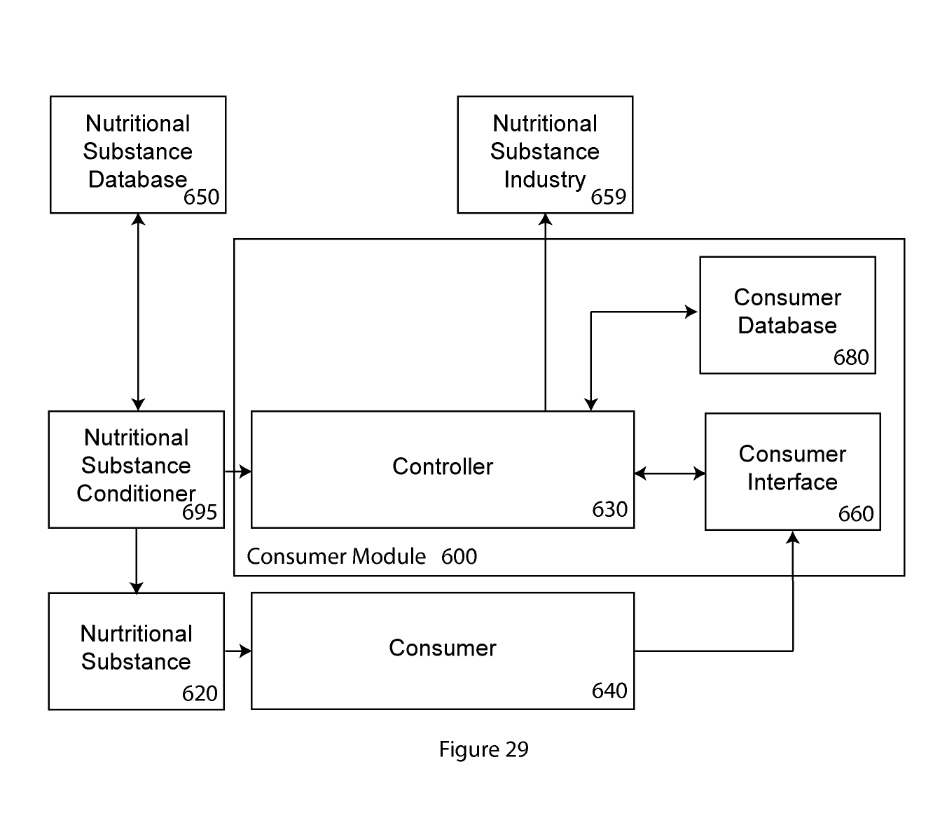

FIG. 29 shows an alternate embodiment of the present invention where nutritional substance 620 was conditioned by nutritional substance conditioner 695. In this case, nutritional substance conditioner 695 would already have information pertaining to nutritional substance 620, including information on how nutritional substance 620 was conditioned by nutritional substance conditioner 695.

In this embodiment, controller 630 receives such information regarding nutritional substance 620 and correlates it with consumer information from consumer interface 660 and provides it to nutritional substance industry 659.

For example, nutritional substance conditioner 695 conditions a ready-to-eat dinner. In the process of conditioning the ready-to-eat dinner, nutritional substance conditioner 695 receives various information, reads the reference tag on nutritional substance 620, the ready-to-eat dinner. Using this reference information, nutritional substance conditioner 695 receives, from nutritional substance database 650, information regarding nutritional substance 620, the ready-to-eat dinner. In this case, if the nutritional substance conditioner 695 is a nutritional substance information ready microwave oven, it would obtain from nutritional substance database 650 preparation information, organoleptic information, and/or nutritional information about the ready-to-eat dinner. Upon presentation of the ready-to-eat dinner to consumer 640, nutritional substance conditioner 695 also provides the information regarding the ready-to-eat dinner it received from nutritional substance database 650 along with information it collected regarding the conditioning of the ready-to-eat dinner by nutritional substance conditioner 695, to controller 630. If consumer module 600 is a standalone device such as a tablet computer or smartphone, the information from nutritional substance conditioner 695 could be transferred by means of a wireless local area network or Bluetooth connection. Consumer module 600, the smartphone for example, would obtain consumer information regarding the consumption of the nutritional substance 620. Since the smartphone knows what was consumed, it can obtain from consumer 640 information appropriate for the ready-to-dinner.

In the case of the ready-to-eat dinner, the consumer 640 could be asked specifically about the taste of the corn and the taste of the beef in the dinner, as well as their combination. Using such information and the information from the nutritional substance database 650, consumer module 600 can provide appropriate information to those in the nutritional substance industry 659 who were involved in the supply chain for nutritional substance 620.

In this embodiment, consumer module 600 could be part of nutritional substance conditioner 695. In this example, the nutritional substance information ready microwave oven would provide user interface 660 to receive consumer information regarding the nutritional substance 620 conditioned by nutritional substance conditioner 695. In such a case, controller 630 likely would be the same controller which operates nutritional substance conditioner 695.

It will be understood that subsets of the embodiment described herein can operate to achieve the goals stated herein. In one embodiment, nutritional substance sensor 380, internal sensor 370, external sensor 360, information storage module 330, controller 350, reader 340, and parts of container 310 are each electrical or electromechanical devices which perform each of the indicated functions. However, it is possible for some or all of these functions to be done using chemical and/or organic compounds. For example, a specifically designed plastic wrap for bananas can sense the exterior conditions of the package, the interior conditions of the package, and control gas flow through its surface so as to preserve and ripen the bananas.

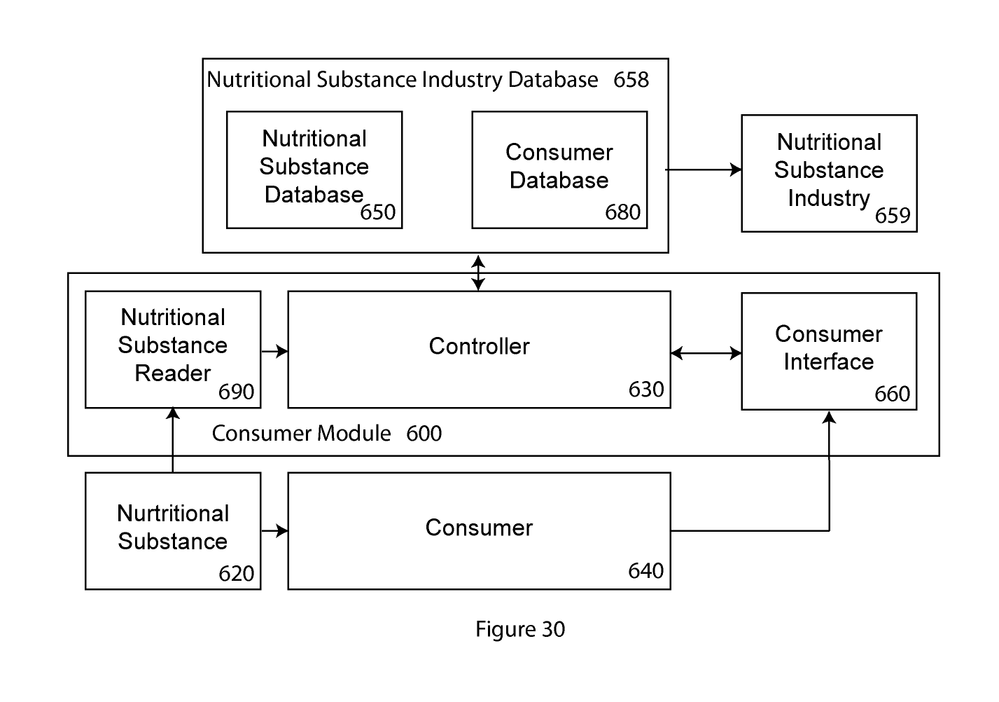

FIG. 30 shows an embodiment of consumer module 600 of the present invention. In the first embodiment of the present invention, consumer module 600 comprises nutritional substance reader 690, controller 630, and consumer interface 660. A nutritional substance 620 is read by nutritional substance reader 690 to obtain reference information regarding nutritional substance 620. Nutritional substance reader 690 provides such reference information to controller 630. Nutritional substance 620 is consumed by consumer 640. During, and/or following, consumption of nutritional substance 620 consumer 640 provides information to consumer interface 660. Such information is provided by consumer interface 660 to controller 630. Controller 630 correlates the nutritional substance information and the consumer information and provides the correlated information to nutritional substance industry 659. Such information may be used for improving nutritional substance 620, creating new nutritional substances, discontinue nutritional substances, and for marketing nutritional substance 620. Other uses of such correlated consumer information will be apparent to those in the nutritional substance industry 659. In a further embodiment described herein, consumer information may also be provided to the nutritional substance industry 659.

In an alternate embodiment, controller 630 references nutritional substance information 620 to nutritional substance database 650 to determine those in nutritional substance industry 659 who were involved in the creation, preserving, transforming, and/or conditioning of the nutritional substance 620. Controller 630 may provide the consumer information regarding nutritional substance 620 to those involved in the supply chain of nutritional substance 620.

Consumer module 600 can be implemented with discreet devices. For example, nutritional substance reader 690 could be an optical reader such as a barcode scanner or camera capable of discerning reference information. Nutritional substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630.

Preferably, consumer module 600 is an integrated device such as a tablet computer or smartphone. In this case, nutritional substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known nutritional substance 620

In operation, consumer 640 would use the camera on the tablet computer or smartphone to read a barcode on nutritional substance 620 providing the reference information for nutritional substance 620. The tablet computer or smartphone would display an appropriate user interface so as to allow consumer 640 to provide information about her consumption of nutritional substance 620. Controller 630 could query nutritional substance database 650 using reference information regarding nutritional substance 620 to determine those in the nutritional substance industry who were involved in the supply chain for nutritional substance 620. Additionally, nutritional substance database 650 could contain information on what information to collect from consumer 640 of the particular nutritional substance 620 being referenced.

Such information could be provided through a connection to the internet accessed through the telecommunication system in the tablet computer or smartphone. Preferably, such a telecommunications connection to nutritional substance database 630 would be a wireless telecommunication system. The tablet computer or smartphone would then, in the same manner, provide the consumer information regarding her consumption of nutritional substance 620 to those in nutritional substance industry 659 involved in the supply chain of nutritional substance 620.

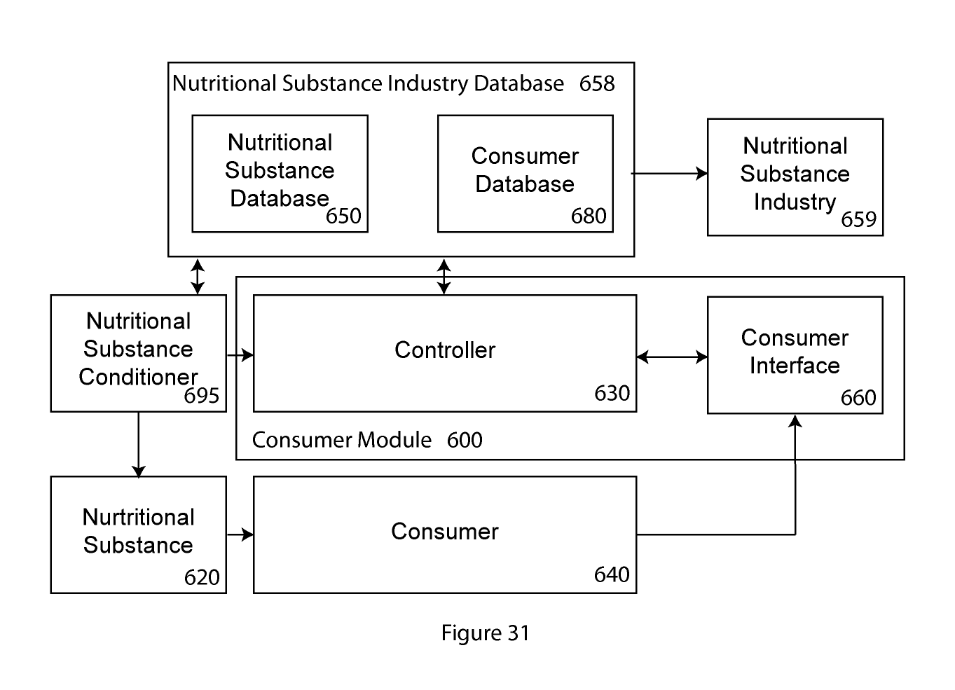

FIG. 31 shows an alternate embodiment of the present invention where nutritional substance 620 was conditioned by nutritional substance conditioner 695. In this case, nutritional substance conditioner 695 would already have information pertaining to nutritional substance 620, including information on how nutritional substance 620 was conditioned by nutritional substance conditioner 695.

In this embodiment, controller 630 receives such information regarding nutritional substance 620 and correlates it with consumer information from consumer interface 660 and provides it to nutritional substance industry 659.

For example, nutritional substance conditioner 695 conditions a ready-to-eat dinner. In the process of conditioning the ready-to-eat dinner, nutritional substance conditioner 695 receives various information, reads the reference tag on nutritional substance 620, the ready-to-eat dinner. Using this reference information, nutritional substance conditioner 695 receives, from nutritional substance database 650, information regarding nutritional substance 620, the ready-to-eat dinner. In this case, if the nutritional substance conditioner 695 is a nutritional substance information ready microwave oven, it would obtain from nutritional substance database 650 preparation information, organoleptic information, and/or nutritional information about the ready-to-eat dinner. Upon presentation of the ready-to-eat dinner to consumer 640, nutritional substance conditioner 695 also provides the information regarding the ready-to-eat dinner it received from nutritional substance database 650 along with information it collected regarding the conditioning of the ready-to-eat dinner by nutritional substance conditioner 695, to controller 630. If consumer module 600 is a standalone device such as a tablet computer or smartphone, the information from nutritional substance conditioner 695 could be transferred by means of a wireless local area network or Bluetooth connection. Consumer module 600, the smartphone for example, would obtain consumer information regarding the consumption of the nutritional substance 620. Since the smartphone knows what was consumed, it can obtain from consumer 640 information appropriate for the ready-to-dinner.

In the case of the ready-to-eat dinner, the consumer 640 could be asked specifically about the taste of the corn and the taste of the beef in the dinner, as well as their combination. Using such information and the information from the nutritional substance database 650, consumer module 600 can provide appropriate information to those in the nutritional substance industry 659 who were involved in the supply chain for nutritional substance 620.

In this embodiment, consumer module 600 could be part of nutritional substance conditioner 695. In this example, the nutritional substance information ready microwave oven would provide user interface 660 to receive consumer information regarding the nutritional substance 620 conditioned by nutritional substance conditioner 695. In such a case, controller 630 likely would be the same controller which operates nutritional substance conditioner 695.

Also included in consumer module 600 is consumer database 680. Consumer database 680 contains specific information regarding consumer 640. Correlated information regarding the consumption of nutritional substance 620 could be stored for future reference in consumer database 680. Such information could be used in collecting future consumer information. For example, if consumer 640 is very particular about a certain aspect of a nutritional substance 620, controller 630 could ask for additional and/or more specific information from consumer 640 about the nutritional substance 620 through consumer interface 660. As an example, consumer 640 is very particular about the texture of pasta. When nutritional substance 620 being consumed by consumer 640 contains pasta, controller 630, in response to historical consumer 640 information in consumer database 680, could ask for additional information regarding the texture of the pasta in nutritional substance 620, using consumer interface 660.

Controller 630 is connected to nutritional substance industry database 658. Nutritional substance industry database 658 contains information regarding nutritional substances 620 in nutritional substance database 650. Also contained in nutritional substance industry database 658 is consumer database 680 which contains information about consumer 640.

In the preferred embodiment of the present invention, nutritional substance industry database is a massive multi-dimension data based used by part or all of the nutritional substance industry to track, store and analyze information about nutritional substances, preservation of nutritional substances, transformation of nutritional substances, conditioning of nutritional substances, recipes for the preparation of nutritional substances, consumption of nutritional substances and marketing of nutritional substances.

In FIG. 1, Information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Additionally, information module 100 can provide such collected information to the other modules, as well as outside parties not part of nutritional substance industry 10

Creation module 200 collects information regarding a particular nutritional substance, such as information regarding the genesis of the nutritional substance, information regarding the growing or raising of the nutritional substance, information regarding the harvesting or slaughtering of the nutritional substance, and where the nutritional substance was delivered. This creation information can be delivered by creation module 200 to information module 100 by means of a communications network such as a telecommunications network and, preferably, a wireless telecommunications network.

For example, if the nutritional substance is corn, the farmer would collect information regarding the seed that was planted, the location and soil the seed was planted in, the water used for irrigation, and any fertilizers or pesticides used in growing the corn. Additionally, creation information as to when the corn was planted and when it was harvested and to whom the corn was delivered could also be collected. The farmer would provide such information to information module 100.

In the case where nutritional substance is beef hamburger meet, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered. All such creation information would be provided by the rancher to information module 100.

Preservation module 300 preserves nutritional substance during its journey from the creation module 200 to the transformation module 400. However, it is understood that preservation module 300 may be located between any two modules for the transfer of nutritional substance between those modules. For example, not only does the nutritional substance need to be preserved between creation module 200 and transformation module 400, it also needs to be preserved between transformation module 400 and conditioning module 500. Preservation module 300 obtains creation information regarding the nutritional substance from information module 100. Using that information, preservation module 300 optimizes the preservation of the nutritional substance so as to preserve or improve the organoleptic and nutritional properties of the nutritional substance.

Additionally, preservation module 300 provides information to information module 100 regarding the nutritional substance during the time it is being preserved and shipped to transformation module 400. This information could include the condition of the nutritional substance when it was received for preservation, the condition of the nutritional substance during its preservation, and the condition of the nutritional substance at the end of its preservation. Additionally, such preservation information could include the environmental conditions outside the preservation module 300 during the period of preservation and shipment. Preservation module 300 could also provide information regarding the interior conditions of preservation module 300 during the preservation and shipment of the nutritional substance. Finally, if preservation module 300 dynamically modified its preservation of the nutritional substance during its preservation and shipment, information regarding how preservation module 300 dynamically modified itself during the period of preservation and shipment could be provided to information module 100.

In the case where the nutritional substance is bananas, preservation 300 could provide to information module 100 information about the current state of the bananas, as well as the exterior and interior conditions of preservation module 300, as well modifications preservation module 300 made to itself to ripen the bananas during preservation so as to meet optimize organoleptic and nutritional properties when the bananas arrive at the grocery store.

In the case where the nutritional substance is beef which is being aged during the period it is preserved by preservation module 300, preservation module 300 could provide information module 100 with information regarding the condition of the beef from the time of its delivery to preservation module 300, through the time the beef was preserved by preservation module 300, to when it was removed from preservation module 300. This preservation information provided to information module 100 could be used by the conditioner of the beef, such as a restaurant, to determine how to properly cook the beef.

Transformation module 400 could retrieve from information module 100 both creation information provided by creation module 200 and preservation information provided by preservation module 300. Transformation module 400 could use such creation information and preservation information to dynamically modify the transformation of the nutritional substance. Additionally, transformation module 400 could provide information module 100 with transformation information.

In the case where the nutritional substance is sweet corn which is to be cooked and canned for consumer consumption, transformation module 400 could use the creation information regarding the composition of the corn, including its nutrients and additives, to determine how to transform the corn so as to preserve or improve organoleptic and nutritional properties. Transformation module 400 could also use preservation information regarding the corn to modify the transformation in response to changes to the corn which occurred during preservation. The information regarding how the corn was transformed in transformation module 400, such as cooking temperatures and duration and substances added to the canned corn, could be provided by transformation module 400 to information module 100.

Conditioning module 500 receives information regarding the nutritional substance from information module 100. This information could include creation information provided by creation module 200, preservation information provided by preservation module 300, and transformation information from transformation module 400. Additionally, conditioning module 500 could receive recipe information from information module 100. All such information could be used by conditioning module 500 in the conditioning of the nutritional substance. Conditioning module 500 can provide information module 100 with conditioning information regarding how the nutritional substance was conditioned, as well as measured or sensed information as to the state of the nutritional substance before, during and upon completion of conditioning.

In the example of a frozen ready-to-eat dinner, conditioning module 500 could use such information provided by information module 100 to optimize the conditioning of the nutritional substance by conditioning module 500. Conditioning module 500 could dynamically modify the conditioning of the nutritional substance in response to information it receives from information module 100 regarding the organoleptic and nutritional properties of the nutritional substance. Conditioning module 500 could use information about the corn and beef in the dinner to modify the defrosting and cooking the dinner.

Consumer module 600 obtains consumer information from the consumer of the nutritional substance. Such consumer information could include feedback from the consumer as to the quality and taste of the nutritional substance. Consumer module 600 provides such information to information module 100. Information module 100 correlates this information with all the information provided regarding the nutritional substance and provides some or all consumer information to the various modules in nutritional substance supply system 10. Each module in the nutritional substance supply system 10 could use such consumer information to modify and/or improve its operation. Additionally, consumer module 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, and/or marketing of nutritional substances.

It should be understood that nutritional substances do not need to necessarily pass through all the modules in nutritional substance supply system 10. For example, produce grown and sold to a consumer at the farm would only pass through creation module 200 and consumer module 600. Bananas grown on a plantation and shipped to a grocery store may only pass through creation module 200 and preservation module 300 before being consumed by consumer in consumer module 600. In the case where the nutritional substance is Brussels sprouts, the Brussels sprouts would have creation information provided by creation module 200, preservation information from preservation module 300, and conditioning information from conditioning module 500 before being delivered to consumer module 600.

In the case where the nutritional substance can be consumed following transformation by transformation module 400 without the need for conditioning by conditioning module 500, the nutritional substance would pass directly from transformation module 400 to consumer module 600. In the case of dried cranberries, creation information from creation module 200, the cranberry grower, would be provided to information module 100. Preservation information from preservation module 300 would be provided to information module regarding the preservation of the cranberries during their trip from the cranberry grower to transformation module 400, the dried fruit processor. Transformation information regarding the drying of the cranberries by transformation module 400 would be provided to information module 100. An additional preservation module 300 would preserve the dried cranberries during their trip from the dried fruit processor to the consumer in consumer module 600. In this case, there would be no conditioning module 500 in nutritional substance supply system 10, as the dried cranberries do not necessarily need to be conditioned before consumption.

It will also be understood that nutritional substances may pass through nutritional substance supply system 10 more than one time. In the case of the nutritional substance being wheat flour which is eventually used to make bread, the wheat grain may pass through conditioning module 200, preservation module 300, and transformation module 400 to become wheat flour. The flour can then be passed to a preservation module 300 for delivery to a transformation module 400 which prepares bread dough, for conditioning in a conditioning module 500, which bakes the dough into bread for consumer module 600. During the wheat's multiple trips through nutritional substance supply system 10, information module 100 receives and provides information regarding the wheat.

It will be additionally understood that for certain complex nutritional substances such as a frozen ready-to-eat dinner, a plurality of nutritional substances may travel through nutritional substance supply system 10 to be transformed by transformation module 400 into the complete ready-to-eat dinner which is eventually conditioned by conditioning module 500. The plurality of nutritional substances used to form the ready-to-eat dinner would each be tracked through nutritional substance supply system 10, where information module 100 receives and provides information regarding the component nutritional substances used in the ready-to-eat dinner.

Information module 100 can be implemented as a computer hosted database such as a flat database, or a relational database. Preferably, information module 100 is a multi-dimensional database.

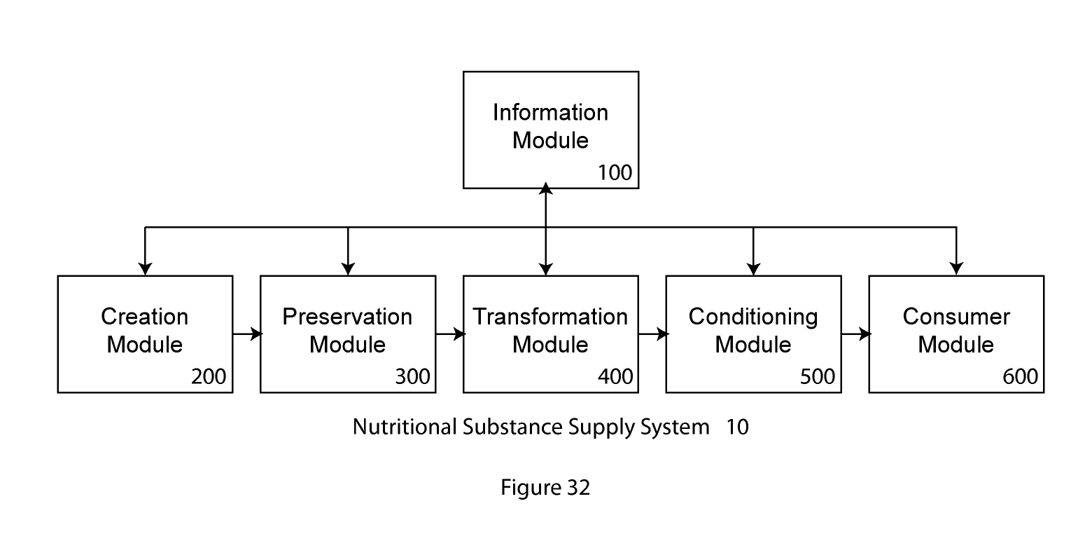

In FIG. 32, information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Additionally, information module 100 can provide such collected information to the other modules, as well as outside parties not part of nutritional substance industry 10

Creation module 200 collects information regarding a particular nutritional substance, such as information regarding the genesis of the nutritional substance, information regarding the growing or raising of the nutritional substance, information regarding the harvesting or slaughtering of the nutritional substance, and where the nutritional substance was delivered. This creation information can be delivered by creation module 200 to information module 100 by means of a communications network such as a telecommunications network and, preferably, a wireless telecommunications network.

For example, if the nutritional substance is corn, the farmer would collect information regarding the seed that was planted, the location and soil the seed was planted in, the water used for irrigation, and any fertilizers or pesticides used in growing the corn. Additionally, creation information as to when the corn was planted and when it was harvested and to whom the corn was delivered could also be collected. The farmer would provide such information to information module 100.

In the case where nutritional substance is beef hamburger meet, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered. All such creation information would be provided by the rancher to information module 100.

Preservation module 300 preserves nutritional substance during its journey from the creation module 200 to the transformation module 400. However, it is understood that preservation module 300 may be located between any two modules for the transfer of nutritional substance between those modules. For example, not only does the nutritional substance need to be preserved between creation module 200 and transformation module 400, it also needs to be preserved between transformation module 400 and conditioning module 500. Preservation module 300 obtains creation information regarding the nutritional substance from information module 100. Using that information, preservation module 300 optimizes the preservation of the nutritional substance so as to preserve or improve the organoleptic and nutritional properties of the nutritional substance.

Additionally, preservation module 300 provides information to information module 100 regarding the nutritional substance during the time it is being preserved and shipped to transformation module 400. This information could include the condition of the nutritional substance when it was received for preservation, the condition of the nutritional substance during its preservation, and the condition of the nutritional substance at the end of its preservation. Additionally, such preservation information could include the environmental conditions outside the preservation module 300 during the period of preservation and shipment. Preservation module 300 could also provide information regarding the interior conditions of preservation module 300 during the preservation and shipment of the nutritional substance. Finally, if preservation module 300 dynamically modified its preservation of the nutritional substance during its preservation and shipment, information regarding how preservation module 300 dynamically modified itself during the period of preservation and shipment could be provided to information module 100.

In the case where the nutritional substance is bananas, preservation 300 could provide to information module 100 information about the current state of the bananas, as well as the exterior and interior conditions of preservation module 300, as well modifications preservation module 300 made to itself to ripen the bananas during preservation so as to meet optimize organoleptic and nutritional properties when the bananas arrive at the grocery store.

In the case where the nutritional substance is beef which is being aged during the period it is preserved by preservation module 300, preservation module 300 could provide information module 100 with information regarding the condition of the beef from the time of its delivery to preservation module 300, through the time the beef was preserved by preservation module 300, to when it was removed from preservation module 300. This preservation information provided to information module 100 could be used by the conditioner of the beef, such as a restaurant, to determine how to properly cook the beef Transformation module 400 could retrieve from information module 100 both creation information provided by creation module 200 and preservation information provided by preservation module 300. Transformation module 400 could use such creation information and preservation information to dynamically modify the transformation of the nutritional substance. Additionally, transformation module 400 could provide information module 100 with transformation information.

In the case where the nutritional substance is sweet corn which is to be cooked and canned for consumer consumption, transformation module 400 could use the creation information regarding the composition of the corn, including its nutrients and additives, to determine how to transform the corn so as to preserve or improve organoleptic and nutritional properties. Transformation module 400 could also use preservation information regarding the corn to modify the transformation in response to changes to the corn which occurred during preservation. The information regarding how the corn was transformed in transformation module 400, such as cooking temperatures and duration and substances added to the canned corn, could be provided by transformation module 400 to information module 100.

Conditioning module 500 receives information regarding the nutritional substance from information module 100. This information could include creation information provided by creation module 200, preservation information provided by preservation module 300, and transformation information from transformation module 400. Additionally, conditioning module 500 could receive recipe information from information module 100. All such information could be used by conditioning module 500 in the conditioning of the nutritional substance. Conditioning module 500 can provide information module 100 with conditioning information regarding how the nutritional substance was conditioned, as well as measured or sensed information as to the state of the nutritional substance before, during and upon completion of conditioning.

In the example of a frozen ready-to-eat dinner, conditioning module 500 could use such information provided by information module 100 to optimize the conditioning of the nutritional substance by conditioning module 500. Conditioning module 500 could dynamically modify the conditioning of the nutritional substance in response to information it receives from information module 100 regarding the organoleptic and nutritional properties of the nutritional substance. Conditioning module 500 could use information about the corn and beef in the dinner to modify the defrosting and cooking the dinner.

Consumer module 600 obtains consumer information from the consumer of the nutritional substance. Such consumer information could include feedback from the consumer as to the quality and taste of the nutritional substance. Consumer module 600 provides such information to information module 100. Information module 100 correlates this information with all the information provided regarding the nutritional substance and provides some or all consumer information to the various modules in nutritional substance supply system 10. Each module in the nutritional substance supply system 10 could use such consumer information to modify and/or improve its operation. Additionally, consumer module 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, and/or marketing of nutritional substances.

It should be understood that nutritional substances do not need to necessarily pass through all the modules in nutritional substance supply system 10. For example, produce grown and sold to a consumer at the farm would only pass through creation module 200 and consumer module 600. Bananas grown on a plantation and shipped to a grocery store may only pass through creation module 200 and preservation module 300 before being consumed by consumer in consumer module 600. In the case where the nutritional substance is brussels sprouts, the brussels sprouts would have creation information provided by creation module 200, preservation information from preservation module 300, and conditioning information from conditioning module 500 before being delivered to consumer module 600.

In the case where the nutritional substance can be consumed following transformation by transformation module 400 without the need for conditioning by conditioning module 500, the nutritional substance would pass directly from transformation module 400 to consumer module 600. In the case of dried cranberries, creation information from creation module 200, the cranberry grower, would be provided to information module 100. Preservation information from preservation module 300 would be provided to information module regarding the preservation of the cranberries during their trip from the cranberry grower to transformation module 400, the dried fruit processor. Transformation information regarding the drying of the cranberries by transformation module 400 would be provided to information module 100. An additional preservation module 300 would preserve the dried cranberries during their trip from the dried fruit processor to the consumer in consumer module 600. In this case, there would be no conditioning module 500 in nutritional substance supply system 10, as the dried cranberries do not necessarily need to be conditioned before consumption.

It will also be understood that nutritional substances may pass through nutritional substance supply system 10 more than one time. In the case of the nutritional substance being wheat flour which is eventually used to make bread, the wheat grain may pass through conditioning module 200, preservation module 300, and transformation module 400 to become wheat flour. The flour can then be passed to a preservation module 300 for delivery to a transformation module 400 which prepares bread dough, for conditioning in a conditioning module 500, which bakes the dough into bread for consumer module 600. During the wheat's multiple trips through nutritional substance supply system 10, information module 100 receives and provides information regarding the wheat.

It will be additionally understood that for certain complex nutritional substances such as a frozen ready-to-eat dinner, a plurality of nutritional substances may travel through nutritional substance supply system 10 to be transformed by transformation module 400 into the complete ready-to-eat dinner which is eventually conditioned by conditioning module 500. The plurality of nutritional substances used to form the ready-to-eat dinner would each be tracked through nutritional substance supply system 10, where information module 100 receives and provides information regarding the component nutritional substances used in the ready-to-eat dinner.

Information module 100 can be implemented as a computer hosted database such as a flat database, or a relational database. Preferably, information module 100 is a multi-dimensional database.

Information module 100 may also contain information regarding the consumer of the nutritional substance. This information could include the consumer's medical history, current physical condition, including height, weight and BMI. Additional consumer information could include specific dietary needs, such as vitamin and mineral levels and food allergies. Additional consumer information could include food preferences, such as disliking cilantro or preferring well-cooked meat, or al dente pasta. Dietary preferences could also include whether the consumer is vegetarian, vegan, kosher, macrobiotic, gluten free, etc. Additional consumer information could include current dietary programs such as being on a diet, such as the South Beach diet, the Atkins diet, the Weight Watchers diet, or a diet provided by the consumer's physician.

Information module 100 could track the nutritional substances consumed to track and manage the diets of consumers. For example, a consumer who is on dialysis must manage the levels of certain chemicals in their blood for the dialysis to be effective. Information module 100 could track such information regarding nutritional substances being consumed. Additionally, information module 100 could provide information to consumer module 600 to assist in nutritional substance selection, including menu planning This could include not only suggestions as to nutritional substances to be consumed, but also nutritional substances that should not be consumed. Further, such information from information module 100 could allow consumer module 600 to suggest compromises in the selection of nutritional substances.

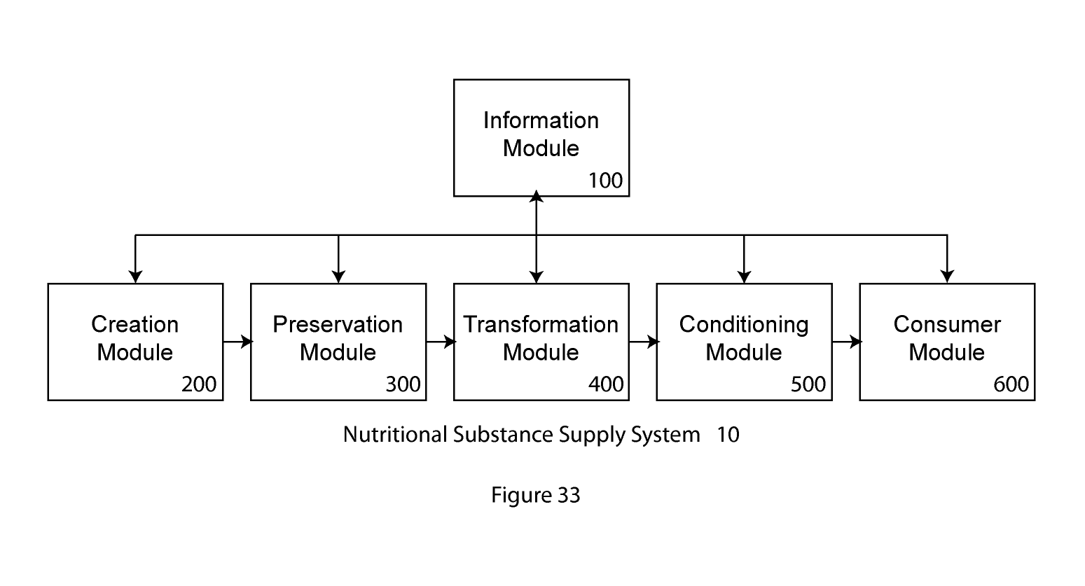

In FIG. 33, Information module 100 is operably connected to at least one of the following modules: creation module 200, preservation module 300, transformation module 400, conditioning module 500, and consumer module 600. Each module collects information from its associated tasks regarding a nutritional substance and provides such information to information module 100. Additionally, information module 100 can provide such collected information to the other modules, as well as outside parties not part of nutritional substance industry 10

Creation module 200 collects information regarding a particular nutritional substance, such as information regarding the genesis of the nutritional substance, information regarding the growing or raising of the nutritional substance, information regarding the harvesting or slaughtering of the nutritional substance, and where the nutritional substance was delivered. This creation information can be delivered by creation module 200 to information module 100 by means of a communications network such as a telecommunications network and, preferably, a wireless telecommunications network.

For example, if the nutritional substance is corn, the farmer would collect information regarding the seed that was planted, the location and soil the seed was planted in, the water used for irrigation, and any fertilizers or pesticides used in growing the corn. Additionally, creation information as to when the corn was planted and when it was harvested and to whom the corn was delivered could also be collected. The farmer would provide such information to information module 100.

In the case where nutritional substance is beef hamburger meet, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered. All such creation information would be provided by the rancher to information module 100.

Preservation module 300 preserves nutritional substance during its journey from the creation module 200 to the transformation module 400. However, it is understood that preservation module 300 may be located between any two modules for the transfer of nutritional substance between those modules. For example, not only does the nutritional substance need to be preserved between creation module 200 and transformation module 400, it also needs to be preserved between transformation module 400 and conditioning module 500. Preservation module 300 obtains creation information regarding the nutritional substance from information module 100. Using that information, preservation module 300 optimizes the preservation of the nutritional substance so as to preserve or improve the organoleptic and nutritional properties of the nutritional substance.

Additionally, preservation module 300 provides information to information module 100 regarding the nutritional substance during the time it is being preserved and shipped to transformation module 400. This information could include the condition of the nutritional substance when it was received for preservation, the condition of the nutritional substance during its preservation, and the condition of the nutritional substance at the end of its preservation. Additionally, such preservation information could include the environmental conditions outside the preservation module 300 during the period of preservation and shipment. Preservation module 300 could also provide information regarding the interior conditions of preservation module 300 during the preservation and shipment of the nutritional substance. Finally, if preservation module 300 dynamically modified its preservation of the nutritional substance during its preservation and shipment, information regarding how preservation module 300 dynamically modified itself during the period of preservation and shipment could be provided to information module 100.

In the case where the nutritional substance is bananas, preservation 300 could provide to information module 100 information about the current state of the bananas, as well as the exterior and interior conditions of preservation module 300, as well modifications preservation module 300 made to itself to ripen the bananas during preservation so as to meet optimize organoleptic and nutritional properties when the bananas arrive at the grocery store.

In the case where the nutritional substance is beef which is being aged during the period it is preserved by preservation module 300, preservation module 300 could provide information module 100 with information regarding the condition of the beef from the time of its delivery to preservation module 300, through the time the beef was preserved by preservation module 300, to when it was removed from preservation module 300. This preservation information provided to information module 100 could be used by the conditioner of the beef, such as a restaurant, to determine how to properly cook the beef Transformation module 400 could retrieve from information module 100 both creation information provided by creation module 200 and preservation information provided by preservation module 300. Transformation module 400 could use such creation information and preservation information to dynamically modify the transformation of the nutritional substance. Additionally, transformation module 400 could provide information module 100 with transformation information.

In the case where the nutritional substance is sweet corn which is to be cooked and canned for consumer consumption, transformation module 400 could use the creation information regarding the composition of the corn, including its nutrients and additives, to determine how to transform the corn so as to preserve or improve organoleptic and nutritional properties. Transformation module 400 could also use preservation information regarding the corn to modify the transformation in response to changes to the corn which occurred during preservation. The information regarding how the corn was transformed in transformation module 400, such as cooking temperatures and duration and substances added to the canned corn, could be provided by transformation module 400 to information module 100.

Conditioning module 500 receives information regarding the nutritional substance from information module 100. This information could include creation information provided by creation module 200, preservation information provided by preservation module 300, and transformation information from transformation module 400. Additionally, conditioning module 500 could receive recipe information from information module 100. All such information could be used by conditioning module 500 in the conditioning of the nutritional substance. Conditioning module 500 can provide information module 100 with conditioning information regarding how the nutritional substance was conditioned, as well as measured or sensed information as to the state of the nutritional substance before, during and upon completion of conditioning.

In the example of a frozen ready-to-eat dinner, conditioning module 500 could use such information provided by information module 100 to optimize the conditioning of the nutritional substance by conditioning module 500. Conditioning module 500 could dynamically modify the conditioning of the nutritional substance in response to information it receives from information module 100 regarding the organoleptic and nutritional properties of the nutritional substance. Conditioning module 500 could use information about the corn and beef in the dinner to modify the defrosting and cooking the dinner.

Consumer module 600 obtains consumer information from the consumer of the nutritional substance. Such consumer information could include feedback from the consumer as to the quality and taste of the nutritional substance. Consumer module 600 provides such information to information module 100. Information module 100 correlates this information with all the information provided regarding the nutritional substance and provides some or all consumer information to the various modules in nutritional substance supply system 10. Each module in the nutritional substance supply system 10 could use such consumer information to modify and/or improve its operation. Additionally, consumer module 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, and/or marketing of nutritional substances.

It should be understood that nutritional substances do not need to necessarily pass through all the modules in nutritional substance supply system 10. For example, produce grown and sold to a consumer at the farm would only pass through creation module 200 and consumer module 600. Bananas grown on a plantation and shipped to a grocery store may only pass through creation module 200 and preservation module 300 before being consumed by consumer in consumer module 600. In the case where the nutritional substance is brussels sprouts, the brussels sprouts would have creation information provided by creation module 200, preservation information from preservation module 300, and conditioning information from conditioning module 500 before being delivered to consumer module 600.

In the case where the nutritional substance can be consumed following transformation by transformation module 400 without the need for conditioning by conditioning module 500, the nutritional substance would pass directly from transformation module 400 to consumer module 600. In the case of dried cranberries, creation information from creation module 200, the cranberry grower, would be provided to information module 100. Preservation information from preservation module 300 would be provided to information module regarding the preservation of the cranberries during their trip from the cranberry grower to transformation module 400, the dried fruit processor. Transformation information regarding the drying of the cranberries by transformation module 400 would be provided to information module 100. An additional preservation module 300 would preserve the dried cranberries during their trip from the dried fruit processor to the consumer in consumer module 600. In this case, there would be no conditioning module 500 in nutritional substance supply system 10, as the dried cranberries do not necessarily need to be conditioned before consumption.

It will also be understood that nutritional substances may pass through nutritional substance supply system 10 more than one time. In the case of the nutritional substance being wheat flour which is eventually used to make bread, the wheat grain may pass through conditioning module 200, preservation module 300, and transformation module 400 to become wheat flour. The flour can then be passed to a preservation module 300 for delivery to a transformation module 400 which prepares bread dough, for conditioning in a conditioning module 500, which bakes the dough into bread for consumer module 600. During the wheat's multiple trips through nutritional substance supply system 10, information module 100 receives and provides information regarding the wheat.

It will be additionally understood that for certain complex nutritional substances such as a frozen ready-to-eat dinner, a plurality of nutritional substances may travel through nutritional substance supply system 10 to be transformed by transformation module 400 into the complete ready-to-eat dinner which is eventually conditioned by conditioning module 500. The plurality of nutritional substances used to form the ready-to-eat dinner would each be tracked through nutritional substance supply system 10, where information module 100 receives and provides information regarding the component nutritional substances used in the ready-to-eat dinner.

Information module 100 can be implemented as a computer hosted database such as a flat database, or a relational database. Preferably, information module 100 is a multi-dimensional database.

Information module 100 may also contain information regarding the consumer of the nutritional substance. This information could include the consumer's medical history, current physical condition, including height, weight and BMI. Additional consumer information could include specific dietary needs, such as vitamin and mineral levels and food allergies. Additional consumer information could include food preferences, such as disliking cilantro or preferring well-cooked meat, or al dente pasta. Dietary preferences could also include whether the consumer is vegetarian, vegan, kosher, macrobiotic, gluten free, etc. Additional consumer information could include current dietary programs such as being on a diet, such as the South Beach diet, the Atkins diet, the Weight Watchers diet, or a diet provided by the consumer's physician.

Information module 100 could track the nutritional substances consumed to track and manage the diets of consumers. For example, a consumer who is on dialysis must manage the levels of certain chemicals in their blood for the dialysis to be effective. Information module 100 could track such information regarding nutritional substances being consumed. Additionally, information module 100 could provide information to consumer module 600 to assist in nutritional substance selection, including menu planning This could include not only suggestions as to nutritional substances to be consumed, but also nutritional substances that should not be consumed. Further, such information from information module 100 could allow consumer module 600 to suggest compromises in the selection of nutritional substances.

Information module 100 is preferably implemented as a massive, multidimensional database operated on multiple computing devices across an interconnecting network. Such a database could be hosted by a plurality of nutritional substance creators, preservers, transformers, conditioners, consumers. Preferably, information module 100 is maintained and operated by a global entity which operates the system for the benefit of all participants in the nutritional substance supply system 10. In such an information module 10, the global entity could be remunerated on a per-transaction basis for receiving nutritional substance information and/or providing nutritional substance information.

In another business model for the global entity operating information module 100, access to the module by participants in the supply chain could be at no charge. However, the global entity could receive remuneration for access by non-participants such as research and marketing organizations. Alternatively, participants in the supply chain could pay to advertise to other participants in the supply chain as part of their access to the information in information module 100.

Information transfer throughout nutritional substance supply system 10, to and from information module 100 can be accomplished through various computer information transmission systems, such as the internet. Such interconnection could be accomplished by wired networks and wireless networks, or some combination thereof. Wireless networks could include WiFi local area networks, Bluetooth networks, but preferably wireless telecommunication networks.

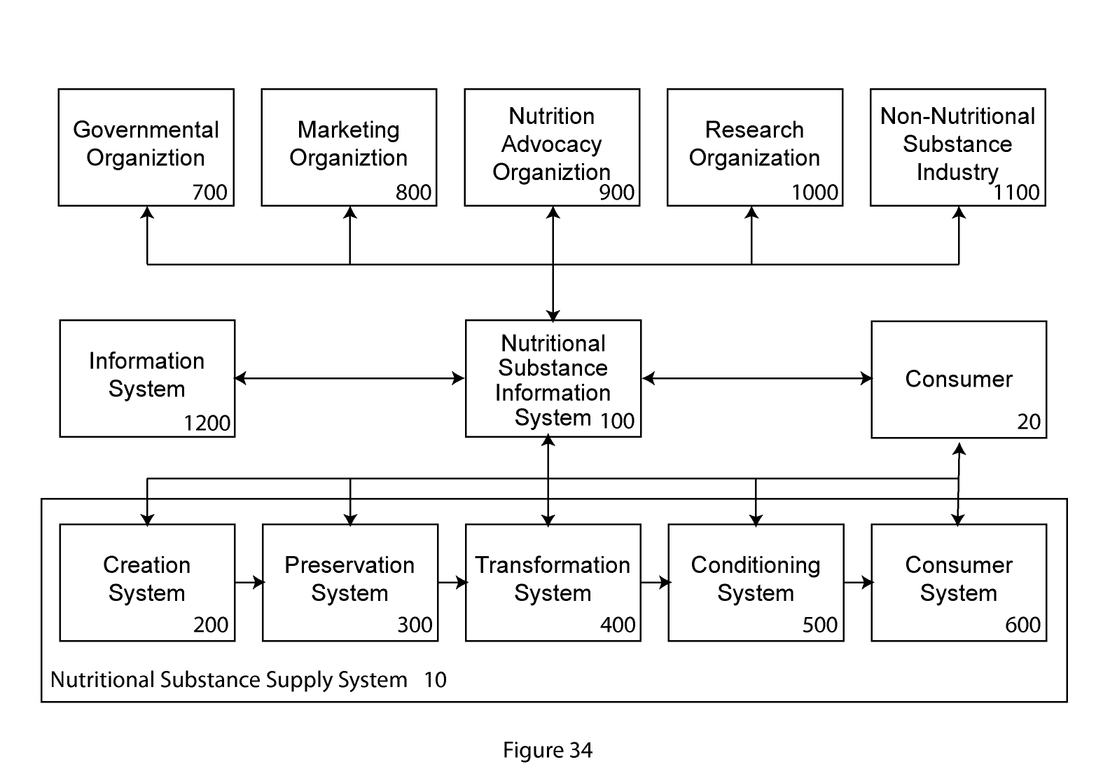

In FIG. 34, all the systems comprising nutritional substance supply system 10, including creation system 200, preservation system 300, transformation system 400, conditioning system 500, and consumer system 600, that are operably connected to nutritional substance information system 100 can additionally receive information from, and/or provide information to, governmental organization 700, marketing organization 800, nutrition advocacy organization 900, research organization 1000, non-nutritional substance industry 1100, information system 1200, and consumer 20 through nutritional substance information system 100.

Nutritional substance information system 100 receives and transmits information regarding a nutritional substance between each of the systems in the nutritional substance industry 10 including, the creation system 200, the preservation system 300, the transformation system 400, the conditioning system 500, and the consumer system 600. The nutritional substance information system 100 can be an interconnecting information transmission system which allows the transmission of information between some or all of the various systems. Nutritional substance information system 100 contains a database where the information regarding the nutritional substance resides.

Nutritional substance information system 100 is operably connected to at least one of the following systems: creation system 200, preservation system 300, transformation system 400, conditioning system 500, and consumer system 600. Each system collects information from its associated tasks regarding a nutritional substance and provides such information to nutritional substance information system 100. Additionally, nutritional substance information system 100 can provide such collected information to the other systems, as well as outside parties not part of nutritional substance industry 10

Creation system 200 collects information regarding a particular nutritional substance, such as information regarding the genesis of the nutritional substance, information regarding the growing or raising of the nutritional substance, information regarding the harvesting or slaughtering of the nutritional substance, and where the nutritional substance was delivered. This creation information can be delivered by creation system 200 to nutritional substance information system 100 by means of a communications network such as a telecommunications network and, preferably, a wireless telecommunications network.

For example, if the nutritional substance is corn, the farmer would collect information regarding the seed that was planted, the location and soil the seed was planted in, the water used for irrigation, and any fertilizers or pesticides used in growing the corn. Additionally, creation information as to when the corn was planted and when it was harvested and to whom the corn was delivered could also be collected. In the case of a wine maker the state of the soil the weather during the growing period of the vines, the state of ripeness at recollection and the description of the “torroir” land composition, inclination, weather conditions, fermentation and bottling techniques, etc. could all be incorporated. The farmer would provide such information to nutritional substance information system 100 and eventually the information could be automatically downloaded and monitored trough a telecommunications network and, preferably, a wireless telecommunications and or satellite network. This would be a significant contribution to discourage counterfeiting/tampering and increase the value of authentic natural ingredients. Additionally, it would serve as a tool to prevent identify epidemic outbreaks and control them early on at its origin.

In the case where nutritional substance is beef hamburger meet, the rancher would collect information regarding the lineage of the cow, where the cow was raised (open range, feed yard, etc.), what the cow was fed, the medical history of the cow, and what dietary supplements and drugs were given to the cow. The rancher would also collect information regarding the cow's date of birth and when the cow was sold or slaughtered. All such creation information would be provided by the rancher to nutritional substance information system 100.

Preservation system 300 preserves nutritional substance during its journey from the creation system 200 to the transformation system 400. However, it is understood that preservation system 300 may be located between any two systems for the transfer of nutritional substance between those systems. For example, not only does the nutritional substance need to be preserved between creation system 200 and transformation system 400, it also needs to be preserved between transformation system 400 and conditioning system 500. Preservation system 300 obtains creation information regarding the nutritional substance from nutritional substance information system 100. Using that information, preservation system 300 optimizes the preservation of the nutritional substance so as to preserve or improve the organoleptic and nutritional properties of the nutritional substance.

Additionally, preservation system 300 provides information to nutritional substance information system 100 regarding the nutritional substance during the time it is being preserved and shipped to transformation system 400. This information could include the condition of the nutritional substance when it was received for preservation, the condition of the nutritional substance during its preservation, and the condition of the nutritional substance at the end of its preservation. Additionally, such preservation information could include the environmental conditions outside the preservation system 300 during the period of preservation and shipment. Preservation system 300 could also provide information regarding the interior conditions of preservation system 300 during the preservation and shipment of the nutritional substance. Finally, if preservation system 300 dynamically modified its preservation of the nutritional substance during its preservation and shipment, information regarding how preservation system 300 dynamically modified itself during the period of preservation and shipment could be provided to nutritional substance information system 100.

In the case where the nutritional substance is bananas, preservation 300 could provide to nutritional substance information system 100 information about the current state of the bananas, as well as the exterior and interior conditions of preservation system 300, as well modifications preservation system 300 made to itself to ripen the bananas during preservation so as to meet optimize organoleptic and nutritional properties when the bananas arrive at the grocery store.

In the case where the nutritional substance is beef which is being aged during the period it is preserved by preservation system 300, preservation system 300 could provide nutritional substance information system 100 with information regarding the condition of the beef from the time of its delivery to preservation system 300, through the time the beef was preserved by preservation system 300, to when it was removed from preservation system 300. This preservation information provided to nutritional substance information system 100 could be used by the conditioner of the beef, such as a restaurant, to determine how to properly cook the beef.

Transformation system 400 could retrieve from nutritional substance information system 100 both creation information provided by creation system 200 and preservation information provided by preservation system 300. Transformation system 400 could use such creation information and preservation information to dynamically modify the transformation of the nutritional substance. Additionally, transformation system 400 could provide nutritional substance information system 100 with transformation information.

In the case where the nutritional substance is sweet corn which is to be cooked and canned for consumer consumption, transformation system 400 could use the creation information regarding the composition of the corn, including its nutrients and additives, to determine how to transform the corn so as to preserve or improve organoleptic and nutritional properties. Transformation system 400 could also use preservation information regarding the corn to modify the transformation in response to changes to the corn which occurred during preservation. The information regarding how the corn was transformed in transformation system 400, such as cooking temperatures and duration and substances added to the canned corn, could be provided by transformation system 400 to nutritional substance information system 100.

Conditioning system 500 receives information regarding the nutritional substance from nutritional substance information system 100. This information could include creation information provided by creation system 200, preservation information provided by preservation system 300, and transformation information from transformation system 400. Additionally, conditioning system 500 could receive recipe information from nutritional substance information system 100. All such information could be used by conditioning system 500 in the conditioning of the nutritional substance. Conditioning system 500 can provide nutritional substance information system 100 with conditioning information regarding how the nutritional substance was conditioned, as well as measured or sensed information as to the state of the nutritional substance before, during and upon completion of conditioning.

In the example of a frozen ready-to-eat dinner, conditioning system 500 could use such information provided by nutritional substance information system 100 to optimize the conditioning of the nutritional substance by conditioning system 500. Conditioning system 500 could dynamically modify the conditioning of the nutritional substance in response to information it receives from nutritional substance information system 100 regarding the organoleptic and nutritional properties of the nutritional substance. Conditioning system 500 could use information about the corn and beef in the dinner to modify the defrosting and cooking the dinner.

Consumer system 600 obtains consumer information from the consumer of the nutritional substance. Such consumer information could include feedback from the consumer as to the quality and taste of the nutritional substance. Consumer system 600 provides such information to nutritional substance information system 100. Nutritional substance information system 100 correlates this information with all the information provided regarding the nutritional substance and provides some or all consumer information to the various systems in nutritional substance supply system 10. Each system in the nutritional substance supply system 10 could use such consumer information to modify and/or improve its operation. Additionally, consumer system 600 could obtain information from the consumer as to the effectiveness of the marketing of the nutritional substance consumed. This information can also be provided to others for general consumer satisfaction information for other purposes, such as development of new nutritional substances, modification of existing nutritional substances, discontinuation of nutritional substances, and/or marketing of nutritional substances.

It should be understood that nutritional substances do not need to necessarily pass through all the systems in nutritional substance supply system 10. For example, produce grown and sold to a consumer at the farm would only pass through creation system 200 and consumer system 600. Bananas grown on a plantation and shipped to a grocery store may only pass through creation system 200 and preservation system 300 before being consumed by consumer in consumer system 600. In the case where the nutritional substance is Brussels sprouts, the Brussels sprouts would have creation information provided by creation system 200, preservation information from preservation system 300, and conditioning information from conditioning system 500 before being delivered to consumer system 600.

In the case where the nutritional substance can be consumed following transformation by transformation system 400 without the need for conditioning by conditioning system 500, the nutritional substance would pass directly from transformation system 400 to consumer system 600. In the case of dried cranberries, creation information from creation system 200, the cranberry grower, would be provided to nutritional substance information system 100. Preservation information from preservation system 300 would be provided to nutritional substance information system regarding the preservation of the cranberries during their trip from the cranberry grower to transformation system 400, the dried fruit processor. Transformation information regarding the drying of the cranberries by transformation system 400 would be provided to nutritional substance information system 100. An additional preservation system 300 would preserve the dried cranberries during their trip from the dried fruit processor to the consumer in consumer system 600. In this case, there would be no conditioning system 500 in nutritional substance supply system 10, as the dried cranberries do not necessarily need to be conditioned before consumption.

It will also be understood that nutritional substances may pass through nutritional substance supply system 10 more than one time. In the case of the nutritional substance being wheat flour which is eventually used to make bread, the wheat grain may pass through conditioning system 200, preservation system 300, and transformation system 400 to become wheat flour. The flour can then be passed to a preservation system 300 for delivery to a transformation system 400 which prepares bread dough, for conditioning in a conditioning system 500, which bakes the dough into bread for consumer system 600. During the wheat's multiple trips through nutritional substance supply system 10, nutritional substance information system 100 receives and provides information regarding the wheat.

It will be additionally understood that for certain complex nutritional substances such as a frozen ready-to-eat dinner, a plurality of nutritional substances may travel through nutritional substance supply system 10 to be transformed by transformation system 400 into the complete ready-to-eat dinner which is eventually conditioned by conditioning system 500. The plurality of nutritional substances used to form the ready-to-eat dinner would each be tracked through nutritional substance supply system 10, where nutritional substance information system 100 receives and provides information regarding the component nutritional substances used in the ready-to-eat dinner.

Nutritional substance information system 100 can be implemented as a computer hosted database such as a flat database, or a relational database. Preferably, nutritional substance information system 100 is a multi-dimensional database.

Nutritional substance information system 100 may also contain information regarding the consumer of the nutritional substance. This information could include the consumer's medical history, current physical condition, including height, weight and BMI. Additional consumer information could include specific dietary needs, such as vitamin and mineral levels and food allergies. Additional consumer information could include food preferences, such as disliking cilantro or preferring well-cooked meat, or al dente pasta. Dietary preferences could also include whether the consumer is vegetarian, vegan, kosher, macrobiotic, gluten free, etc. Additional consumer information could include current dietary programs such as being on a diet, such as the South Beach diet, the Atkins diet, the Weight Watchers diet, or a diet provided by the consumer's physician.

Nutritional substance information system 100 could track the nutritional substances consumed to track and manage the diets of consumers. For example, a consumer who is diabetic, allergic to gluten or on dialysis must manage the levels of certain chemicals in their blood for the dialysis to be effective. Nutritional substance information system 100 could track such information regarding nutritional substances being consumed. Additionally, nutritional substance information system 100 could provide information to consumer system 600 to assist in nutritional substance selection, including menu planning This could include not only suggestions as to nutritional substances to be consumed, but also nutritional substances that should not be consumed. Further, such information from nutritional substance information system 100 could allow consumer system 600 to suggest compromises in the selection of nutritional substances.

Nutritional substance information system 100 is preferably implemented as a global massive, multidimensional database operated on multiple computing devices across an interconnecting network. Such a database could be hosted by a plurality of nutritional substance creators, preservers, transformers, conditioners, consumers. Preferably, nutritional substance information system 100 is maintained and operated by a global entity which operates the system for the benefit of all participants in the nutritional substance supply system 10. In such an nutritional substance information system 10, the global entity could be remunerated on a per-transaction basis for receiving nutritional substance information and/or providing nutritional substance information, trough-out its lifecycle form its origin to consumption and could be monitored traced through a data base and or real time tough a satellite system.

In another business model for the global entity operating nutritional substance information system 100, access to the system by participants in the supply chain could be at no charge. However, the global entity could receive remuneration for access by non-participants such as research and marketing organizations. Alternatively, participants in the supply chain could pay to advertise to other participants in the supply chain as part of their access to the information in nutritional substance information system 100.

Information transfer throughout nutritional substance supply system 10, to and from nutritional substance information system 100 can be accomplished through various computer information transmission systems, such as the internet. Such interconnection could be accomplished by wired networks and wireless networks, or some combination thereof. Wireless networks could include WiFi local area networks, Bluetooth networks, but preferably wireless telecommunication networks.

Nutritional substance information system 100 can also be operably connected to consumer 20. Consumer 20 can be an individual, a collection of individuals, or an organization of individuals. If consumer 20 is an individual, consumer 20 could provide information to nutritional substance information system 100 by means of manual entry through a computer interface. Preferably the information could be provided by automatic data collection from consumer's 20 consumption, preparation, feedback, biometric data, or medical assessment. Consumer 20 can utilize information stored in nutritional substance information system 100 through a computer interface. Preferably, consumer 20 could utilize information from nutritional substance information system 100 in automated fashion through selection of nutritional substances to be consumed, preparation of nutritional substances, including creation, preservation, transformation, and conditioning.

For example, consumer 20 could provide biometric (such as BMI) and medical information along with consumption information to nutritional substance information system 100. Such information could be correlated so as to provide consumer 20, information on selection and preparation of future nutritional substances to be consumed by consumer, to minimize or maximize the organoleptic and/or nutritional properties of selected nutritional substances. In the circumstance of consumer 20 being diabetic, as indicated by consumer's 20 biometric and medical information, nutritional substance information system 100 could provide nutritional substance suggestions and/or nutritional substance preparation techniques so as to provide a nutritional substance diet which is non-detrimental, and is advantageous for such a medical condition. Additionally, if consumer 20 has provided nutritional substance information system 100 with nutritional substance preferences and/or nutritional substance preparation preferences, nutritional substance information system 100 can suggest nutritional substance selection choices and nutritional substance preparation choices which could encourage consumer 20 to consume non-detrimental or advantageous nutritional substances. Additionally, if consumer 20 would provide biometric information prior to and following consumption of a nutritional substance, such as blood sugar level information, nutritional substance information system 100 could record and correlate such information for use in future nutritional substance selection and preparation.

Preferably, nutritional substance information system 100 could receive such consumer information from a plurality of consumers. Nutritional substance information system 100 could analyze and correlate such information for consumers to identify trends, techniques, and/or classes of nutritional substances or nutritional substance preparation techniques which might benefit consumer 20. For example, nutritional substance information system 100, in analyzing information from a plurality of consumers 20, could determine that individuals with diabetes would benefit from a diet high in whole grain cereals. Nutritional substance information system 100 would then suggest to a consumer 20 who fits in the group of such diabetic consumers 20 a diet high in whole grain cereals.

Consumer 20 can also be operably connected to consumer system 600. Consumer 20 can receive nutritional substances from consumer system 600, located within nutritional substance supply system 10. Consumer 20 can receive information regarding the nutritional substance from consumer system 600, and provide feedback regarding the nutritional substance to consumer system 600. Consumer system 600 can provide such feedback, consumer information, to nutritional substance information system 100 correlated to the nutritional substance provided to consumer 20.

Governmental organization 700 could provide to nutritional substance information system 100 a variety of information collected by governmental organizations. This could include any of the following information: information regarding location of nutritional substance creation, environmental information about the location of nutritional substance creation, including weather, geographic information on nutritional substance preservation and transformation, geo-political, socio-economic, and industry economic information on nutritional substances created, preserved, transformed, conditioned and consumed within the governmental organization's geographic area. Governments routinely collect this information for governmental and non-governmental purposes. Some of such information may already be correlated for use in nutritional substance information system 100, but any such non-correlated information could be correlated and analyzed by nutritional substance information system 100.

For example, the government of Columbia collects and tracks information about its country, including information specific to nutritional substances created, preserved, transformed, conditioned and consumed within and outside the country of Columbia. Additionally, the government of Columbia collects and tracks information regarding geographic uses of its land and resources, geological and meteorological information, information regarding the political and economic conditions within its boundaries, and information regarding industries within its boundaries. In a specific example, Columbia collects and tracks information regarding its coffee bean industry, including information on growers, processors, and distributors of coffee beans within its boundaries. Additionally, Columbia collects and tracks information on the national and international coffee bean industry. The government of Columbia could provide such information to nutritional substance information system 100.

Governmental organization 700 could receive information from nutritional substance information system 100. In the example of the government of Columbia, the government could use such information regarding the use of nutritional substance to plan and manage public health and assist in developing and promoting socio-economic systems, including specific nutritional substance industries. In the coffee bean example, the government of Columbia could predict worldwide trends in coffee consumption and assist its coffee bean industry in meeting those needs to maximize the country's economic goals.

Marketing organization 800 can provide nutritional substance information system 100 with information regarding the various markets for nutritional substances, including both current and historic data on such markets. Additionally, marketing organization 800 could provide information on past, present and future marketing campaigns and programs. In the case of coffee beans marketing organization 800 could provide information on the worldwide coffee market, including information on consumption, historical demand, and/or projected future demand of various varieties of coffee beans on a worldwide, regional, and/or local basis. Marketing organization 800 could also provide information on various marketing campaigns and strategies related to coffee beans. Also, future marketing campaigns, programs and/or strategies could be provided to nutritional substance information system 100. Specifically, marketing organization 800 could provide information on the consumption of Columbian grown coffee beans in the United States, information on prior marketing efforts of Columbian grown coffee beans in the United States, and, finally, a proposed program for such marketing in the future.

Marketing organization 800 could receive from nutritional substance information system 100, information on historical, current, and projected consumption of a nutritional substance, as well as factors influencing the growing, preservation, transformation, conditioning, and consumption of the nutritional substance on a global, regional, and/or local basis. Marketing organization 800 could also receive information on the effectiveness of various marketing campaigns, programs and/or strategies implemented by marketing organization 800. This information could be obtained from the various other sources in the network of systems, organizations, and consumers connected to nutritional substance information system 100.

In the example of Columbian coffee beans, marketing organization 800 could receive information on the consumption of Columbian coffee, and consumer marketing research on the effectiveness of prior and current marketing efforts for Columbian coffee beans. Nutritional substance information system 100 could correlate and analyze consumption information in the United States over the period and following the Columbian coffee grower's campaign using the fictional character Juan Valdez.

Nutritional advocacy organization 900 provides nutritional substance information system 100 with information regarding past goals and objectives, current goals and objectives, and contemplated future goals and objectives for individual, group, worldwide consumers of nutritional substances. These goals and objectives could include means for meeting organoleptic and/or nutritional parameters for an individual, group, worldwide consumers. Additionally, such goals and objectives could include nutritional substance sustainability, ecosystem stability, socioeconomic stability, and/or political stability.

For example, a nutritional advocacy organization 900 has goals and objectives regarding reducing the amount of fat in the American diet. Nutritional advocacy organization 900 could provide such a goal of reducing fat to nutritional substance information system 100. Nutritional substance information system 100 could provide such a goal to other organizations, industries, information systems and the nutritional substance supply system 10. Nutritional substance supply system 10 could use such information to modify the creation, preservation, transformation and conditioning of nutritional substances to assist in meeting the goal of reducing fat in the American diet. Consumer system 600 could receive feedback from consumer 20 on the effect of meeting such a goal from nutritional advocacy organization 900. For example, consumer system 600 could provide information on whether consumer 20 is selecting and consuming low-fat nutritional substances and their satisfaction/dissatisfaction with such nutritional substances.

Nutritional advocacy organization 900 could receive from nutritional substance information system 100, information regarding the success or failure in meeting nutritional advocacy organization' 900 goals and objectives. In the reducing fat in the American diet example, nutritional advocacy organization 900 could receive information from the nutritional substance supply system 10 as to any changes in the creation, preservation, transformation, condition and consumption of low-fat nutritional substances for the American market. It could also receive information from consumer 20, as to consumer's 20 consumption of such low-fat nutritional substances. From this information provided by nutritional substance information system 100, nutritional advocacy organizations could gauge the effectiveness of their campaign to reduce fat in the American diet. Using this information, nutritional advocacy organization 900 could continue, modify, or discontinue this program, and/or plan future programs.

Research organization 1000 could provide information to nutritional substance information system 100 regarding research they have conducted on nutritional substances, consumers, geography, logistics, consumption, socio-economics, politics, ecology, and their interconnection. Such research organization 1000 could include “think tank” research organizations, industry organizations, consumer organizations, marketing research organizations, educational institutions, and governmental research organizations. Research organization 1000 could include both nutritional substance related research organizations and non-nutritional substance research organizations. For example, the University of California at Davis has an extensive research organization into the creation, preservation, transformation, conditioning of grapes and wine. UC Davis could provide such information to nutritional substance information system 100, which could correlate such research information with information regarding grapes and wine provided by creation system 200, preservation system 300, transformation system 400, conditioning system 500, consumer system 600, and consumer 20.

Research organization 1000 can receive from nutritional substance information system 100 information related to the research conducted by research organization 1000. For example, UC Davis could receive information from nutritional substance supply system 10 and consumer 20 to use in its collection and analysis of research it is conducting regarding the grape and wine industry.

Non-nutritional substance industry 1100 could provide nutritional substance information system 100 with information not related to nutritional substances, but useful in analyzing and utilizing information related to nutritional substances. For example, the housing industry could provide information as to where homes have been built, are being built, and are being planned for future construction. This information can be correlated by nutritional substance information system 100 and used by nutritional substance supply system 10 to plan where nutritional substances should be created, how nutritional substances should be preserved for shipment to such homes, how nutritional substances should be transformed for consumption in such homes, what conditioning systems should be located within such homes, and how consumer information should be collected by consumer system 600 in such homes.

Non-nutritional substance industry 1100 could receive information from nutritional substance information system 100 from information from nutritional substance supply system 10 to manage and plan non-nutritional substance industry 1100 factors affected by nutritional substance supply system 10. For example, in the housing industry, home locations and designs could be affected by information regarding where nutritional substances are created, preserved and transformed. In order to preserve organoleptic and nutritional properties of certain nutritional substances, the housing industry could locate homes near creation systems 200 and transformation systems 400. Additionally, the housing industry could design homes which include conditioning systems and consumer systems from information provided by nutritional substance supply system 10, through nutritional substance information system 100.

Information system 1200 could provide information to nutritional substance information system 100. For example, Google Earth could provide a wealth of geographic, geopolitical, and satellite reconnaissance information to nutritional substance information system 100 for correlation with nutritional substance information from other organizations, industries, nutritional substance supply system 10, and consumer 20. Such information from Google Earth correlated with nutritional substance information could be used by governmental organization 700, marketing organization 800, nutrition advocacy organization 900, research organization 1000, non-nutritional substance industry 1100, nutritional substance supply system 10, and consumer 20.

Information system 1200 could receive information from nutritional substance information system 100 for use and correlation with information in information system 1200. For example, Google Earth could use information regarding the locations of creation of nutritional substances provided by creation system 200. Google Earth could map worldwide corn cultivation using information from nutritional substance information system 100 provided by farmers through creation system 200.

Government organization 700, marketing organization 800, nutritional advocacy organization 900, research organization 1000, non-nutritional substance industry 1100, and information system 12 are preferably a plurality of such organizations, industries and/or systems. It will be understood that the various organizations, industries and systems connected to nutritional substance information system 100 are examples of such organizations, industries and systems, and many additional organizations, industries and systems could be connected to nutritional substance information system 100.

Preferably, all such organizations, industries, systems, and consumers are operably interconnected to nutritional substance information system 100 by a computer networks. Preferably, such networks are accomplished over telecommunications systems, preferably wireless telecommunication system.

Consumer 20 goals, needs, preferences and values could be optimized through the use of information provided by nutritional substance information system 100 and/or could be furthered by providing such information to the various organizations, industries, information systems, and nutritional substance supply system 10. For example, if consumer 20 desires to eat only wild salmon, nutritional substance information system 100 could provide consumer 20 with information to allow consumer 20 to select and consume only wild salmon, avoiding farm-raised salmon. Such a consumer preference for wild salmon could be used by nutritional substance supply system 10 in making decisions on the source of salmon available to consumers.

In another example, consumer 20 may desire, following consumer's 20 political values, to only consume coffee that is grown in fair-trade, sustainable conditions. Nutritional substance information system 100 could provide information to consumer 20 to allow consumer 20 only to select and consume such products which meet consumer's 20 political values. Additionally, consumer's 20 political values which influencing consumer's 20 selection and consumption of coffee, could be collected by nutritional substance information system 100 and provided to nutritional substance supply system 10 to affect how coffee beans are produced.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. Any claims intended to be treated under 35 U.S.C. §112, ¶ 6 will begin with the words “means for.” Accordingly, the applicant reserves the right to add additional claims after filing the application to pursue such additional claim forms for other aspects of the invention.

1. An information identification system for nutritional substances comprising:
information relating to particular nutritional substance;
information storage the information;
an identifier on or part of a particular nutritional substance;
identifier reader for reading the identifier; and
retrieval obtaining information regarding the particular nutritional substance from the means for storage.

2. An information identification system for nutritional substances comprising:
Information relating to particular nutritional substance;
means for storing the information;
an identifier on or part of a particular nutritional substance;
means for reading the identifier; and
means obtaining information regarding the particular nutritional substance from the means for storage.

3. A nutritional substance tracking system for tracking the nutritional, organoleptic and/or aesthetic values of a nutritional substance at creation of said nutritional substance, comprising:
information related to said nutritional, organoleptic and/or aesthetic values of said nutritional substance;
identifier associated with said nutritional substance;
information storage containing said information referenced to said identifier;
reader for obtaining the identifier;
retriever for retrieving said formation from said information storage using said identifier.

4. A method of tracking a nutritional substance comprising the steps of:
obtaining source information for a particular nutritional substance;
identifying said nutritional substance;
associating said source information with said identified nutritional substance.

5. A preservation system for nutritional substances comprising:
adaptive preserver for adaptively preserving a nutritional substance;
sensor for sensing an attribute of the nutritional substance;
attribute storage for storing the attribute;
wherein the adaptive preserver preserves said nutritional substance in response to the internal attribute of the nutritional substance.

6. A nutritional substance tracking system for tracking the nutritional, organoleptic and/or aesthetic values of a nutritional substance at creation of said nutritional substance, comprising:
adaptive preserver for adaptively preserving a nutritional substance;
sensor for said sensing nutritional, organoleptic and/or aesthetic values of the nutritional substance;
attribute storage for storing said sensing nutritional, organoleptic and/or aesthetic values of the nutritional substance;
wherein the adaptive preserver preserves said nutritional substance in response to the internal attribute of the nutritional substance so as to maintain, or minimize degradation of said sensing nutritional, organoleptic and/or aesthetic values of the nutritional substance.

7. A method of dynamically ascertaining an expiration date for a nutritional substance comprising the steps of:
measuring an attribute of said nutritional substance;
comparing said measured attribute to a known attribute of similar nutritional substances to determine if said nutritional substance has passed its expiration date.

8. A transformation system for nutritional substances comprising:
retriever for obtaining source information regarding a nutritional substance to be transformed;
transformer for adaptively transforming the nutritional substance according to the source information;
sensor for obtaining transformation information regarding the transformation; and
transmitter for transmitting the transformation information and source information after transformation.

9. A transformation system for nutritional substances comprising:
retriever for obtaining nutritional, organoleptic and/or aesthetic information regarding a nutritional substance to be transformed;
transformer for adaptively transforming the nutritional substance according to the nutritional, organoleptic and/or aesthetic information so as to maintain, or minimize degradation of, nutritional, organoleptic and/or aesthetic values of the nutritional substance;
sensor for obtaining transformation nutritional, organoleptic and/or aesthetic information regarding the transformation; and
transmitter for transmitting the transformation nutritional, organoleptic and/or aesthetic information and nutritional, organoleptic and/or aesthetic information after transformation.

10. A method of dynamically generating a nutritional table for a nutritional substance comprising the steps of:
ascertaining nutritional information for a particular nutritional substance;
producing a nutritional table using the ascertained nutritional information.

11. A conditioning system for nutritional substances comprising:
retriever for obtaining source information regarding a nutritional substance to be conditioned;
detector for obtaining conditioning specifications;
conditioner for adaptively conditioning the nutritional substance according to the source information and the conditioning specifications;
sensor for obtaining conditioning information regarding the conditioning; and
transmitter for transmitting the source information and conditioning information after conditioning.

12. A conditioning system for nutritional substances comprising:
retriever for obtaining source information regarding a nutritional substance to be conditioned;
means for obtaining conditioning specifications;
conditioner for adaptively conditioning the nutritional substance according to the source information and the conditioning specifications;
means for obtaining conditioning information regarding the conditioning; and
transmitter for transmitting the source information and conditioning information after conditioning.

13. A method of generating nutritional information for a conditioned nutritional substance comprising the steps of:
obtaining source information regarding the nutritional substance;
obtaining conditioning information for the nutritional substance;
calculating any change in nutritional information using the source information and the conditioning information.

14. A communication system for nutritional substances comprising:
an information storage system containing source information regarding a particular nutritional substance;
locator for obtaining particular consumer information relating to the particular nutritional substance;
retriever for retrieving the information regarding a particular nutritional substance;
interface for collecting and storing general information regarding the consumer of the particular substance;
transmitter for transmitting the particular and general consumer information and source information for the particular nutritional substance.

15. A communication system for nutritional substances comprising:
an information storage system containing source information regarding a particular nutritional substance;
locator for obtaining particular consumer information relating to the particular nutritional substance;
retriever for retrieving the information regarding a particular nutritional substance;
interface for collecting and storing general information regarding the consumer of the particular substance;
transmitter for transmitting the particular and general consumer information and source information for the particular nutritional substance.

16. A communication system for nutritional substances comprising:
an information storage system containing nutritional, organoleptic and/or aesthetic information regarding a particular nutritional substance;
locator for obtaining particular consumer information relating to the particular nutritional substance;
retriever for retrieving the information regarding a particular nutritional substance;
interface for collecting and storing general information regarding the consumer of the particular substance;
transmitter for transmitting the particular and general consumer information and nutritional, organoleptic and/or aesthetic information for the particular nutritional substance.

17. A method of obtaining and associating consumption information of a nutritional substance comprising the steps of:
obtaining consumption information for a particular nutritional substance;
identifying source information for the particular nutritional substance;
associating the consumption information with the source information.

18. An information system for nutritional substances comprising:
information storage system containing information regarding a particular nutritional substance;
identifier for identifying the particular nutritional substance; and
retriever for retrieving the information regarding a particular nutritional substance.

19. An information system for nutritional substances comprising:
information storage system containing information regarding a particular nutritional substance;
identifier for identifying the particular nutritional substance; and
retriever for retrieving the information regarding a particular nutritional substance,
wherein the information storage system also contains information about the consumer of the nutritional substance.

20. An information system for nutritional substances comprising:
information storage system containing information regarding a particular nutritional substance;
identifier for identifying the particular nutritional substance; and
retriever for retrieving the information regarding a particular nutritional substance,
wherein the information storage system also contains information about the consumer of the nutritional substance.

21. An information system for nutritional substances comprising an information storage system containing information regarding a particular nutritional substance operably connected to one, or more, of the following nutritional substance systems:
creation system for creation of nutritional substances;
preservation system for the packaging and shipping nutritional substances;
transformation system for the processing of nutritional substances;
conditioning system for the consumer preparation of nutritional substances;
consumption system for the consumption of nutritional substances;
wherein the information storage system receives and transmits information regarding said particular nutritional substance between said nutritional substance systems.

22. An information system for nutritional substances comprising an information storage system containing nutritional, organoleptic and/or aesthetic values a particular nutritional substance operably connected to one, or more, of the following nutritional substance systems:
creation system for creation of nutritional substances;
preservation system for the packaging and shipping nutritional substances;
transformation system for the processing of nutritional substances;
conditioning system for the consumer preparation of nutritional substances;
consumption system for the consumption of nutritional substances;
wherein the information storage system receives and transmits nutritional, organoleptic and/or aesthetic values regarding said particular nutritional substance between said nutritional substance systems.

23. A method of dynamically determining a price for a nutritional substance comprising the steps of:
obtaining source information for a particular nutritional substance;
determining a price for the nutritional substance using said source information.

24. A method of dynamically determining a price for a nutritional substance comprising the steps of:
obtaining source information for a particular nutritional substance;
obtaining market information for similar nutritional substances;
determining a price for the nutritional substance using said source information and market information.

25. An information system for nutritional substances comprising an information storage system containing information regarding a particular nutritional substance operably connected to one, or more, of the following nutritional substance systems:
creation system for creation of nutritional substances;
preservation system for the packaging and shipping nutritional substances;
transformation system for the processing of nutritional substances;
conditioning system for the consumer preparation of nutritional substances;
consumption system for the consumption of nutritional substances;
and one, or more, of the following non-nutritional substance systems:
government organization
marketing organization
nutritional advocacy organization
research organization
non-nutritional substance industry
non-nutritional substance information system
wherein the information storage system receives and transmits information regarding said particular nutritional substance between said nutritional substance systems and said non-nutritional substance systems.

26. An information system for nutritional substances comprising an information storage system containing nutritional, organoleptic and/or aesthetic values a particular nutritional substance operably connected to one, or more, of the following nutritional substance systems:
creation system for creation of nutritional substances;
preservation system for the packaging and shipping nutritional substances;
transformation system for the processing of nutritional substances;
conditioning system for the consumer preparation of nutritional substances;
consumption system for the consumption of nutritional substances;
and one, or more, of the following non-nutritional substance systems:
government organization
marketing organization
nutritional advocacy organization
research organization
non-nutritional substance industry
non-nutritional substance information system
wherein the information storage system receives and transmits nutritional, organoleptic and/or aesthetic values regarding said particular nutritional substance between said nutritional substance systems and said non-nutritional substance systems.

27. A method of dynamically determining a price for a nutritional substance comprising the steps of:
obtaining source information for a particular nutritional substance;
obtaining non-nutritional substance information related to the particular nutritional substance;
determining a price for the nutritional substance using said source information and said non-nutritional substance information.

28. A method of dynamically determining a price for a nutritional substance comprising the steps of:
obtaining source information for a particular nutritional substance;
obtaining market information for similar nutritional substances;
obtaining non-nutritional substance information related to the particular nutritional substance;
determining a price for the nutritional substance using said source information, market information, and said non-nutritional substance information.
